(19) United States
(12) Patent Application Publication
(10) Pub. No.: US 2026/0056603 A1
(43) Pub. Date: Feb. 26, 2026

(54) USER INTERFACES AND TECHNIQUES FOR MOVING A COMPUTER SYSTEM

(71) Applicant: Apple Inc., Cupertino, CA (US)

(72) Inventors: Agatha Y. YU, Oakland, CA (US); Anthony D'AURIA, San Francisco, CA (US); Christopher P. SAARI, San Francisco, CA (US); Hans C. LEE, San Martin, CA (US); Jamie L. MYROLD, Chicago, IL (US); Ji Chen Jason YUAN, Cupertino, CA (US); Joshua C. WEINBERG, Monte Sereno, CA (US); Kevin M. LYNCH, Woodside, CA (US); Matthew D. FORTIER, San Jose, CA (US); Stephen B. LYNCH, Portola Valley, CA (US); Tuhin KUMAR, San Francisco, CA (US); James N. JONES, San Francisco, CA (US)

(21) Appl. No.: 19/375,064

(22) Filed: Oct. 30, 2025

Related U.S. Application Data
(63) Continuation of application No. PCT/US2024/048467, filed on Sep. 25, 2024.
(60) Provisional application No. 63/541,834, filed on Sep. 30, 2023.
(60) Provisional application No. 63/541,842, filed on Sep. 30, 2023.
(60) Provisional application No. 63/541,835, filed on Sep. 30, 2023.

(51) Int. Cl. G06F 3/01; G06F 3/0481

(52) U.S. Cl. CPC G06F 3/011; G06F 3/0481

(57) ABSTRACT

The present disclosure generally relates to user interfaces for a computer system.

### CROSS-REFERENCE TO RELATED APPLICATIONS

This application is a continuing application of International Patent Application Serial No. PCT/US2024/048467, entitled “USER INTERFACES AND TECHNIQUES FOR MOVING A COMPUTER SYSTEM,” filed Sep. 25, 2024, which claims priority to U.S. Provisional Patent Application Ser. No. 63/541,834, filed Sep. 30, 2023, to U.S. Provisional Patent Application Ser. No. 63/541,842, filed Sep. 30, 2023, and to U.S. Provisional Patent Application Ser. No. 63/541,835, filed Sep. 30, 2023. The content of these applications are hereby incorporated by reference in their entirety.

### BACKGROUND

Users often move computer systems to various positions. Such movements require the users to manually pick up and move the computer systems. Computer systems perform various operations in the presence of users. Such operations can include turning on a screen or turning off a light when a user is detected. Users often communicate in various languages while using computer systems to communicate in various languages.

### SUMMARY

Existing techniques for moving a computer system using electronic devices are generally cumbersome and inefficient. For example, some existing techniques use a complex and time-consuming user interface, which may include multiple key presses or keystrokes. Some existing techniques require more time than necessary, wasting user time and device energy. This latter consideration is particularly important in battery-operated devices.

Accordingly, the present technique provides electronic devices with faster, more efficient methods and interfaces for moving a computer system and/or communicating in a different dialect. Such methods and interfaces optionally complement or replace other methods for moving a computer system and/or communicating in a different dialect. Such methods and interfaces reduce the cognitive burden on a user and produce a more efficient human-machine interface. For battery-operated computing devices, such methods and interfaces conserve power and increase the time between battery charges.

In some embodiments, a method that is performed at a computer system that is in communication with a movement component and one or more input devices is described. In some embodiments, the method comprises: detecting, via the one or more input devices, a first event; in response to detecting the first event: in accordance with a determination that a first set of one or more criteria is satisfied, wherein the first set of one or more criteria includes a criterion that is satisfied when a portion of a user is not within a first predefined distance from the computer system, moving, via the movement component, a portion of the computer system; and in accordance with a determination that a second set of one or more criteria is satisfied, wherein the second set of one or more criteria includes a criterion that is satisfied when the portion of the user is within the first predefined distance from the computer system, forgoing moving, via the movement component, the portion of the computer system; while moving, via the movement component, the portion of the computer system, detecting that the second set of one or more criteria is satisfied; and in response to detecting the second set of one or more criteria is satisfied while moving the portion of the computer system, ceasing moving, via the movement component, the portion of the computer system.

In some embodiments, a non-transitory computer-readable storage medium storing one or more programs configured to be executed by one or more processors of a computer system that is in communication with a movement component and one or more input devices is described. In some embodiments, the one or more programs includes instructions for: detecting, via the one or more input devices, a first event; in response to detecting the first event: in accordance with a determination that a first set of one or more criteria is satisfied, wherein the first set of one or more criteria includes a criterion that is satisfied when a portion of a user is not within a first predefined distance from the computer system, moving, via the movement component, a portion of the computer system; and in accordance with a determination that a second set of one or more criteria is satisfied, wherein the second set of one or more criteria includes a criterion that is satisfied when the portion of the user is within the first predefined distance from the computer system, forgoing moving, via the movement component, the portion of the computer system; while moving, via the movement component, the portion of the computer system, detecting that the second set of one or more criteria is satisfied; and in response to detecting the second set of one or more criteria is satisfied while moving the portion of the computer system, ceasing moving, via the movement component, the portion of the computer system.

In some embodiments, a transitory computer-readable storage medium storing one or more programs configured to be executed by one or more processors of a computer system that is in communication with a movement component and one or more input devices is described. In some embodiments, the one or more programs includes instructions for: detecting, via the one or more input devices, a first event; in response to detecting the first event: in accordance with a determination that a first set of one or more criteria is satisfied, wherein the first set of one or more criteria includes a criterion that is satisfied when a portion of a user is not within a first predefined distance from the computer system, moving, via the movement component, a portion of the computer system; and in accordance with a determination that a second set of one or more criteria is satisfied, wherein the second set of one or more criteria includes a criterion that is satisfied when the portion of the user is within the first predefined distance from the computer system, forgoing moving, via the movement component, the portion of the computer system; while moving, via the movement component, the portion of the computer system, detecting that the second set of one or more criteria is satisfied; and in response to detecting the second set of one or more criteria is satisfied while moving the portion of the computer system, ceasing moving, via the movement component, the portion of the computer system.

In some embodiments, a computer system that is in communication with a movement component and one or more input devices is described. In some embodiments, the computer system comprises one or more processors and memory storing one or more programs configured to be executed by the one or more processors. In some embodiments, the one or more programs includes instructions for: detecting, via the one or more input devices, a first event; in response to detecting the first event: in accordance with a determination that a first set of one or more criteria is satisfied, wherein the first set of one or more criteria includes a criterion that is satisfied when a portion of a user is not within a first predefined distance from the computer system, moving, via the movement component, a portion of the computer system; and in accordance with a determination that a second set of one or more criteria is satisfied, wherein the second set of one or more criteria includes a criterion that is satisfied when the portion of the user is within the first predefined distance from the computer system, forgoing moving, via the movement component, the portion of the computer system; while moving, via the movement component, the portion of the computer system, detecting that the second set of one or more criteria is satisfied; and in response to detecting the second set of one or more criteria is satisfied while moving the portion of the computer system, ceasing moving, via the movement component, the portion of the computer system.

In some embodiments, a computer system that is in communication with a movement component and one or more input devices is described. In some embodiments, the computer system comprises means for performing each of the following steps: detecting, via the one or more input devices, a first event; in response to detecting the first event: in accordance with a determination that a first set of one or more criteria is satisfied, wherein the first set of one or more criteria includes a criterion that is satisfied when a portion of a user is not within a first predefined distance from the computer system, moving, via the movement component, a portion of the computer system; and in accordance with a determination that a second set of one or more criteria is satisfied, wherein the second set of one or more criteria includes a criterion that is satisfied when the portion of the user is within the first predefined distance from the computer system, forgoing moving, via the movement component, the portion of the computer system; while moving, via the movement component, the portion of the computer system, detecting that the second set of one or more criteria is satisfied; and in response to detecting the second set of one or more criteria is satisfied while moving the portion of the computer system, ceasing moving, via the movement component, the portion of the computer system.

In some embodiments, a computer program product is described. In some embodiments, the computer program product comprises one or more programs configured to be executed by one or more processors of a computer system that is in communication with a movement component and one or more input devices. In some embodiments, the one or more programs include instructions for: detecting, via the one or more input devices, a first event; in response to detecting the first event: in accordance with a determination that a first set of one or more criteria is satisfied, wherein the first set of one or more criteria includes a criterion that is satisfied when a portion of a user is not within a first predefined distance from the computer system, moving, via the movement component, a portion of the computer system; and in accordance with a determination that a second set of one or more criteria is satisfied, wherein the second set of one or more criteria includes a criterion that is satisfied when the portion of the user is within the first predefined distance from the computer system, forgoing moving, via the movement component, the portion of the computer system; while moving, via the movement component, the portion of the computer system, detecting that the second set of one or more criteria is satisfied; and in response to detecting the second set of one or more criteria is satisfied while moving the portion of the computer system, ceasing moving, via the movement component, the portion of the computer system.

In some embodiments, a method that is performed at a computer system that is in communication with a movement component, one or more input devices, and a display component is described. In some embodiments, the method comprises: detecting, via the one or more input devices, a first event; in response to detecting the first event: in accordance with a determination that a first set of one or more criteria is satisfied, wherein the first set of one or more criteria includes a criterion that is satisfied when a first object is not within a path, moving, via the movement component, a portion of the computer system; and in accordance with a determination that a second set of one or more criteria is satisfied, wherein the second set of one or more criteria includes a criterion that is satisfied when the first object is within the path, forgoing moving, via the movement component, the portion of the computer system; while moving, via the movement component, the portion of the computer system, detecting that the second set of one or more criteria is satisfied; and in response to detecting the second set of one or more criteria is satisfied while moving the portion of the computer system: ceasing moving, via the movement component, the portion of the computer system; and displaying, via the display component, a first representation of the first object.

In some embodiments, a non-transitory computer-readable storage medium storing one or more programs configured to be executed by one or more processors of a computer system that is in communication with a movement component, one or more input devices, and a display component is described. In some embodiments, the one or more programs includes instructions for: detecting, via the one or more input devices, a first event; in response to detecting the first event: in accordance with a determination that a first set of one or more criteria is satisfied, wherein the first set of one or more criteria includes a criterion that is satisfied when a first object is not within a path, moving, via the movement component, a portion of the computer system; and in accordance with a determination that a second set of one or more criteria is satisfied, wherein the second set of one or more criteria includes a criterion that is satisfied when the first object is within the path, forgoing moving, via the movement component, the portion of the computer system; while moving, via the movement component, the portion of the computer system, detecting that the second set of one or more criteria is satisfied; and in response to detecting the second set of one or more criteria is satisfied while moving the portion of the computer system: ceasing moving, via the movement component, the portion of the computer system; and displaying, via the display component, a first representation of the first object.

In some embodiments, a transitory computer-readable storage medium storing one or more programs configured to be executed by one or more processors of a computer system that is in communication with a movement component, one or more input devices, and a display component is described. In some embodiments, the one or more programs includes instructions for: detecting, via the one or more input devices, a first event; in response to detecting the first event: in accordance with a determination that a first set of one or more criteria is satisfied, wherein the first set of one or more criteria includes a criterion that is satisfied when a first object is not within a path, moving, via the movement component, a portion of the computer system; and in accordance with a determination that a second set of one or more criteria is satisfied, wherein the second set of one or more criteria includes a criterion that is satisfied when the first object is within the path, forgoing moving, via the movement component, the portion of the computer system; while moving, via the movement component, the portion of the computer system, detecting that the second set of one or more criteria is satisfied; and in response to detecting the second set of one or more criteria is satisfied while moving the portion of the computer system: ceasing moving, via the movement component, the portion of the computer system; and displaying, via the display component, a first representation of the first object.

In some embodiments, a computer system that is in communication with a movement component, one or more input devices, and a display component is described. In some embodiments, the computer system comprises one or more processors and memory storing one or more programs configured to be executed by the one or more processors. In some embodiments, the one or more programs includes instructions for: detecting, via the one or more input devices, a first event; in response to detecting the first event: in accordance with a determination that a first set of one or more criteria is satisfied, wherein the first set of one or more criteria includes a criterion that is satisfied when a first object is not within a path, moving, via the movement component, a portion of the computer system; and in accordance with a determination that a second set of one or more criteria is satisfied, wherein the second set of one or more criteria includes a criterion that is satisfied when the first object is within the path, forgoing moving, via the movement component, the portion of the computer system; while moving, via the movement component, the portion of the computer system, detecting that the second set of one or more criteria is satisfied; and in response to detecting the second set of one or more criteria is satisfied while moving the portion of the computer system: ceasing moving, via the movement component, the portion of the computer system; and displaying, via the display component, a first representation of the first object.

In some embodiments, a computer system that is in communication with a movement component, one or more input devices, and a display component is described. In some embodiments, the computer system comprises means for performing each of the following steps: detecting, via the one or more input devices, a first event; in response to detecting the first event: in accordance with a determination that a first set of one or more criteria is satisfied, wherein the first set of one or more criteria includes a criterion that is satisfied when a first object is not within a path, moving, via the movement component, a portion of the computer system; and in accordance with a determination that a second set of one or more criteria is satisfied, wherein the second set of one or more criteria includes a criterion that is satisfied when the first object is within the path, forgoing moving, via the movement component, the portion of the computer system; while moving, via the movement component, the portion of the computer system, detecting that the second set of one or more criteria is satisfied; and in response to detecting the second set of one or more criteria is satisfied while moving the portion of the computer system: ceasing moving, via the movement component, the portion of the computer system; and displaying, via the display component, a first representation of the first object.

In some embodiments, a computer program product is described. In some embodiments, the computer program product comprises one or more programs configured to be executed by one or more processors of a computer system that is in communication with a movement component, one or more input devices, and a display component. In some embodiments, the one or more programs include instructions for: detecting, via the one or more input devices, a first event; in response to detecting the first event: in accordance with a determination that a first set of one or more criteria is satisfied, wherein the first set of one or more criteria includes a criterion that is satisfied when a first object is not within a path, moving, via the movement component, a portion of the computer system; and in accordance with a determination that a second set of one or more criteria is satisfied, wherein the second set of one or more criteria includes a criterion that is satisfied when the first object is within the path, forgoing moving, via the movement component, the portion of the computer system; while moving, via the movement component, the portion of the computer system, detecting that the second set of one or more criteria is satisfied; and in response to detecting the second set of one or more criteria is satisfied while moving the portion of the computer system: ceasing moving, via the movement component, the portion of the computer system; and displaying, via the display component, a first representation of the first object.

In some embodiments, a method that is performed at a computer system that is in communication with a movement component, one or more input devices, and a display component is described. In some embodiments, the method comprises: detecting, via the one or more input devices, a first user in an environment; and in response to detecting the first user in the environment: moving, via the movement component, a portion of the computer system to be directed to the first user; and displaying a first predefined indication for the first user.

In some embodiments, a non-transitory computer-readable storage medium storing one or more programs configured to be executed by one or more processors of a computer system that is in communication with a movement component, one or more input devices, and a display component is described. In some embodiments, the one or more programs includes instructions for: detecting, via the one or more input devices, a first user in an environment; and in response to detecting the first user in the environment: moving, via the movement component, a portion of the computer system to be directed to the first user; and displaying a first predefined indication for the first user.

In some embodiments, a transitory computer-readable storage medium storing one or more programs configured to be executed by one or more processors of a computer system that is in communication with a movement component, one or more input devices, and a display component is described. In some embodiments, the one or more programs includes instructions for: detecting, via the one or more input devices, a first user in an environment; and in response to detecting the first user in the environment: moving, via the movement component, a portion of the computer system to be directed to the first user; and displaying a first predefined indication for the first user.

In some embodiments, a computer system that is in communication with a movement component, one or more input devices, and a display component is described. In some embodiments, the computer system comprises one or more processors and memory storing one or more programs configured to be executed by the one or more processors. In some embodiments, the one or more programs includes instructions for: detecting, via the one or more input devices, a first user in an environment; and in response to detecting the first user in the environment: moving, via the movement component, a portion of the computer system to be directed to the first user; and displaying a first predefined indication for the first user.

In some embodiments, a computer system that is in communication with a movement component, one or more input devices, and a display component is described. In some embodiments, the computer system comprises means for performing each of the following steps: detecting, via the one or more input devices, a first user in an environment; and in response to detecting the first user in the environment: moving, via the movement component, a portion of the computer system to be directed to the first user; and displaying a first predefined indication for the first user.

In some embodiments, a computer program product is described. In some embodiments, the computer program product comprises one or more programs configured to be executed by one or more processors of a computer system that is in communication with a movement component, one or more input devices, and a display component. In some embodiments, the one or more programs include instructions for: detecting, via the one or more input devices, a first user in an environment; and in response to detecting the first user in the environment: moving, via the movement component, a portion of the computer system to be directed to the first user; and displaying a first predefined indication for the first user.

In some embodiments, a method that is performed at a computer system that is in communication with a first movement component, a second movement component, and one or more input devices is described. In some embodiments, the method comprises: detecting, via the one or more input devices, a first user in an environment; and in response to detecting the first user in the environment: moving, via the first movement component, a portion of the computer system to be directed to the first user; and in conjunction with moving the portion of the computer system to be directed to the first user, performing, via the second movement component, a first physical movement that causes a position of the portion of the computer system to be moved away from being directed to the first user.

In some embodiments, a non-transitory computer-readable storage medium storing one or more programs configured to be executed by one or more processors of a computer system that is in communication with a first movement component, a second movement component, and one or more input devices is described. In some embodiments, the one or more programs includes instructions for: detecting, via the one or more input devices, a first user in an environment; and in response to detecting the first user in the environment: moving, via the first movement component, a portion of the computer system to be directed to the first user; and in conjunction with moving the portion of the computer system to be directed to the first user, performing, via the second movement component, a first physical movement that causes a position of the portion of the computer system to be moved away from being directed to the first user.

In some embodiments, a transitory computer-readable storage medium storing one or more programs configured to be executed by one or more processors of a computer system that is in communication with a first movement component, a second movement component, and one or more input devices is described. In some embodiments, the one or more programs includes instructions for: detecting, via the one or more input devices, a first user in an environment; and in response to detecting the first user in the environment: moving, via the first movement component, a portion of the computer system to be directed to the first user; and in conjunction with moving the portion of the computer system to be directed to the first user, performing, via the second movement component, a first physical movement that causes a position of the portion of the computer system to be moved away from being directed to the first user.

In some embodiments, a computer system that is in communication with a first movement component, a second movement component, and one or more input devices is described. In some embodiments, the computer system comprises one or more processors and memory storing one or more programs configured to be executed by the one or more processors. In some embodiments, the one or more programs includes instructions for: detecting, via the one or more input devices, a first user in an environment; and in response to detecting the first user in the environment: moving, via the first movement component, a portion of the computer system to be directed to the first user; and in conjunction with moving the portion of the computer system to be directed to the first user, performing, via the second movement component, a first physical movement that causes a position of the portion of the computer system to be moved away from being directed to the first user.

In some embodiments, a computer system that is in communication with a first movement component, a second movement component, and one or more input devices is described. In some embodiments, the computer system comprises means for performing each of the following steps: detecting, via the one or more input devices, a first user in an environment; and in response to detecting the first user in the environment: moving, via the first movement component, a portion of the computer system to be directed to the first user; and in conjunction with moving the portion of the computer system to be directed to the first user, performing, via the second movement component, a first physical movement that causes a position of the portion of the computer system to be moved away from being directed to the first user.

In some embodiments, a computer program product is described. In some embodiments, the computer program product comprises one or more programs configured to be executed by one or more processors of a computer system that is in communication with a first movement component, a second movement component, and one or more input devices. In some embodiments, the one or more programs include instructions for: detecting, via the one or more input devices, a first user in an environment; and in response to detecting the first user in the environment: moving, via the first movement component, a portion of the computer system to be directed to the first user; and in conjunction with moving the portion of the computer system to be directed to the first user, performing, via the second movement component, a first physical movement that causes a position of the portion of the computer system to be moved away from being directed to the first user.

In some embodiments, a method that is performed at a computer system that is in communication with a movement component and a sensor is described. In some embodiments, the method comprises: while a portion of the computer system is in a first position in an environment, detecting an input corresponding to a request to register a user with the computer system; and in response to detecting the input corresponding to the request to register a user with the computer system: in accordance with a determination that a new user is in a second position, different from the first position, in the environment, moving, via the movement component, the portion of the computer system to be directed to the second position; in accordance with a determination that the new user is in a third position, different from the first position and the second position, in the environment, moving, via the movement component, the portion of the computer system to be directed to the third position; and in conjunction with moving the portion of the computer system, capturing, via the sensor, data corresponding to the new user.

In some embodiments, a non-transitory computer-readable storage medium storing one or more programs configured to be executed by one or more processors of a computer system that is in communication with a movement component and a sensor is described. In some embodiments, the one or more programs includes instructions for: while a portion of the computer system is in a first position in an environment, detecting an input corresponding to a request to register a user with the computer system; and in response to detecting the input corresponding to the request to register a user with the computer system: in accordance with a determination that a new user is in a second position, different from the first position, in the environment, moving, via the movement component, the portion of the computer system to be directed to the second position; in accordance with a determination that the new user is in a third position, different from the first position and the second position, in the environment, moving, via the movement component, the portion of the computer system to be directed to the third position; and in conjunction with moving the portion of the computer system, capturing, via the sensor, data corresponding to the new user.

In some embodiments, a transitory computer-readable storage medium storing one or more programs configured to be executed by one or more processors of a computer system that is in communication with a movement component and a sensor is described. In some embodiments, the one or more programs includes instructions for: while a portion of the computer system is in a first position in an environment, detecting an input corresponding to a request to register a user with the computer system; and in response to detecting the input corresponding to the request to register a user with the computer system: in accordance with a determination that a new user is in a second position, different from the first position, in the environment, moving, via the movement component, the portion of the computer system to be directed to the second position; in accordance with a determination that the new user is in a third position, different from the first position and the second position, in the environment, moving, via the movement component, the portion of the computer system to be directed to the third position; and in conjunction with moving the portion of the computer system, capturing, via the sensor, data corresponding to the new user.

In some embodiments, a computer system that is in communication with a movement component and a sensor is described. In some embodiments, the computer system comprises one or more processors and memory storing one or more programs configured to be executed by the one or more processors. In some embodiments, the one or more programs includes instructions for: while a portion of the computer system is in a first position in an environment, detecting an input corresponding to a request to register a user with the computer system; and in response to detecting the input corresponding to the request to register a user with the computer system: in accordance with a determination that a new user is in a second position, different from the first position, in the environment, moving, via the movement component, the portion of the computer system to be directed to the second position; in accordance with a determination that the new user is in a third position, different from the first position and the second position, in the environment, moving, via the movement component, the portion of the computer system to be directed to the third position; and in conjunction with moving the portion of the computer system, capturing, via the sensor, data corresponding to the new user.

In some embodiments, a computer system that is in communication with a movement component and a sensor is described. In some embodiments, the computer system comprises means for performing each of the following steps: while a portion of the computer system is in a first position in an environment, detecting an input corresponding to a request to register a user with the computer system; and in response to detecting the input corresponding to the request to register a user with the computer system: in accordance with a determination that a new user is in a second position, different from the first position, in the environment, moving, via the movement component, the portion of the computer system to be directed to the second position; in accordance with a determination that the new user is in a third position, different from the first position and the second position, in the environment, moving, via the movement component, the portion of the computer system to be directed to the third position; and in conjunction with moving the portion of the computer system, capturing, via the sensor, data corresponding to the new user.

In some embodiments, a computer program product is described. In some embodiments, the computer program product comprises one or more programs configured to be executed by one or more processors of a computer system that is in communication with a movement component and a sensor. In some embodiments, the one or more programs include instructions for: while a portion of the computer system is in a first position in an environment, detecting an input corresponding to a request to register a user with the computer system; and in response to detecting the input corresponding to the request to register a user with the computer system: in accordance with a determination that a new user is in a second position, different from the first position, in the environment, moving, via the movement component, the portion of the computer system to be directed to the second position; in accordance with a determination that the new user is in a third position, different from the first position and the second position, in the environment, moving, via the movement component, the portion of the computer system to be directed to the third position; and in conjunction with moving the portion of the computer system, capturing, via the sensor, data corresponding to the new user.

In some embodiments, a method that is performed at a computer system that is in communication with one or more output devices and one or more input devices is described. In some embodiments, the method comprises: in conjunction with outputting, via the one or more output devices, a first portion of content in a first dialect, detecting, via the one or more input devices, verbal input; and in response to detecting the verbal input and in accordance with a determination that the verbal input includes a second dialect different from the first dialect, outputting, via the one or more output devices, a second portion of content in the second dialect, wherein the second portion of content is different from the first portion of content.

In some embodiments, a non-transitory computer-readable storage medium storing one or more programs configured to be executed by one or more processors of a computer system that is in communication with one or more output devices and one or more input devices is described. In some embodiments, the one or more programs includes instructions for: in conjunction with outputting, via the one or more output devices, a first portion of content in a first dialect, detecting, via the one or more input devices, verbal input; and in response to detecting the verbal input and in accordance with a determination that the verbal input includes a second dialect different from the first dialect, outputting, via the one or more output devices, a second portion of content in the second dialect, wherein the second portion of content is different from the first portion of content.

In some embodiments, a transitory computer-readable storage medium storing one or more programs configured to be executed by one or more processors of a computer system that is in communication with one or more output devices and one or more input devices is described. In some embodiments, the one or more programs includes instructions for: in conjunction with outputting, via the one or more output devices, a first portion of content in a first dialect, detecting, via the one or more input devices, verbal input; and in response to detecting the verbal input and in accordance with a determination that the verbal input includes a second dialect different from the first dialect, outputting, via the one or more output devices, a second portion of content in the second dialect, wherein the second portion of content is different from the first portion of content.

In some embodiments, a computer system that is in communication with one or more output devices and one or more input devices is described. In some embodiments, the computer system comprises one or more processors and memory storing one or more programs configured to be executed by the one or more processors. In some embodiments, the one or more programs includes instructions for: in conjunction with outputting, via the one or more output devices, a first portion of content in a first dialect, detecting, via the one or more input devices, verbal input; and in response to detecting the verbal input and in accordance with a determination that the verbal input includes a second dialect different from the first dialect, outputting, via the one or more output devices, a second portion of content in the second dialect, wherein the second portion of content is different from the first portion of content.

In some embodiments, a computer system that is in communication with one or more output devices and one or more input devices is described. In some embodiments, the computer system comprises means for performing each of the following steps: in conjunction with outputting, via the one or more output devices, a first portion of content in a first dialect, detecting, via the one or more input devices, verbal input; and in response to detecting the verbal input and in accordance with a determination that the verbal input includes a second dialect different from the first dialect, outputting, via the one or more output devices, a second portion of content in the second dialect, wherein the second portion of content is different from the first portion of content.

In some embodiments, a computer program product is described. In some embodiments, the computer program product comprises one or more programs configured to be executed by one or more processors of a computer system that is in communication with one or more output devices and one or more input devices. In some embodiments, the one or more programs include instructions for: in conjunction with outputting, via the one or more output devices, a first portion of content in a first dialect, detecting, via the one or more input devices, verbal input; and in response to detecting the verbal input and in accordance with a determination that the verbal input includes a second dialect different from the first dialect, outputting, via the one or more output devices, a second portion of content in the second dialect, wherein the second portion of content is different from the first portion of content.

In some embodiments, a method that is performed at a computer system that is in communication with a movement component and one or more input devices is described. In some embodiments, the method comprises: detecting, via the one or more input devices, first voice input; and in response to detecting the first voice input: in accordance with a determination that the first voice input includes a first dialect, configuring the computer system to perform a first set of one or more physical movements corresponding to the first dialect; and in accordance with a determination that the first voice input includes a second dialect different from the first dialect, configuring the computer system to perform a second set of one or more physical movements corresponding to the second dialect; and after the computer system is configured to perform the first set of one or more physical movements corresponding to the first dialect or the second set of one or more physical movements corresponding to the second dialect, providing output corresponding to a first phrase that has a respective interpretation, including: in accordance with a determination that the computer system is configured to perform the first set of one or more physical movements corresponding to the first dialect, moving, via the movement component, a portion of the computer system in a first manner; and in accordance with a determination that the computer system is configured to perform the second set of one or more physical movements corresponding to the second dialect, forgoing moving, via the movement component, the portion of the computer system in the first manner.

In some embodiments, a non-transitory computer-readable storage medium storing one or more programs configured to be executed by one or more processors of a computer system that is in communication with a movement component and one or more input devices is described. In some embodiments, the one or more programs includes instructions for: detecting, via the one or more input devices, first voice input; and in response to detecting the first voice input: in accordance with a determination that the first voice input includes a first dialect, configuring the computer system to perform a first set of one or more physical movements corresponding to the first dialect; and in accordance with a determination that the first voice input includes a second dialect different from the first dialect, configuring the computer system to perform a second set of one or more physical movements corresponding to the second dialect; and after the computer system is configured to perform the first set of one or more physical movements corresponding to the first dialect or the second set of one or more physical movements corresponding to the second dialect, providing output corresponding to a first phrase that has a respective interpretation, including: in accordance with a determination that the computer system is configured to perform the first set of one or more physical movements corresponding to the first dialect, moving, via the movement component, a portion of the computer system in a first manner; and in accordance with a determination that the computer system is configured to perform the second set of one or more physical movements corresponding to the second dialect, forgoing moving, via the movement component, the portion of the computer system in the first manner.

In some embodiments, a transitory computer-readable storage medium storing one or more programs configured to be executed by one or more processors of a computer system that is in communication with a movement component and one or more input devices is described. In some embodiments, the one or more programs includes instructions for: detecting, via the one or more input devices, first voice input; and in response to detecting the first voice input: in accordance with a determination that the first voice input includes a first dialect, configuring the computer system to perform a first set of one or more physical movements corresponding to the first dialect; and in accordance with a determination that the first voice input includes a second dialect different from the first dialect, configuring the computer system to perform a second set of one or more physical movements corresponding to the second dialect; and after the computer system is configured to perform the first set of one or more physical movements corresponding to the first dialect or the second set of one or more physical movements corresponding to the second dialect, providing output corresponding to a first phrase that has a respective interpretation, including: in accordance with a determination that the computer system is configured to perform the first set of one or more physical movements corresponding to the first dialect, moving, via the movement component, a portion of the computer system in a first manner; and in accordance with a determination that the computer system is configured to perform the second set of one or more physical movements corresponding to the second dialect, forgoing moving, via the movement component, the portion of the computer system in the first manner.

In some embodiments, a computer system that is in communication with a movement component and one or more input devices is described. In some embodiments, the computer system comprises one or more processors and memory storing one or more programs configured to be executed by the one or more processors. In some embodiments, the one or more programs includes instructions for: detecting, via the one or more input devices, first voice input; and in response to detecting the first voice input: in accordance with a determination that the first voice input includes a first dialect, configuring the computer system to perform a first set of one or more physical movements corresponding to the first dialect; and in accordance with a determination that the first voice input includes a second dialect different from the first dialect, configuring the computer system to perform a second set of one or more physical movements corresponding to the second dialect; and after the computer system is configured to perform the first set of one or more physical movements corresponding to the first dialect or the second set of one or more physical movements corresponding to the second dialect, providing output corresponding to a first phrase that has a respective interpretation, including: in accordance with a determination that the computer system is configured to perform the first set of one or more physical movements corresponding to the first dialect, moving, via the movement component, a portion of the computer system in a first manner; and in accordance with a determination that the computer system is configured to perform the second set of one or more physical movements corresponding to the second dialect, forgoing moving, via the movement component, the portion of the computer system in the first manner.

In some embodiments, a computer system that is in communication with a movement component and one or more input devices is described. In some embodiments, the computer system comprises means for performing each of the following steps: detecting, via the one or more input devices, first voice input; and in response to detecting the first voice input: in accordance with a determination that the first voice input includes a first dialect, configuring the computer system to perform a first set of one or more physical movements corresponding to the first dialect; and in accordance with a determination that the first voice input includes a second dialect different from the first dialect, configuring the computer system to perform a second set of one or more physical movements corresponding to the second dialect; and after the computer system is configured to perform the first set of one or more physical movements corresponding to the first dialect or the second set of one or more physical movements corresponding to the second dialect, providing output corresponding to a first phrase that has a respective interpretation, including: in accordance with a determination that the computer system is configured to perform the first set of one or more physical movements corresponding to the first dialect, moving, via the movement component, a portion of the computer system in a first manner; and in accordance with a determination that the computer system is configured to perform the second set of one or more physical movements corresponding to the second dialect, forgoing moving, via the movement component, the portion of the computer system in the first manner.

In some embodiments, a computer program product is described. In some embodiments, the computer program product comprises one or more programs configured to be executed by one or more processors of a computer system that is in communication with a movement component and one or more input devices. In some embodiments, the one or more programs include instructions for: detecting, via the one or more input devices, first voice input; and in response to detecting the first voice input: in accordance with a determination that the first voice input includes a first dialect, configuring the computer system to perform a first set of one or more physical movements corresponding to the first dialect; and in accordance with a determination that the first voice input includes a second dialect different from the first dialect, configuring the computer system to perform a second set of one or more physical movements corresponding to the second dialect; and after the computer system is configured to perform the first set of one or more physical movements corresponding to the first dialect or the second set of one or more physical movements corresponding to the second dialect, providing output corresponding to a first phrase that has a respective interpretation, including: in accordance with a determination that the computer system is configured to perform the first set of one or more physical movements corresponding to the first dialect, moving, via the movement component, a portion of the computer system in a first manner; and in accordance with a determination that the computer system is configured to perform the second set of one or more physical movements corresponding to the second dialect, forgoing moving, via the movement component, the portion of the computer system in the first manner.

In some embodiments, a method that is performed at a computer system is described. In some embodiments, the method comprises: detecting, from a first user, an input that includes an indication of a second user, different from the first user; and in response to detecting the input that includes the indication of the second user: in accordance with a determination that an unknown user is detected in the environment, initiating a process to add the unknown user as the second user; and in accordance with a determination that the unknown user is not detected in the environment, forgoing initiating the process to add the unknown user as the second user.

In some embodiments, a non-transitory computer-readable storage medium storing one or more programs configured to be executed by one or more processors of a computer system is described. In some embodiments, the one or more programs includes instructions for: detecting, from a first user, an input that includes an indication of a second user, different from the first user; and in response to detecting the input that includes the indication of the second user: in accordance with a determination that an unknown user is detected in the environment, initiating a process to add the unknown user as the second user; and in accordance with a determination that the unknown user is not detected in the environment, forgoing initiating the process to add the unknown user as the second user.

In some embodiments, a transitory computer-readable storage medium storing one or more programs configured to be executed by one or more processors of a computer system is described. In some embodiments, the one or more programs includes instructions for: detecting, from a first user, an input that includes an indication of a second user, different from the first user; and in response to detecting the input that includes the indication of the second user: in accordance with a determination that an unknown user is detected in the environment, initiating a process to add the unknown user as the second user; and in accordance with a determination that the unknown user is not detected in the environment, forgoing initiating the process to add the unknown user as the second user.

In some embodiments, a computer system is described. In some embodiments, the computer system comprises one or more processors and memory storing one or more programs configured to be executed by the one or more processors. In some embodiments, the one or more programs includes instructions for: detecting, from a first user, an input that includes an indication of a second user, different from the first user; and in response to detecting the input that includes the indication of the second user: in accordance with a determination that an unknown user is detected in the environment, initiating a process to add the unknown user as the second user; and in accordance with a determination that the unknown user is not detected in the environment, forgoing initiating the process to add the unknown user as the second user.

In some embodiments, a computer system is described. In some embodiments, the computer system comprises means for performing each of the following steps: detecting, from a first user, an input that includes an indication of a second user, different from the first user; and in response to detecting the input that includes the indication of the second user: in accordance with a determination that an unknown user is detected in the environment, initiating a process to add the unknown user as the second user; and in accordance with a determination that the unknown user is not detected in the environment, forgoing initiating the process to add the unknown user as the second user.

In some embodiments, a computer program product is described. In some embodiments, the computer program product comprises one or more programs configured to be executed by one or more processors of a computer system. In some embodiments, the one or more programs include instructions for: detecting, from a first user, an input that includes an indication of a second user, different from the first user; and in response to detecting the input that includes the indication of the second user: in accordance with a determination that an unknown user is detected in the environment, initiating a process to add the unknown user as the second user; and in accordance with a determination that the unknown user is not detected in the environment, forgoing initiating the process to add the unknown user as the second user.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a computer system in accordance with some embodiments.

FIGS. 2A-2C are diagrams illustrating exemplary components and user interfaces of electronic device in accordance with some embodiments.

FIG. 3 is a block diagram illustrating exemplary components of a device in accordance with some embodiments.

FIG. 4 is a functional diagram of an exemplary actuator device in accordance with some embodiments.

FIG. 5 is a functional diagram of an exemplary agent system in accordance with some embodiments.

FIGS. 6A-6B illustrate exemplary user interfaces for physically adjusting a position of a portion of a computer system in accordance with some embodiments.

FIG. 7 is a flow diagram illustrating methods for physically adjusting a position of a portion of a computer system in accordance with some embodiments.

FIGS. 8A-8C illustrate exemplary user interfaces for a movable computer system in accordance with some embodiments.

FIG. 9 is a flow diagram illustrating methods for a movable computer system in accordance with some embodiments.

FIGS. 10A-10G illustrate exemplary user interfaces for acknowledging presence of users in accordance with some embodiments.

FIG. 11 is a flow diagram illustrating methods for moving a portion of a computer system in accordance with some embodiments.

FIG. 12 is a flow diagram illustrating methods for performing a movement in accordance with some embodiments.

FIG. 13 is a flow diagram illustrating methods for introducing a new user in accordance with some embodiments.

FIGS. 14A-14D illustrate exemplary user interfaces for communicating with respect to dialects and registering users in accordance with some embodiments.

FIG. 15 is a flow diagram illustrating methods for automatically outputting in a specific dialect in accordance with some embodiments.

FIG. 16 is a flow diagram illustrating methods for moving a computer system corresponding to a specific dialect in accordance with some embodiments.

FIG. 17 is a flow diagram illustrating methods for initiating a process to add unknown users in accordance with some embodiments.

### DETAILED DESCRIPTION

The description to follow sets forth exemplary methods, components, parameters, and the like. While specific examples are set out below, it should be recognized that such embodiments should not be understood as limiting the scope of the present disclosure to the explicit descriptions of the examples set forth herein but instead should be understood as providing illustrative examples.

One or more steps of the methods described herein can rely on (be contingent on) one or more conditions being satisfied. In some embodiments, a method is performed by iterating a process multiple times. In some embodiments, contingent steps can be satisfied on different iterations of the same process and still be within the scope of the methods described herein. For example, for a given method that includes two steps that are contingent on different conditions, one of ordinary skill in the art would understand that the given method is considered performed even when a process is repeated multiple times until the contingent steps are satisfied. In some embodiments, multiple iterations of a process are not required to in order to practice claims as presented herein. For example, electronic device, system, or computer readable medium claims can be performed without iteratively repeating a process. In some embodiments, the electronic device, system, or computer readable medium claims include instructions for performing one or more steps that are contingent upon one or more conditions being satisfied. Because such instructions are stored in one or more processors and/or at one or more memory locations, the electronic device, system, or computer readable medium claims can include logic that determines whether the one or more conditions have been satisfied without needing to repeat steps of a process.

Although elements are described below using numerical descriptors, such as “a first” and/or “a second,” these elements do not correspond to order or distinct representations and should not be limited to the stated numerical term. In some embodiments, these terms simply used as prefix to distinguish a reference to one element from a reference to another element. For example, a “first” device and a “second” device can be two separate references to the same device. In contrast, for example, a “first” device and a “second” device can be a reference to two different devices (e.g., not the same device and/or not the same type of device). For example, a first computer system and a second computer system do not correspond to a first and a second in time, and merely are used to distinguish between two computer systems. As such, the first computer system can be termed a second computer system, and the second computer system can be termed a first computer system without departing from the scope of the various described embodiments.

For description of various elements and examples, the use of certain terminology is used to provide productive descriptions of the subject matter below and should not be read as limiting. As used to describe various examples herein, the singular forms of “a,” “an,” and “the” should not be interpreted as precluding or excluding the plural forms as well, unless the context clearly indicates otherwise. As well, “and/or” is used to encompasses any and all possible combinations of one or more associated listed items. For example, “x and/or y” should be interpreted as including “x,” or “y,” as well as “x and y” as possible permutations. Further, the use of the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

When describing choices and/or logical possibilities, the term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

The processes described below enhance the operability of the devices and make the user-device and/or user-device interfaces more efficient (e.g., by helping the user to provide proper inputs and reducing user mistakes when operating/interacting with the device) through various techniques, including by providing improved feedback (e.g., visual, haptic, acoustic, and/or tactile feedback) to the user, reducing the number of inputs needed to perform an operation, providing additional control options without cluttering the user interface with additional displayed controls, performing an operation when a set of conditions has been met without requiring further input (e.g., input by a user), and/or additional techniques, such as increasing the security and/or privacy of the computer system and reducing burn-in of one or more portions of a user interface of a display. These techniques also reduce power usage and improve battery life of the device by enabling the user to use the device more quickly and efficiently.

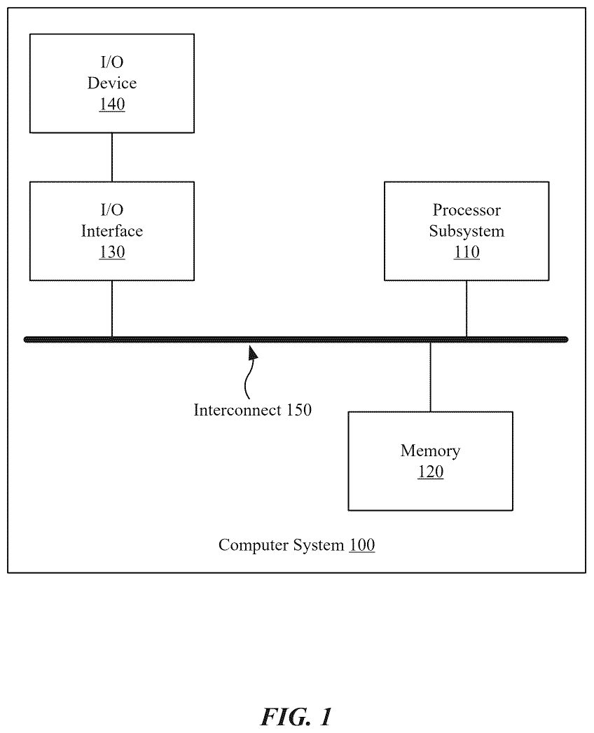

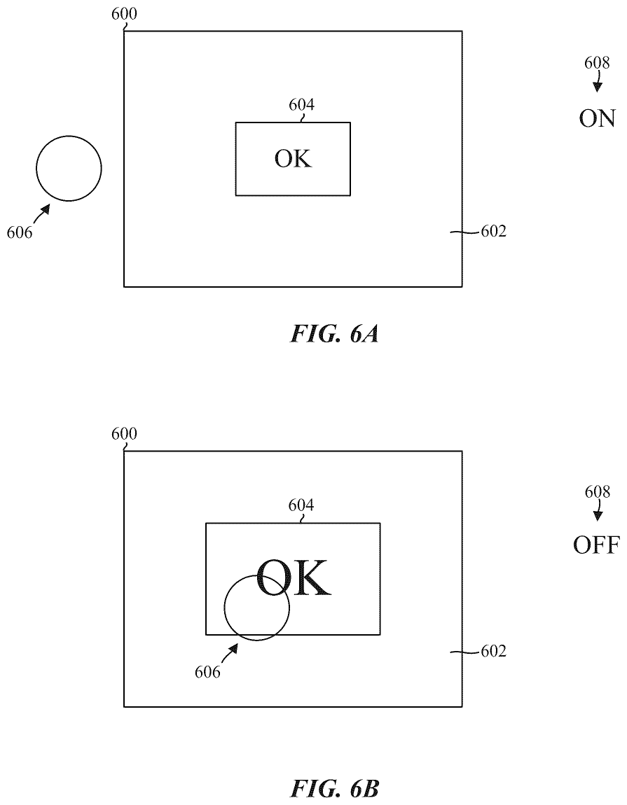

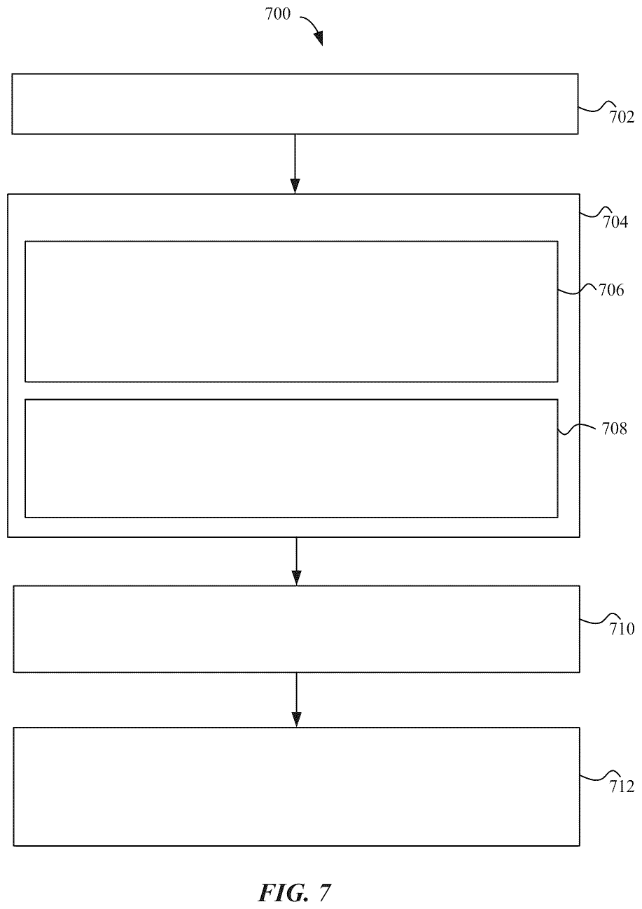

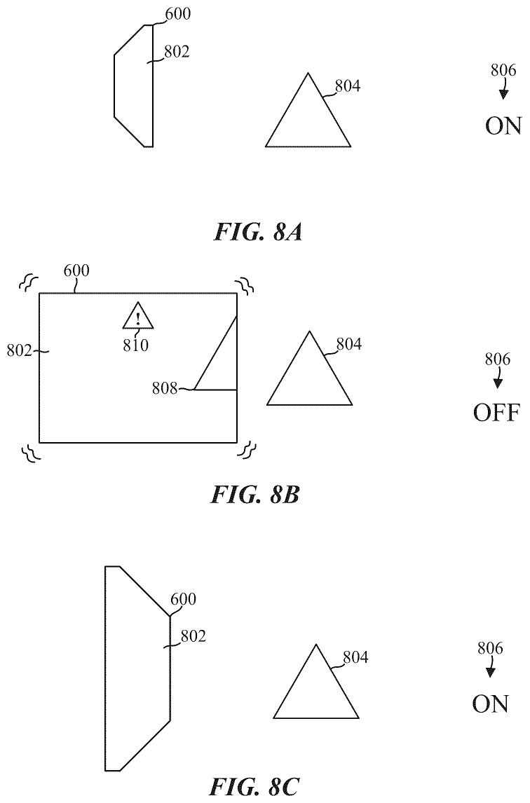

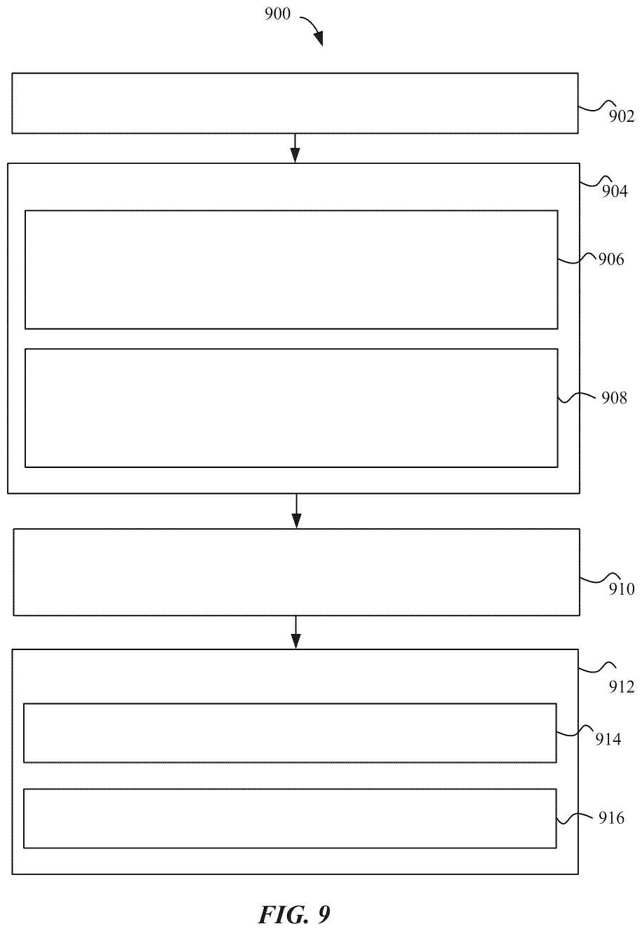

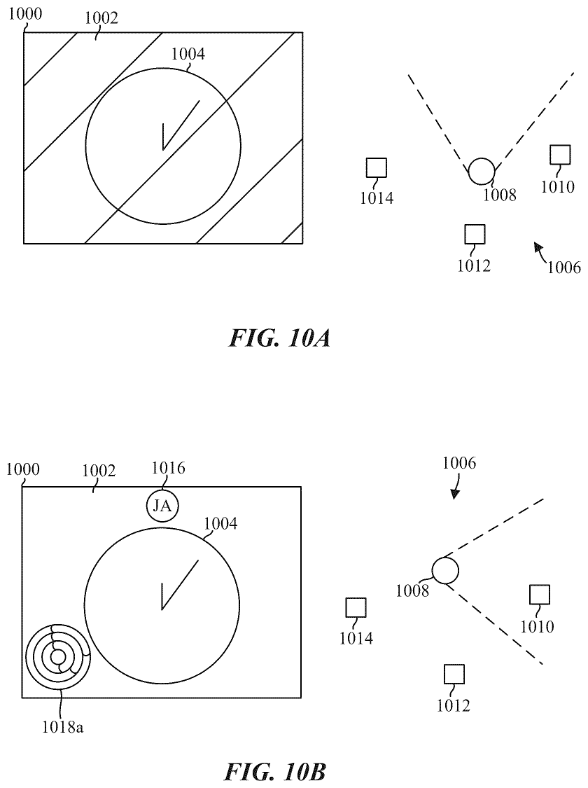

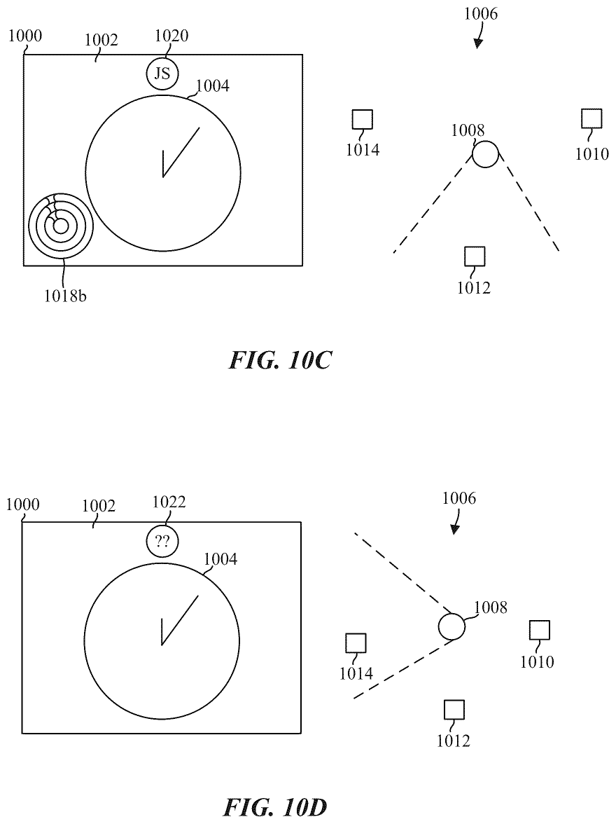

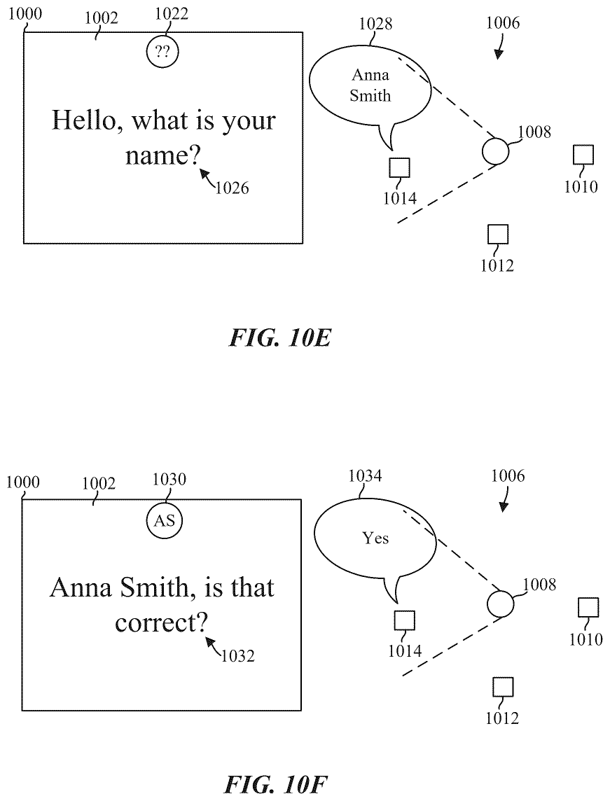

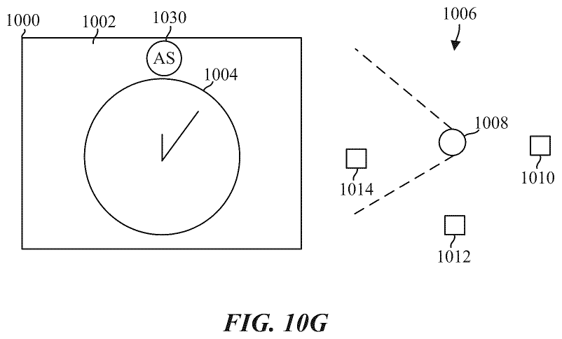

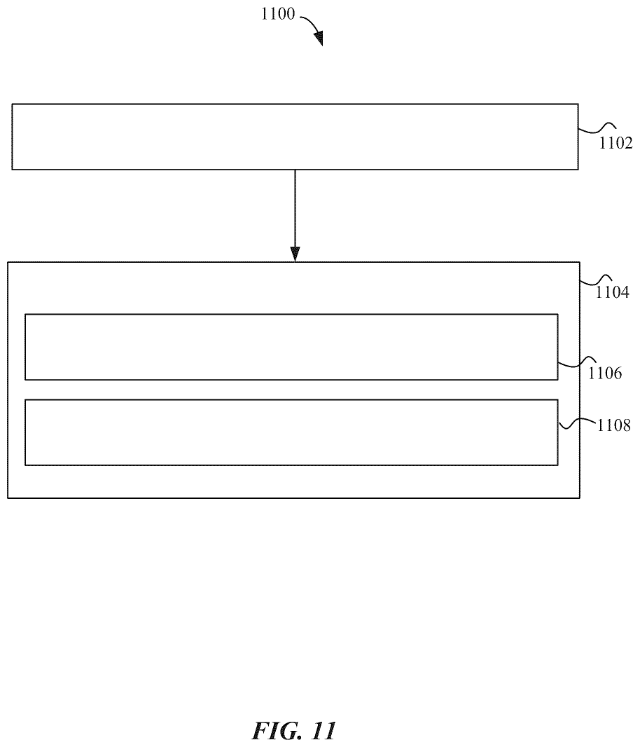

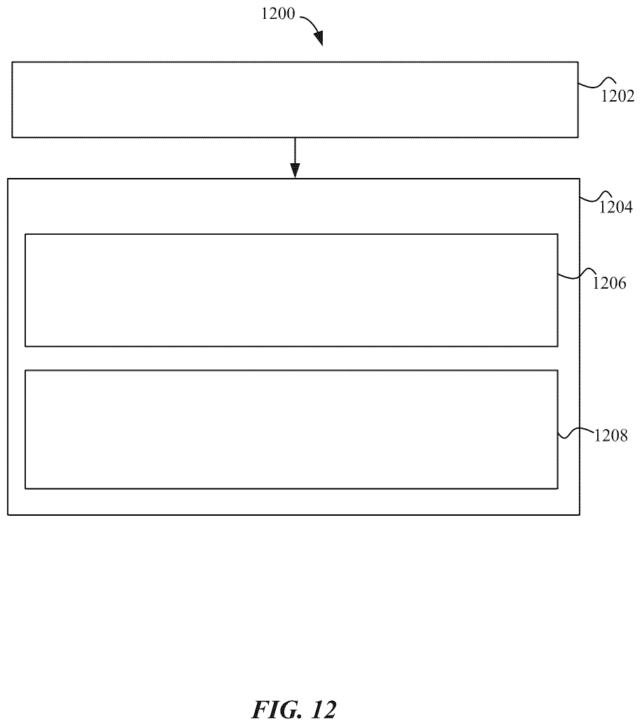

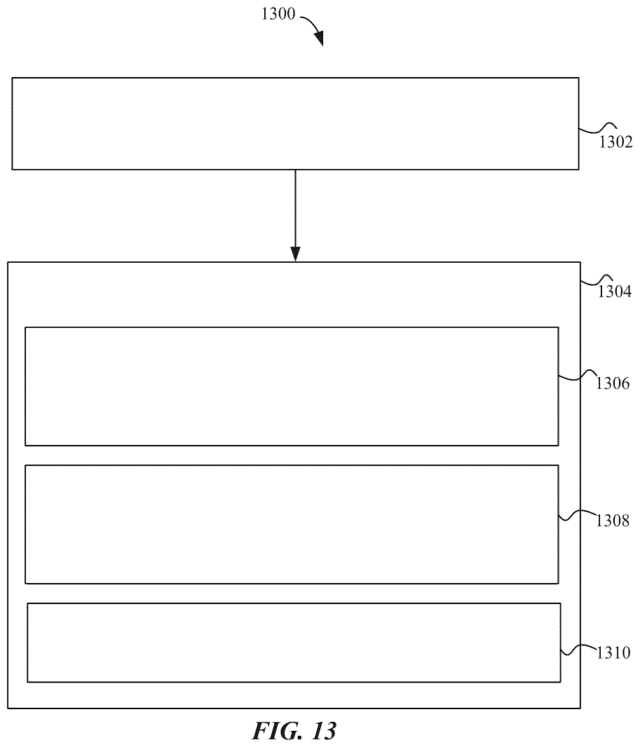

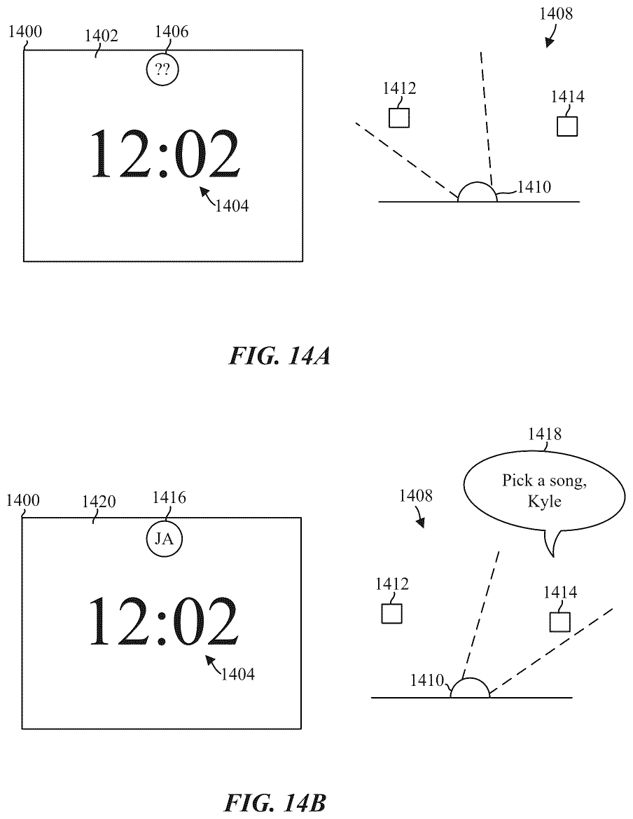

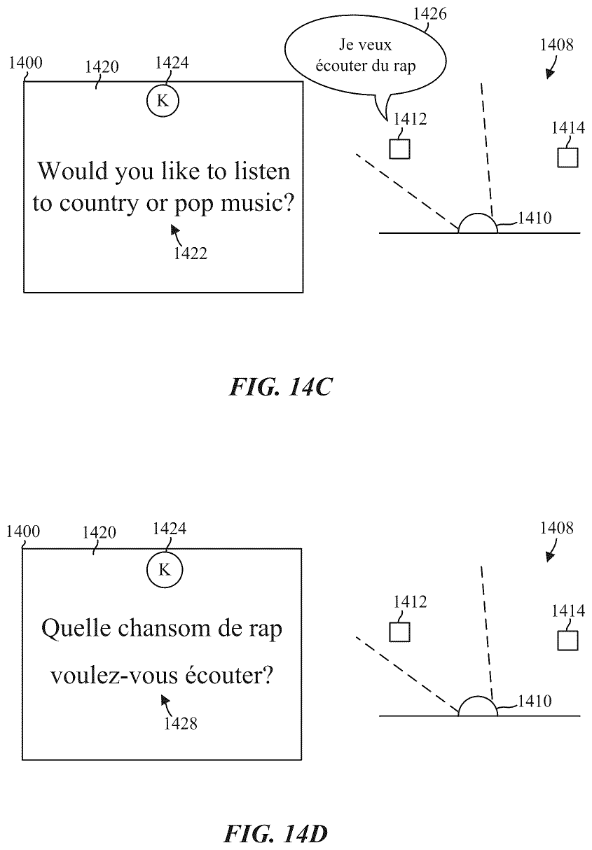

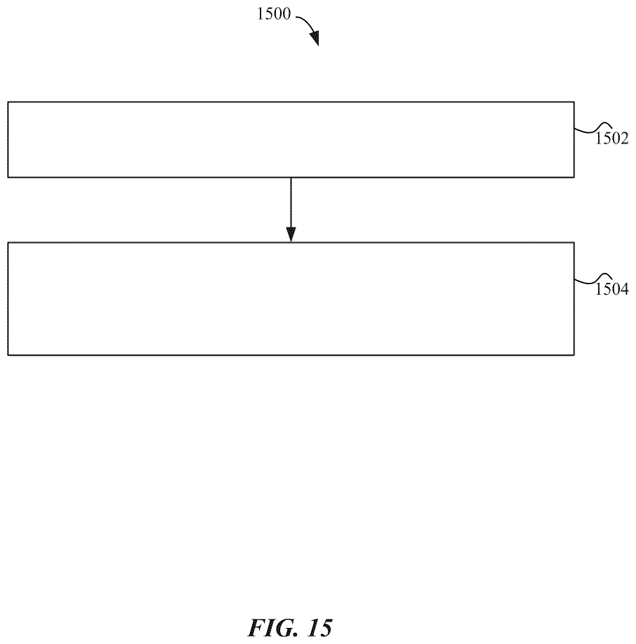

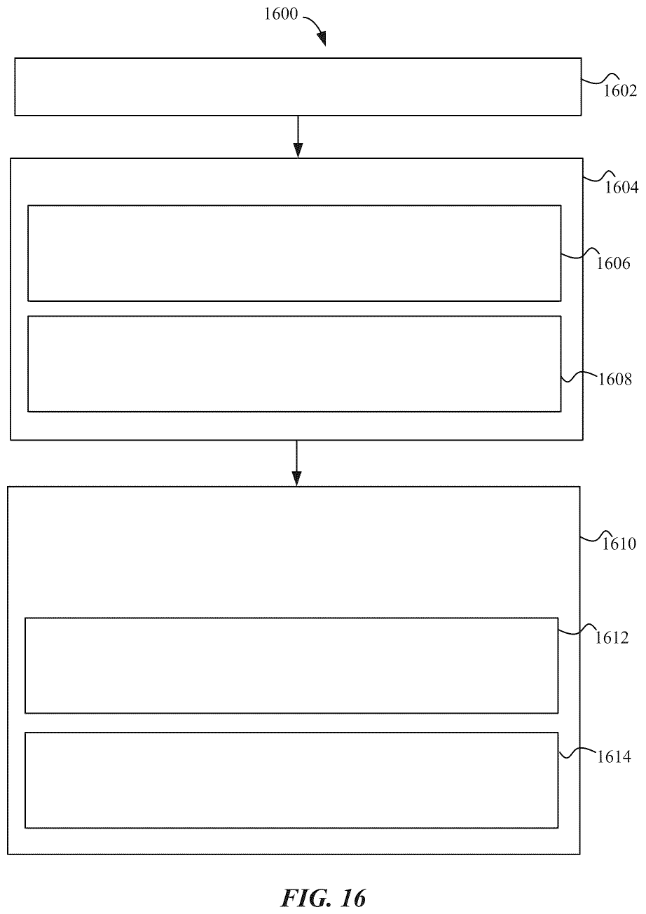

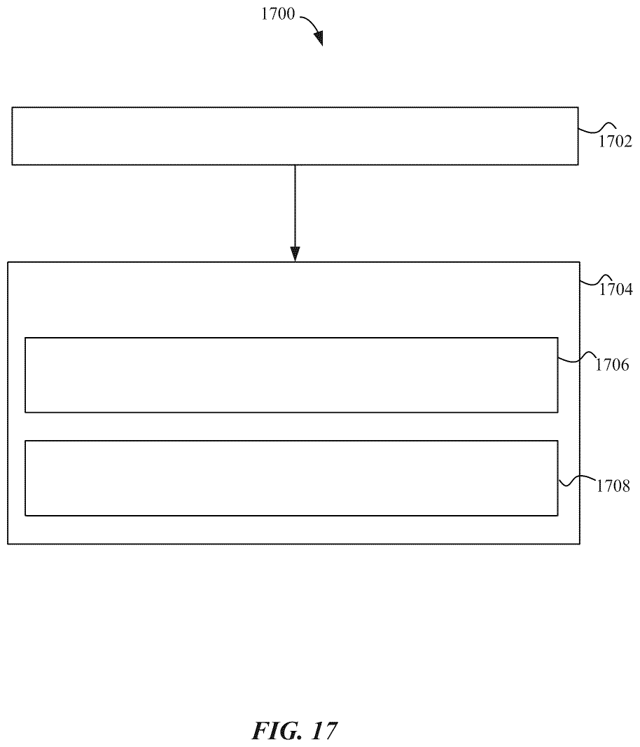

Below, FIGS. 1, 2A-2C, and 3-5 provide a description of exemplary devices for performing the techniques for outputting content based on context and characteristics of input. FIGS. 6A-6B illustrate exemplary user interfaces for physically adjusting a position of a portion of a computer system in accordance with some embodiments. FIG. 7 is a flow diagram illustrating methods for physically adjusting a position of a portion of a computer system in accordance with some embodiments. The user interfaces in FIGS. 6A-6B are used to illustrate the processes described below, including the processes in FIG. 7. FIGS. 8A-8C illustrate exemplary user interfaces for a movable computer system in accordance with some embodiments. FIG. 9 is a flow diagram illustrating methods for a movable computer system in accordance with some embodiments. The user interfaces in FIGS. 8A-8C are used to illustrate the processes described below, including the processes in FIG. 9. FIGS. 10A-10G illustrate exemplary user interfaces for acknowledging presence of users in accordance with some embodiments. FIG. 11 is a flow diagram illustrating methods for moving a portion of a computer system in accordance with some embodiments. FIG. 12 is a flow diagram illustrating methods for performing a movement in accordance with some embodiments. FIG. 13 is a flow diagram illustrating methods for introducing a new user in accordance with some embodiments. FIGS. 10A-10G are used to illustrate the processes described below, including the processes in FIGS. 11-13. FIGS. 14A-14D illustrate exemplary user interfaces for communicating with respect to dialects and registering users in accordance with some embodiments. FIG. 15 is a flow diagram illustrating methods for automatically outputting in a specific dialect in accordance with some embodiments. FIG. 16 is a flow diagram illustrating methods for moving a computer system corresponding to a specific dialect in accordance with some embodiments. FIG. 17 is a flow diagram illustrating methods for initiating a process to add unknown users in accordance with some embodiments. FIGS. 14A-14D are used to illustrate the processes described below, including the processes in FIGS. 15-17.

FIG. 1 depicts a block diagram of computer system 100 (e.g., electronic device and/or electronic system) including a set of electronic components in communication with (e.g., connected to) (e.g., wired or wirelessly) to each other. It should be understood that computer system 100 is merely one example of a computer system that can be used to perform functionality described below and that one or more other computer systems can be used to perform the functionality described below. Additionally, while FIG. 1 depicts a computer architecture of computer system 100, other computer architectures (e.g., including more components, similar components, and/or fewer components) of a computer system can be used to perform functionality described herein.

In some embodiments, computer system 100 can correspond to (e.g., be and/or include) a system on a chip, a server system, a personal computer system, a smart phone, a smart watch, a wearable device, a tablet, a laptop computer, a fitness tracking device, a head-mounted display (HMD) device, a desktop computer, a communal device (e.g., smart speaker, connected thermostat, and/or additional home based computer systems), an accessory (e.g., switch, light, speaker, air conditioner, heater, window cover, fan, lock, media playback device, television, and so forth), a controller, a hub, and/or a sensor.

In some embodiments, a sensor includes one or more hardware components capable of detecting (e.g., sensing, generating, and/or processing) information about a physical environment in proximity to the sensor. For example, a sensor can be configured to detect information surrounding the sensor, detect information in one or more directions casting away from the sensor, and/or detect information based on contact of the sensor with an element of the physical environment. In some embodiments, a hardware component of a sensor includes a sensing component (e.g., a temperature and/or image sensor), a transmitting component (e.g., a radio and/or laser transmitter), and/or a receiving component (e.g., a laser and/or radio receiver). In some embodiments, a sensor includes an angle sensor, a breakage sensor, a flow sensor, a force sensor, a gas sensor, a humidity or moisture sensor, a glass breakage sensor, a chemical sensor, a contact sensor, a non-contact sensor, an image sensor (e.g., a RGB camera and/or an infrared sensor), a particle sensor, a photoelectric sensor (e.g., ambient light and/or solar), a position sensor (e.g., a global positioning system), a precipitation sensor, a pressure sensor, a proximity sensor, a radiation sensor, an inertial measurement unit, a leak sensor, a level sensor, a metal sensor, a microphone, a motion sensor, a range or depth sensor (e.g., RADAR, LiDAR), a speed sensor, a temperature sensor, a time-of-flight sensor, a torque sensor, and an ultrasonic sensor, a vacancy sensor, a presence sensor, a voltage and/or current sensor, a conductivity sensor, a resistivity sensor, a capacitive sensor, and/or a water sensor. While only a single computer system is depicted in FIG. 1, functionality described below can be implemented with two or more computer systems operating together. Additionally, in some embodiments, computer system 100 includes one or more sensors as described above, and information about the physical environment is captured by combining data from one sensor with data from one or more additional sensors (e.g., that are part of the computer and/or one or more additional computer systems).

As illustrated in FIG. 1, computer system 100 consists of processor subsystem 110, memory 120, and I/O interface 130. Memory 120 corresponds to system memory in communication with processor subsystem 110. The electronic components making up computer system 100 are electrically connected through interconnect 150, which allows communication between the components of computer system 100. For example, interconnect 150 can be a system bus, one or more memory locations, and/or additional electrical channels for connective multiple components of computer system 100. Also, I/O interface 130 is connected to, via a wired and/or wireless connection, I/O device 140. In some embodiments, computer system 100 includes a component made up of I/O interface 130 and I/O device 140 such that the functionality of the individual components is included in the component. Additionally, it should be understood that computer system 100 can include one or more I/O interfaces, communicating with one or more I/O devices. In some embodiments, computer system 100 consists of multiple processor subsystem 100s, each electrically connected through interconnect 150.

In some embodiments, processor subsystem 110 includes one or more processors or individual processing units capable of executing instructions (e.g., program, system, and/or interrupt) to perform functionality described herein. For example, operating system level and/or application level instructions executed by processor subsystem 110. In some embodiments, processor subsystem 110 includes one or more components (e.g., implemented as hardware, software, and/or a combination thereof) capable of supporting, interpreting, and/or performing machine learning instructions and/or operations. For example, computer system 100 can perform operations according to a machine learning model locally. Alternatively, or in addition, computer system 100 can communicate with (e.g., performing calculations on and/or executing instructions corresponding to) a remote interactive knowledge base (e.g., a processing resource that implements a machine learning model, artificial intelligence model, and/or large language model) to perform operations that can be otherwise outside a set of capabilities of computer system 100. For example, computer system 100 can determine a set of inputs (e.g., instructions, data, and/or parameters) to the interactive knowledge base for performing desired machine learning operations.

Memory 120 in communication with processor subsystem 110 can be implemented by a variety of different physical, non-transitory memory media. In some embodiments, computer system 100 includes multiple memory components and/or multiple types of memory components, each connected to processor subsystem 110 directly and/or via interconnect 150. For example, memory 120 can be implemented using a removable flash drive, storage array, a storage area network (e.g., SAN), flash memory, hard disk storage, optical drive storage, floppy disk storage, removable disk storage, random access memory (e.g., SDRAM, DDR SDRAM, RAM-SRAM, EDO RAM, and/or RAMBUS RAM), and/or read only memory (e.g., PROM and/or EEPROM). Additionally, in some embodiments, processor subsystem 110 and/or interconnect 150 is connected to a memory controller that is electrically connected to memory 120.

In some embodiments, instructions can be executed by processor subsystem 110. In this example, memory 120 can include a computer readable medium (e.g., non-transitory or transitory computer readable medium) usable to store (e.g., configured to store, assigned to store, and/or that stores) instructions to be executable by processor subsystem 110. In some embodiments each instruction stored by memory 120 and executed by processor subsystem 110 corresponds to an operation for completing the functionality described herein. For example, memory 120 can store program instructions to implement the functionality associated with method 300 described below.

As mentioned above, I/O interface 130 can be one or more types of interfaces enabling computer system 100 to communicate with other devices. In some embodiments, I/O interface 130 includes a bridge chip (e.g., Southbridge) from a front-side bus to one or more back-side buses. In some embodiments, I/O interface 130 enables communication with one or more I/O devices, illustrated as I/O device 140, via one or more corresponding buses or other interfaces. For example, an I/O device can include one or more: a physical user-interface devices (e.g., a physical keyboard, a mouse, and/or a joystick), storage devices (e.g., as described above with respect to memory 120), network interface devices (e.g., to a local or wide-area network), sensor devices (e.g., as described above with respect to sensors), and/or auditory and/or visual output devices (e.g., screen, speaker, light, and/or projector). In some embodiments, the visual output device is referred to as a display component. For example, the display component can be configured to provide visual output, such as displaying images on a physically viewable medium via an LED display or image projection. As used herein, “displaying” content includes causing to display the content (e.g., video data rendered and/or decoded by a display controller) by transmitting, via a wired or wireless connection, data (e.g., image data and/or video data) to an integrated or external display component to visually produce the content.

In some embodiments, computer system 100 includes a component that integrates I/O device 140 with other components (e.g., a component that includes I/O interface 130 and I/O device 140). In some embodiments, I/O device 140 is separate from other components of computer system 100 (e.g., is a discrete component). In some embodiments, I/O device 140 includes a network interface device that permits computer system 100 to connect to (e.g., communicate with) a network or other computer systems, in a wired or wireless manner. In some embodiments, a network interface device can include Wi-Fi, Bluetooth, NFC, USB, Thunderbolt, Ethernet, and so forth. For example, computer system 100 can utilize an NFC connection to facilitate a bank, credit, financial, token (e.g., fungible or non-fungible token), and/or cryptocurrency transaction between computer system 100 and another computer system within proximity.

In some embodiments, I/O device 140 includes components for detecting a user (e.g., a user, a person, an animal, another computer system different from the computer system, and/or an object) and/or an input (e.g., a tap input and/or a non-tap input (e.g., a verbal input, an acoustic request, an acoustic command, an acoustic statement, a swipe input, a hold-and-drag input, a gaze input, an air gesture, and/or a mouse click)) from a detected user. In some embodiments, I/O device 140 enables computer system 100 to identify users associated with and/or without an account within an environment. For example, computer system 100 can detect a known user (e.g., a user that corresponds to an account) and access information about the user using the known user's account. In some embodiments, as part of computer system 100 detecting a user, computer system 100 detects that the user's account is associated with (e.g., is included in and/or identified with respect to) a group of users. For example, computer system 100 can access information associated with a family of accounts in response to detecting a member of the family that is defined as a group of accounts. In some embodiments, as account corresponding to a user can be connected with additional accounts and/or additional computer systems. For example, computer system 100 can detect such additional computer systems and/or detect such computer systems for detecting the user. In some embodiments, computer system 100 detects unknown users and enables guest accounts for the unknown users to utilize computer system 100.

In some embodiments, I/O device 140 includes one or more cameras. In some embodiments, a camera includes an image sensor (e.g., one or more optical sensors and/or one or more depth camera sensors) that provides computer system 100 with the ability to detect a user and/or a user's gestures (e.g., hand gestures and/or air gestures) as input. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body). In some embodiments, the one or more cameras enable computer system 100 to transmit pictorial and/or video information to an application. For example, image data captured by a camera can enable computer system 100 to complete a video phone call by transmitting video data to an application for performing the video phone call.

In some embodiments, I/O device 140 includes one or more microphones. For example, a microphone can be used by 100 to obtain data and/or information from a user without a contact input. In some embodiments, a microphone enables computer system 100 to detect verbal and/or speech input from a user. In some embodiments, computer system 100 utilizes speech input to enable personal assistant functionality. For example, a user eliciting a request to computer system 100 to perform an action and/or obtain information for the user. In some embodiments, computer system 100 utilizes speech input (e.g., along with one or more other input and/or output techniques) to request and/or detect information from a user without requiring the user to make physical contact with computer system 100.

In some embodiments, I/O device 140 includes physical input mediums for a user to interact directly with computer system 100. In some embodiments, a physical input medium includes one or more physical buttons (e.g., tactile depressible button and/or touch sensitive non-depressible component) on computer system 100 and/or connected to computer system 100, a mouse and keyboard input method (e.g., connected to computer system 100 together and/or separately with one or more I/O interfaces), and/or a touch sensitive display component.

In some embodiments, I/O device 140 includes one or more components for outputting information (e.g., a display component, an audio generation component, a speaker, a haptic output device, a display screen, a projector, and/or a touch-sensitive display). In some embodiments, computer system 100 uses I/O device 140 to convey information and/or a state of computer system 100. In some embodiments, I/O device 140 includes a tactile output component. For example, a tactile output component can be a haptic generation component that enables computer system 100 to convey information to a user in contact with (e.g., holding, touching, and/or nearby) computer system 100. In some embodiments, I/O device 140 includes one or more components for outputting visual outputs (e.g., video, image, animation, 3D rendering, augmented reality overlay, motion graphics, data visualization, digital art, etc.). For example, displaying content from one or more applications and/or system applications, and/or displaying a widget (e.g., a control that displays real-time information and/or data) corresponding to one or more applications.

In some embodiments, I/O device 140 includes one or more components for outputting audio (e.g., smart speakers, home theater system, soundbars, headphones, earphones, earbuds, speakers, television speakers, augmented reality headset speakers, audio jacks, optical audio output, Bluetooth audio outputs, HDMI audio outputs, audio sensors, etc.). In some embodiments, computer system 100 is able to output audio through the one or more speakers. For example, computer system 100 outputting audio-based content and/or information to a user. In some embodiments, the one or more speakers enable spatial audio (e.g., an audio output corresponding to an environment (e.g., computer system 100 detecting materials and/or objects within the environment and/or computer system 100 altering the audio pattern, intensity, and/or waveform to compensate for varying characteristics of an environment)).

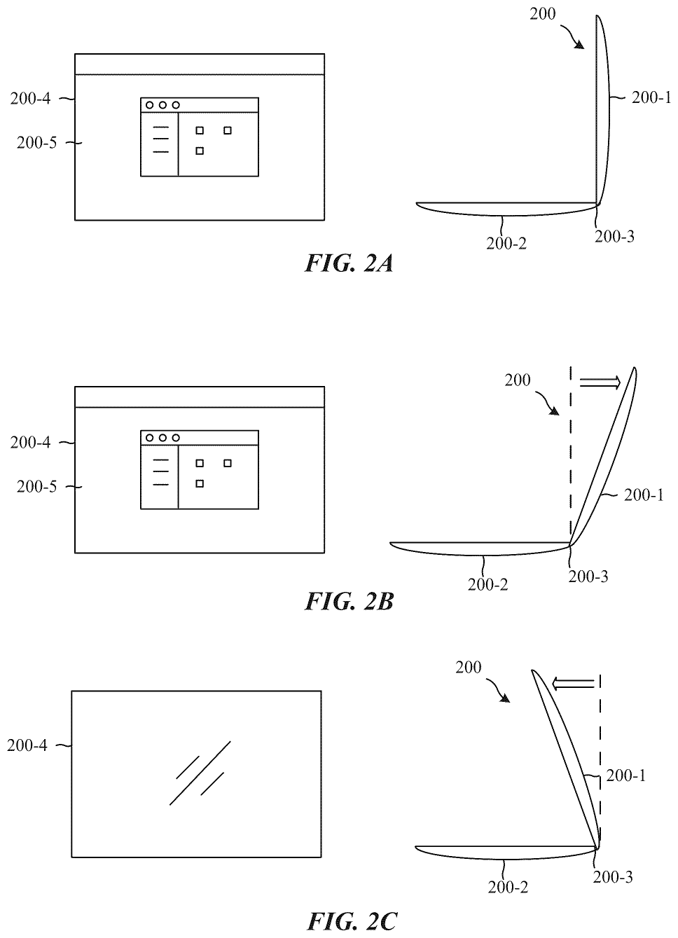

FIGS. 2-5 illustrate exemplary components and user interfaces of electronic device 200 in accordance with some embodiments. Electronic device 200 (sometimes referred to herein as device 200) can include one or more features of computer system 100. In the examples described with respect to FIGS. 2-5, device 200 is a laptop computer. In some embodiments, device 200 is not limited to being a laptop computer and one of ordinary skill in the art should recognize that device 200 can be one or more other devices (e.g., as described herein and/or that include one or more of the components and/or functions described herein with respect to device 200). For example, device 200 can be a communal device (such as a smart display, a smart speaker, and/or a television) and/or a personal device (such as a smart phone, a smart watch, a tablet, a desktop computer, a fitness tracking device, and/or a head mounted display device). In some embodiments, a communal device is configured to provide functionality to multiple users (e.g., at the same time and/or at different times). In such embodiments, the communal device can be administered and/or set up by a single user. In some embodiments, a personal device is configured to provide functionality to a single user (e.g., at a time, such as when the single user is logged into the personal device).

FIGS. 2A-2C illustrate device 200 in three different physical positions. As illustrated in FIG. 2A, device 200 is a laptop computer (also referred to herein as a “laptop”) that includes base portion 200-2 (e.g., that rests on a surface, such as a desk, horizontally as shown in FIG. 2A) and display portion 200-1 that is connected to base portion 200-2 at connection 200-3 (e.g., one or more connection points, a motorized arm, a hinge, and/or a joint) that enables display portion 200-1 to pivot and/or change orientation with respect to base portion 200-2. For example, device 200 can pivot at connection 200-3 to rotate display portion 200-1 and/or device 200 to one or more positions corresponding to an “OFF” internal state (e.g., as further described below in relation to FIG. 2C). In some embodiments, a position corresponding to an “OFF” internal state is a position in which device 200 is in a predetermined pose. For example, a predetermined pose can include display portion 200-1 positioned parallel to base portion 200-2 or display portion 200-1 forming a predetermined angle (e.g., 60-degree angle) with respect to base portion 200-2. In some embodiments, in the “OFF” internal state, an area in which content is displayed by device 200 is positioned in a manner that corresponds to (e.g., represents, is associated with, and/or is configured to accompany) the “OFF” internal state (e.g., facing down, not visible, and/or obscuring the area in which content is displayed). In some embodiments, in the “OFF” internal state, an area in which content is displayed by device 200 is not positioned in a manner that corresponds to (e.g., represents, is associated with, and/or is configured to accompany) the “OFF” internal state (e.g., instead is positioned in a manner that corresponds to an “ON” internal state). For example, when not in the “OFF” internal state, device 200 can be positioned within a range of different open positions (e.g., in which display portion 200-1 is not parallel to base portion 200-2 and the area in which content is displayed by device 200 is visible and/or not obscured). It should be recognized that display portion 200-1 being parallel to base portion 200-2 is an example of a position corresponding to an “OFF” internal state (e.g., a closed position) of device 200. In some embodiments, another configuration could set another orientation of display portion 200-1 with respect to base portion 200-2 as the closed position of device 200, such as illustrated in FIG. 2C.

FIG. 2A illustrates display screen 200-4 (representing the area in which content is displayed by device 200) on the left and device 200 in a corresponding pose on the right. As illustrated in FIG. 2A, device 200 is in a first position (e.g., display portion 200-1 is perpendicular to base portion 200-2 forming a 90-degree angle). In FIG. 2A, display screen 200-4 represents what is currently being displayed (e.g., via a display component) by device 200 while open in the first position. In FIG. 2A, display screen 200-4 illustrates an internal state in which device 200 is “ON” (e.g., operational, powered on, awake, a higher powered and/or more resource intensive state than the “OFF” state, and/or activated). In some embodiments, device 200 displays (e.g., via display screen 200-4) one or more user interfaces (e.g., user interface objects, windows, application user interfaces, system user interfaces, controls, and/or other visual content). In some embodiments, device 200 displays (e.g., via display screen 200-4) the one or more user interfaces while in the “ON” internal state. For example, in FIG. 2A, device 200 is in the “ON” internal state and display screen 200-4 displays a desktop user interface 200-5 that includes an application window. In some embodiments, a user interface includes (and/or is) one or more user interface objects (e.g., windows, icons, and/or other graphical objects). For example, a user interface (e.g., 200-5) can include one or more graphical objects different than, and/or the same as, an application window.

FIG. 2B illustrates display screen 200-4 on the left and device 200 in a corresponding pose on the right. As illustrated in FIG. 2B, device 200 is in a second position (e.g., display portion 200-1 is angled (e.g., via connection 200-3) with respect to base portion 200-2 forming at a 120-degree angle (e.g., a larger angle than in FIG. 2A)). In FIG. 2B, display screen 200-4 represents what is being displayed by device 200 while in the second position. Display screen 200-4 illustrates an internal state in which device 200 is “ON” (e.g., the same internal state as the top diagram of FIG. 2A). In FIG. 2B, device 200 displays (e.g., via display screen 200-4) desktop user interface 200-5 (e.g., and is the same as displayed in FIG. 2A). In some embodiments, device 200 displays a different user interface (e.g., other than desktop user interface 200-5). For example, although FIG. 2B illustrates device 200 displaying the same desktop user interface 200-5 as in FIG. 2A while in a different position than in FIG. 2A, device 200 can display a different user interface. In some embodiments, device 200 displays a user interface that corresponds to (e.g., is based on, due to, caused by, related to, and/or configured to accompany) a physical state (e.g., position, location, and/or orientation), including content that is specific to a particular angle or specific to a current context.

FIG. 2C illustrates display screen 200-4 on the left and device 200 in a corresponding pose on the right. As illustrated in FIG. 2C, device 200 is in a third position (e.g., display portion 200-1 is angled (e.g., via connection 200-3) with respect to base portion 200-2 forming at a 60-degree angle (e.g., a smaller angle than in FIG. 2A and FIG. 2B)). In FIG. 2C, display screen 200-4 represents what is being displayed by device 200 while in the third position. In FIG. 2C, display screen 200-4 illustrates an internal state in which device 200 is “OFF” (e.g., not operational, not powered on, not awake, not activated, powered off, asleep, hibernating, inactive, and/or deactivated). In some embodiments, device 200 does not display (e.g., via display screen 200-4) (e.g., forgoes displaying) the one or more user interfaces while in the “OFF” internal state (e.g., does not display any visual content). In some embodiments, device 200 displays (e.g., via display screen 200-4) one or more user interfaces while in the “OFF” internal state (e.g., the same and/or different from one or more user interfaces displayed while in the “ON” internal state) (e.g., a user interface specific to the “OFF” state and/or a manner of displaying a user interface that is not specific to the “OFF” internal state). In FIG. 2C, display screen 200-4 is blank because nothing is being displayed on the display of device 200 (e.g., display screen 200-4 is off and/or not displaying a user interface) (e.g., desktop user interface 200-5 is not displayed on display screen 200-4).

In some embodiments, device 200 includes one or more components (also referred to herein as “movement components”) that enable device 200 to perform (e.g., cause and/or control) movement (and/or be moved). For example, performing movement can include moving a portion of device 200 (e.g., less than or all components of the device move), moving all of device 200 (e.g., the entire device (including all of its components) moves, such as by changing location), and/or moving one or more other devices and/or components (e.g., that are in communication with device 200 and/or movement components of device 200). For example, device 200 can automatically move (e.g., pivot), cause, and/or control movement of display portion 200-1 relative to base portion 200-2, such as to any of the positions illustrated in FIGS. 2A-2C. In some embodiments, device 200 performs movement based on an internal state of device 200. Performing movement based on an internal state can enable new (e.g., otherwise unavailable) interactions by device 200. For example, such new interactions of device 200 can be configured using special features, functions, modes, and/or programs that take advantage of the ability of device 200 to perform movement. Examples of such interaction include using movement to communicate (e.g., to a user) an internal state (e.g., on, off, sleeping, and/or hibernating) of the device, to assist with user input (e.g., reduce distance to a user), and/or to augment interaction behavior of the device (e.g., moving in particular ways, during an interaction with a user, that convey information such as importance and/or direction of attention). In some embodiments, the movement performed corresponds to (e.g., is caused by, is in response to, and/or is determined and/or performed based on) one or more of: detected input, detected context (e.g., environmental context and/or user context), and/or an internal state of device 200 (e.g., an internal state and/or a set of multiple internal states). For example, device 200 can perform a movement of the display portion such that device 200 moves from being in the first position illustrated in FIG. 2A to being in the second position illustrated in FIG. 2B. In this example, device 200 can detect that a user has repositioned with respect to device 200 (e.g., the user stood up), and in response, device 200 can perform the movement to the second position so that the display is at an optimized viewing angle based on the repositioned height and/or angle of the user's eyes with respect to the display of device 200. As another example, device 200 can perform a movement such that device 200 moves from being in the first position illustrated in FIG. 2A to being in the third position illustrated in FIG. 2C. In this example, device 200 can perform the movement to the third position in response to detecting an internal state with reduced activity (e.g., the “OFF” internal state as described above). In this way, the movement of device 200 to one or more positions can indicate an internal state of device 200.

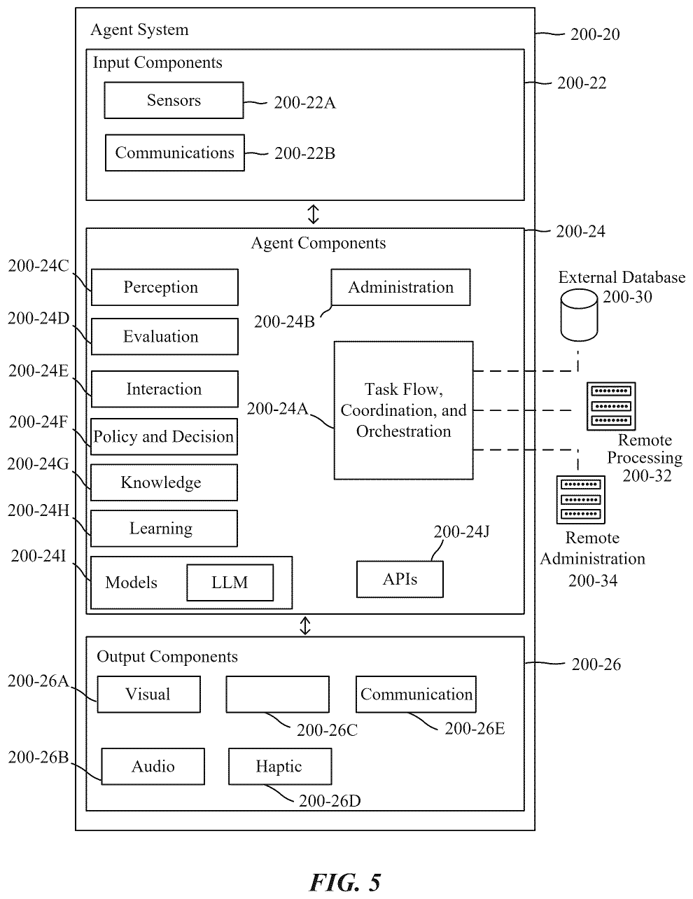

FIGS. 2A-2C illustrate device 200 having a display portion that is able to move with one degree of freedom via connection 200-3 (e.g., a hinge) connecting display portion 200-1 to base portion 200-2. In some embodiments, device 200 includes one or more components that have one or more degrees of freedom. For example, a movement component (e.g., an output component that causes and/or allows movement) (e.g., 200-26C of FIG. 5) of device 200 can include multiple degrees of freedom (e.g., six degrees of freedom including three components of translation and three components of rotation). For example, device 200 can be implemented to be able to move the display portion in a telescoping forward or backward motion (e.g., display portion 200-1 moves forward while base portion 200-2 remains stationary in space relative to the base portion (e.g., to reduce and/or extend viewing distance for a user)). As yet another example, device 200 can be implemented to be able to move the display portion to rotate about an axis that is perpendicular to the hinge such that the display portion can turn to position the display to follow a user as they walk around device 200. While the examples shown in FIGS. 2A-2C illustrate a hinge, other movement components can be included in device 200, such as an actuator (e.g., a pneumatic actuator, hydraulic actuator and/or an electric actuator), a movable base, a rotatable component, and/or a rotatable base. In some embodiments, one or more movement components can cause device 200 to move in different ways, such as to rotate (e.g., 0-360 degrees), to move laterally (e.g., right, left, down, up, and/or any combination thereof), and/or to tilt (e.g., 0-360 degrees).

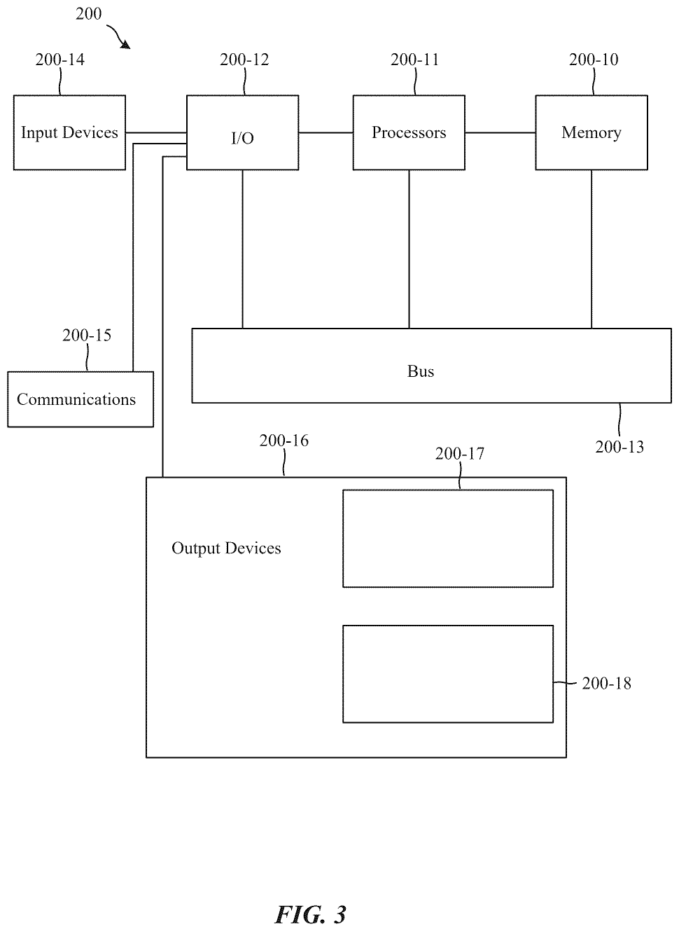

FIG. 3 illustrates exemplary block diagram of device 200. In some embodiments, device 200 includes some or all of the components described with respect to FIGS. 1A, 1B, 3, and 5B. As illustrated in FIG. 3, device 200 has bus 200-13 that operatively couples I/O section 200-12 (also referred to as an I/O subsection and/or an I/O interface) with processors 200-11 and memory 200-10. As illustrated in FIG. 3, I/O section 200-12 is connected to output devices 200-16 (also referred to herein as “output components”). In some embodiments, output devices 200-16 include one or more visual output devices (e.g., a display component, such as a display, a display screen, a projector, and/or a touch-sensitive display), one or more haptic output devices (e.g., a device that causes vibration and/or other tactile output), one or more audio output devices (e.g., a speaker), and/or one or more movement components (e.g., an actuator, a motor, a mechanical linkage, devices that cause and/or allow movement, and/or one or more movement components as described above). As illustrated in FIG. 3, output devices 200-16 include two exemplary movement components (e.g., movement controller 200-17 and actuator 200-18). Actuator 200-18 can be any component that performs physical movement (e.g., of a portion and/or of the entirety) of a device (e.g., device 200 and/or a device coupled to and/or in contact with device 200). Movement controller 200-17 can be any component (e.g., a control device) that controls (e.g., provides control signals to) actuator 200-18. For example, movement controller 200-17 can provide control signals that cause actuator 200-18 to actuate (e.g., cause physical movement). In some embodiments, movement controller 200-17 includes one or more logic component (e.g., a processor), one or more feedback component (e.g., sensor), and/or one or more control components (e.g., for applying control signals, such as a relay, a switch, and/or a control line). In some embodiments, movement controller 200-17 and actuator 200-18 are embodied in the same device and/or component as each other (e.g., a dedicated onboard movement controller 200-17 that is affixed to actuator 200-18). In some embodiments, movement controller 200-17 and actuator 200-18 are embodied in different devices and/or components from each other (e.g., one or more processors 200-11 can function as the movement controller 200-17 of actuator 200-18). In some embodiments, movement controller 200-17 and/or actuator 200-18 are embodied in a device (or one or more devices) other than device 200 (e.g., device 200 is coupled to (e.g., temporarily and/or removably) another device and can instruct movement controller 200-17 and/or control actuator 200-18 of the other device). Actuator 200-18 can function to cause one or more types of mechanical movement (e.g., linear and/or rotational) in one or more manners (e.g., using electric, magnetic, hydraulic, and/or pneumatic power). Examples of actuator 200-18 can include electromechanical actuators, linear actuators, and/or rotary actuators.

As illustrated in FIG. 3, I/O section 200-12 is connected to input devices 200-14. In some embodiments, input devices 200-14 include one or more visual input devices (e.g., a camera and/or a light sensor), one or more physical input devices (e.g., a button, a slider, a switch, a touch-sensitive surface, and/or a rotatable input mechanism), one or more audio input devices (e.g., a microphone), and/or other input devices (e.g., accelerometer, a pressure sensor (e.g., contact intensity sensor), a ranging sensor, a temperature sensor, a GPS sensor, an accelerometer, a directional sensor (e.g., compass), a gyroscope, a motion sensor, and/or a biometric sensor). In addition, I/O section 200-12 can be connected with communication unit 200-15 for receiving application and operating system data, using Wi-Fi, Bluetooth, near field communication (NFC), cellular, and/or other wireless (and/or wired) communication techniques.

Memory 200-10 of personal electronic device 200 can include one or more non-transitory computer-readable storage mediums, for storing computer-executable instructions, which, when executed by one or more computer processors 200-11, for example, cause the computer processors to perform the techniques described below, including processes 700, 900, 1100, 1200, 1300, 1500, 1600, and 1700 (FIGS. 7, 9, 11, 12, 13, 15, 16, and 17). A computer-readable storage medium can be any medium that can tangibly contain or store computer-executable instructions for use by or in connection with the instruction execution system, apparatus, or device. In some embodiments, the storage medium is a transitory computer-readable storage medium. In some embodiments, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, and Blu-ray technologies, as well as persistent solid-state memory such as flash and solid-state drives. Electronic device 200 is not limited to the components and configuration of FIG. 3, but can include other and/or additional components in a multitude of possible configurations, all of which are intended to be within the scope of this disclosure.

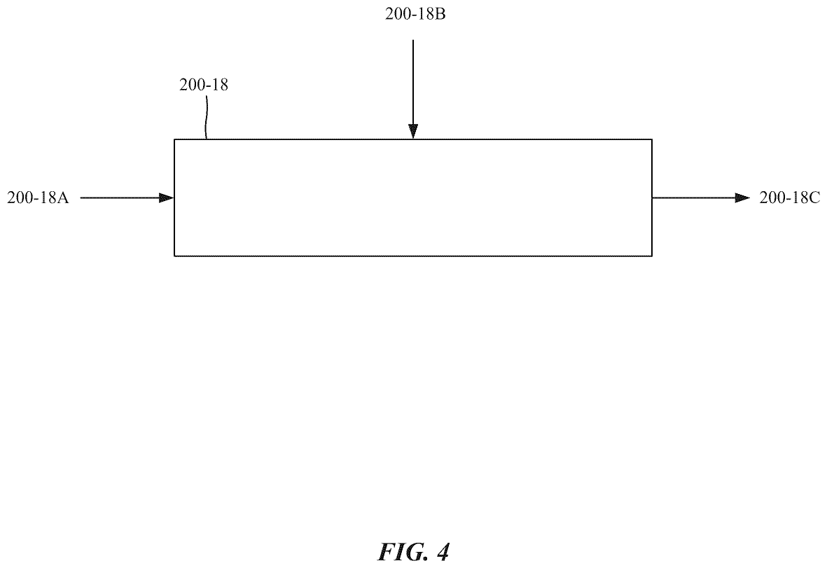

FIG. 4 illustrates a functional diagram of actuator 200-18B in accordance with some embodiments. As described above, actuator 200-18B can be any component that performs physical movement. In some embodiments, actuator 200-18B operates using input that includes control signal 200-18A and/or energy source 200-18B. For example, actuator 200-18 can be a rotary actuator that converts electric energy into rotational movement. This rotational movement can cause the movement of the display portion of device 200 described above with respect to FIGS. 2A-2C (e.g., a counterclockwise rotational movement of the actuator causes device 200 to move to a position having a larger angle (e.g., the second position illustrated in FIG. 2B) and a clockwise (e.g., opposite) rotational movement of the actuator causes device 200 to move to a position having a smaller angle (e.g., the third position illustrated in FIG. 2C)). Control signal 200-18A can indicate one or more start and/or stop instructions, a movement and/or actuation direction, a movement and/or actuation speed, an amount of time to move and/or actuate, a goal position (e.g., pose and/or location) for movement and/or actuation, and/or one or more other characteristics of movement and/or actuation. In some embodiments, the control signal and the energy source are the same signal and/or input. In some embodiments, one or more additional components (e.g., mechanical and/or electric) are coupled (e.g., removably or permanently) to actuator 200-18B for affecting movement and/or actuation (e.g., mechanical linkage such as a lead screw, gears, and/or other component for changing (e.g., converting) a characteristic of movement and/or actuation). In some embodiments, actuator 200-18B includes one or more feedback components (e.g., position sensor, encoder, overcurrent sensor, and/or force sensor) that form part of a feedback loop for modifying and/or ceasing movement and/or actuation (e.g., slowing actuation as a goal position is reached and/or ceasing actuation if physical resistance to actuation is detected via a sensor). In some embodiments, the one or more feedback components are included (e.g., partially and/or wholly) in a movement controller (e.g., movement controller 200-13) operatively coupled to the actuator.

Attention is now turned to functionality (e.g., features and/or capabilities) of one or more devices (e.g., computer system 100 and/or electronic device 200). One such functionality is implementing an “agent,” which can alternatively be referred to as a software agent, an intelligent agent, an interactive agent, a virtual assistant, an intelligent virtual assistant, an interactive virtual assistant, a personal assistant, an intelligent personal assistant, an interactive personal assistant, an intelligent interactive personal assistant, and/or an artificial intelligence (AI) assistant. In some embodiments, an agent refers to a set of one or more functions implemented in hardware and/or software (e.g., locally and/or remotely) on an agent system (e.g., a single device and/or multiple devices). In some embodiments, an agent performs operations to perceive an environment, acquire knowledge, retrieve knowledge, learn skills, interact with users, and/or perform tasks. The agent can, for example, perform these (and/or other) operations in response to user input and/or automatically (e.g., at an appropriate time determined based on a perceived context). A non-exhaustive list of exemplary operations that an agent can be used for and/or with includes: tracking a user's eyes, face, and/or body (e.g., to move with the user and/or identify an intent and/or activity of the user); detecting, recognizing, and/or classifying a user in the environment; detecting and/or responding to input (e.g., verbal input, air gestures, and/or physical input, such as touch input and/or force inputs to physical hardware components (e.g., button, knobs, and/or sliders)); detecting context (e.g., user context, operating context, and/or environmental context); moving (e.g., changing pose, position, orientation, and/or location); performing one or more operations in response to input, context, and/or stimulus (e.g., an object or event (e.g., external and/or internal to a device) that causes one or more responsive operations by a device); providing intelligent interaction capabilities (e.g., due to in part to one or more machine learning (“ML”) models such as a large language model (“LLM”)) for responding and/or causing operations to be performed; and/or performing tasks (e.g., a set of operations for achieving a particular goal) (e.g., automatically and/or intelligently). In some embodiments, an agent performs operations in response to non-contact inputs (e.g., air gestures and/or natural language commands). The preceding list is meant to be illustrative of operations that can be performed using an agent but is not meant to be an exhaustive list. Other operations fall within the intended scope of the capabilities of an agent. Additionally, for the purposes of this disclosure, an agent does not need to include all of the functionality mentioned herein but can include less functionality or more functionality (e.g., an agent can be implemented on an agent system that does not have movement functionality but that otherwise includes an intelligent personal assistant that can interact with a user).

In some embodiments, a user is (e.g., represents, includes, and/or is included in) one or more of a user, person, object, and/or animal in an environment (e.g., a physical and/or virtual environment) (e.g., of the device). In some embodiments, a user is (e.g., represents, includes, and/or is included in) an entity that is perceived (e.g., detected by the device, one or more other devices, and/or one or more components thereof). In some embodiments, an entity is something that is distinguished from surrounding entities (e.g., pieces of environments and/or other users) and/or that is considered as a discrete logical construct via one or more components (e.g., perception components and/or other components). In some embodiments, a user is physical and/or virtual. For example, a physical user can represent a user standing in front of, and being perceived by, the device. As another example, a virtual user can represent an avatar in a virtual scene perceived by the device (e.g., the avatar is detected in a media stream received by the device and/or captured by a camera of the device). Although presented above as examples of a “user,” the terms and/or concepts referred to as “person,” “object,” and/or “animal” can be interchanged with “user” throughout this disclosure, unless explicitly indicated otherwise. For example, use the term “user” can likewise be understood to also refer to “user,” unless explicitly indicated otherwise.

As an example, and referring back to FIGS. 2A-2C, an agent implemented at least partially on device 200 can perform operations that cause display portion 200-1 of device 200 to move with respect to base portion 200-2. For example, the agent detects (e.g., perceives and determines the occurrence of) a context that includes the user standing up (e.g., based on facial detection and tracking); and, in response, the agent causes device 200 to open and/or device 200 opens display portion 200-1 to the larger angle. As another example, the agent can detect verbal input that corresponds to (e.g., is interpreted as and/or that refers to an operation that includes) a request to move the display (e.g., “Please move my display,” or “Please enter sleep mode.”); and, in response, the agent causes device 200 to move and/or device 200 moves display portion 200-1.

FIG. 5 illustrates a functional diagram of an exemplary agent system 200-20A. As illustrated in FIG. 5, agent system 200-20A has a dotted box boundary that encloses input components 200-22, agent components 200-24, and output components 200-26. In some embodiments, agent system 200-20A includes fewer, more, and/or different components than illustrated in FIG. 5. In some embodiments, agent system 200-20 is implemented on a single device (e.g., computer system 100 and/or electronic device 200). In some embodiments, agent system 200-20 is implemented on multiple devices. In some embodiments, one or more components of agent system 200-20 illustrated in and/or described with respect to FIG. 5 are external to but operatively coupled to agent system 200-20 (e.g., an accessory, an external device, an external sensor, an external actuator, an external display component, an external speaker, and/or an external database). In some embodiments, one or more components of agent system 200-20 are local to one or more other components of agent system 200-20. In some embodiments, one or more components of agent system 200-20 are remote from one or more other components of agent system 200-20.

In some embodiments, input components 200-22 includes components for performing sensing and/or communications functions of agent system 200-20. As illustrated in FIG. 5, input components 200-22 includes one or more sensors 200-22A. One or more sensors 200-22A can include any component that functions to detect data corresponding to a physical environment. Examples of one or more sensors 200-22A can include: a camera, a light sensor, a microphone, an accelerometer, a position sensor, a pressure sensor, a temperature sensor, olfactory sensor, and/or a contact sensor. This list is not intended to be exhaustive, and one or more sensors 200-22A can include other sensors not explicitly identified herein that detect, generate, and/or otherwise provide data that can be used (e.g., processed, stored, and/or transformed) for detecting data corresponding to a physical environment. As illustrated in FIG. 5, input components 200-22 includes one or more communications components 200-22B. One or more communications components 200-22B can include any component that functions to send and/or receive communications (e.g., an antenna, a modem, a network interface component, an encoder, a decoder, and/or a communication protocol stack) internal and/or external to agent system 200-20. Communications components 200-22B can be between different devices and/or between components of the same device. The communications can include control signals and/or data (e.g., messages, instructions, files, application data, and/or media streams). In some embodiments, input components 200-22 includes fewer, more, and/or different components than those illustrated in FIG. 5. In some embodiments, input components 200-22 are implemented in hardware and/or software.

In some embodiments, agent components 200-24 includes components that manage and/or carry out functions of an agent of agent system 200-20. As illustrated in FIG. 5, agent components 200-24 includes the following functional components: task flow, coordination, and/or orchestration component 200-24A, administration component 200-24B, perception component 200-24C, evaluation component 200-24D, interaction component 200-24E, policy and decision component 200-24F, knowledge component 200-24G, learning component 200-24H, models component 200-241, and APIs component 200-24J. Each of these components is described briefly below. Notably, this list of agent components 200-24 is not intended to be exhaustive, and agent components 200-24 can include other functional components not explicitly identified herein that can be used (e.g., processed, stored, and/or transformed) for performing any function of an agent, such as those described herein. In some embodiments, agent components 200-24 includes fewer, more, and/or different components than those illustrated in FIG. 5. In some embodiments, agent components 200-24 is implemented in hardware and/or software.

In some embodiments, task flow, coordination, and/or orchestration component 200-24A performs operations that enable an agent to handle coordination between various components. For example, operations can include handling a data processing task flow to move from perception component 200-24C (e.g., that detects speech input) to models component 200-241 (e.g., for processing the detected speech input using a large language model to determine content and/or intent of the speech input). In some embodiments, task flow, coordination, and/or orchestration component 200-24A performs operations that enable an agent to handle coordination between one or more external components (e.g., resources). For example, FIG. 5 illustrates examples of external components, such as external database 200-30. In some embodiments, administration component 200-24B includes functionality performed by an operating system of a device implementing agent system 200-20. In some embodiments, administration component 200-24B includes functionality performed by one or more applications of a device implementing agent system 200-20.

In some embodiments, administration component 200-24B performs operations that enable an agent system to handle administrative tasks like managing system and/or component updates, managing user accounts, managing system settings, and/or managing component settings. In some embodiments, administration component 200-24B includes functionality performed by an operating system of a device implementing agent system 200-20. In some embodiments, administration component 200-24B includes functionality performed by one or more applications of a device implementing agent system 200-20.

In some embodiments, perception component 200-24C performs operations that enable an agent to perceive environmental input. For example, operations can include detecting that a context and/or environmental condition has occurred, detecting the presence of a user (e.g., user, person, object, and/or animal in an environment), detecting an input that includes speech, detecting an input that includes an air gesture, detecting facial expressions, detecting characteristics (e.g., visible and/or non-visible) of a user, and/or detecting verbal and/or physical cues. In some embodiments, perception component 200-24C includes functionality performed by an operating system of a device implementing agent system 200-20. In some embodiments, perception component 200-24C includes functionality performed by one or more applications of a device implementing agent system 200-20.

In some embodiments, evaluation component 200-24D performs operations that enable an agent to process evaluate data (e.g., to determine a context such as a user context, an environmental context, and/or an operating context). For example, operations can include evaluating data gathered from perception component 200-24C, knowledge component 200-24G, external database 200-30, and/or remote processing resource 200-32. In some embodiments, evaluation component 200-24D includes functionality performed by an operating system of a device implementing agent system 200-20. In some embodiments, evaluation component 200-24D includes functionality performed by one or more applications of a device implementing agent system 200-20.

Reference is made herein to environmental context (also referred to herein as a “context of an environment” and/or “a context corresponding to an environment”). In some embodiments, an environmental context is a context based on one or more characteristics of the environment (e.g., users, locations, time, weather, and/or lighting). For example, an environmental context can include that it is raining outside, that it is daytime, and/or that a device is currently located in a park. In some embodiments, a device (e.g., using an agent) determines an environmental context (e.g., to be currently true, occurring, and/or applicable) using one or more of detecting input (e.g., via one or more input components) and/or receiving data (e.g., from one or more other devices and/or components in communication with the device).

Reference is made herein to user context (also referred to herein as a “context of a user” and/or “a context corresponding to a user”) (and/or a user context). In some embodiments, a user context is a context based on one or more characteristics of the user (and/or a user). For example, a user context can include the user's appearance and/or clothing, personality, actions, behavior, movement, location, and/or pose. In some embodiments, a device (e.g., using an agent) determines a user context (e.g., to be currently true, occurring, and/or applicable) using one or more of detecting input (e.g., via one or more input components) and/or receiving data (e.g., from one or more other devices and/or components in communication with the device). In some embodiments, a device determines user context based on historical context and/or learned characteristics of the user, where one or more characteristics of the user are learned and/or stored over a period of time by the device.

Reference is made herein to operational context (also referred to herein as a “context of operation” and/or an “operating context”). In some embodiments, an operational context is a context based on one or more characteristics of the operation of a device (e.g., the device determining and/or accessing the operational context and/or one or more other devices). For example, an operational context can include the internal state of the device (and/or of one or more components of the device), an internal dialogue of the device (e.g., the device's understanding of a context), operations being performed by the device, applications and/processes that are executing (e.g., running and/or open) on the device. In some embodiments, a device (e.g., using an agent) determines an operational context (e.g., to be currently true, occurring, and/or applicable) using one or more of detecting input (e.g., via one or more input components) and/or receiving data (e.g., from one or more other devices and/or components in communication with the device). In some embodiments, a device (e.g., using an agent) determines an operational context (e.g., to be currently true, occurring, and/or applicable) using one or more internal states (e.g., accessed, retrieved, and/or queried by a process of the device).

In some embodiments, interaction component 200-24E performs operations that enable an agent to manage and/or perform interactions with users. For example, operations can include determining an appropriate interaction model for a particular context and/or in response to a particular input. In some embodiments, interaction component 200-24E includes functionality performed by an operating system of a device implementing agent system 200-20. In some embodiments, interaction component 200-24E includes functionality performed by one or more applications of a device implementing agent system 200-20.

In some embodiments, policy and decision component 200-24F performs operations that enable an agent to take actions in view of available data. For example, operations can include determining which operations to perform and/or which functional components to utilize in response to a detected context. In some embodiments, policy and decision component 200-24F includes functionality performed by an operating system of a device implementing agent system 200-20. In some embodiments, policy and decision component 200-24F includes functionality performed by one or more applications of a device implementing agent system 200-20.

In some embodiments, knowledge component 200-24G performs operations that enable an agent to access and use stored knowledge. For example, operations can include indexing, storing, and/or retrieving data from a data store, a database, and/or other resource. In some embodiments, knowledge component 200-24G includes functionality performed by an operating system of a device implementing agent system 200-20. In some embodiments, knowledge component 200-24G includes functionality performed by one or more applications of a device implementing agent system 200-20.

In some embodiments, learning component 200-24H performs operations that enable an agent to learn through experiences. For example, operations can include observing and/or keeping track of data that includes preferences, routines, user characteristics, and/or environmental characteristics in a manner in which such data can be used to inform future operation by the agent and/or a component thereof (e.g., such as when performing tasks and/or interactions with users). In some embodiments, learning component 200-24H includes functionality performed by an operating system of a device implementing agent system 200-20. In some embodiments, learning component 200-24H includes functionality performed by one or more applications of a device implementing agent system 200-20.

In some embodiments, models component 200-241 performs operations that enable an agent to apply ML models (e.g., such as a large language model (LLM)) to process data. For example, operations can include storing ML models, executing ML models, training and/or re-training ML models, and/or otherwise managing aspects of implementing ML models. In some embodiments, models component 200-241 includes functionality performed by an operating system of a device implementing agent system 200-20. In some embodiments, models component 200-241 includes functionality performed by one or more applications of a device implementing agent system 200-20.

In some embodiments, agent system 200 responds to natural language input. For example, agent system 200 responds to a natural language input that is in the form of a statement, a question, a command, and/or a request. In some embodiments, agent system 200 outputs text and/or speech output that is provided in a natural language or mimicking a natural language style. For example, agent system 200 can process the natural language question “How hot is it outside?” with a speech response that indicates the current temperature outside at the user's location (e.g., “It is 18 degrees outside.”). In some embodiments, agent system 200 responds to natural language input by providing information (e.g., weather, travel, and/or calendar information) and/or performing a task (e.g., opening a document, searching a database, and/or opening an application).

In some embodiments, agent system 200 includes and/or relies on one or more data models to process input (e.g., natural language input, gesture input, visual input, and/or other data input) and/or provide output (e.g., output of information via natural language output, visual output, audio output, and/or textual output). Such data models can include and/or be trained using user data (e.g., based on particular interactions and/or data from the user being interacted with) and/or global data (e.g., general data based on interactions and/or data from many users). For example, user data (e.g., preferences, previous use of language and/or phrases, calendar entries, a contact list, and/or activity data) can be used to better infer user intent and/or provide responses that are more likely to address a user's request. In some embodiments, data models used by agent system 200 include, are used by, and/or are implemented using one or more machine learning components (e.g., hardware and/or software) (e.g., one or more neural networks). Such machine learning components can be used to process verbal input to determine words and/or phrases therein, one or more contexts that correspond to the words, a user intent corresponding to the words, one or more confidence scores, and/or a set of one or more actions to take in response to the verbal input. Analogous operations can be performed to process other types of inputs, such as visual input, data input, and/or textual input. Such data models can include machine learning and/or data processing models, including, but not limited to, natural language processing models, language models, speech recognition models, object recognition models, visual processing models, ontologies, task flow models, and/or intent recognition models (e.g., used to determine user intent).

In some embodiments, Application Programming Interfaces (APIs) component 200-24J performs operations that enable an agent to interface with services, devices, and/or components. For example, operations can include relaying data (e.g., requests, responses, and/or other messages) between data interfaces (e.g., between software programs, between a system process and application process, between system processes, between application processes, between communication protocols, between a client and a server, between file systems, and/or between components on different sides of a trust boundary). In some embodiments, the data interfaces served by APIs component 200-24J are local (e.g., to the device, such as two application processes exchanging data) and/or remote (e.g., from the device, such as interfacing with a web service via a remote server). In some embodiments, APIs component 200-24J includes functionality performed by an operating system of a device implementing agent system 200-20. In some embodiments, APIs component 200-24J includes functionality performed by one or more applications of a device implementing agent system 200-20.

In some embodiments, output components 200-26 includes components for performing output functions of agent system 200-20. The exemplary output components illustrated in FIG. 5 are described briefly below. In some embodiments, output components 200-26 include fewer components, more, and/or different components than those illustrated in FIG. 5. In some embodiments, input components is implemented in hardware and/or software.

As illustrated in FIG. 5, output components 200-26 includes one or more visual output components 200-26A. One or more visual output components 200-26A can include any component that functions to output (e.g., generate, create, and/or display), and/or cause output of, a visual output (e.g., an output that is visually perceptible, such as graphical user interface, playback of visual media content, and/or lighting). Examples of one or more visual output components 200-26A can include: a display component, a projector, a head mounted display (HMD), a light-emitting diode (“LED”), and/or a component that creates visually perceptible effects (e.g., movement). This list is not intended to be exhaustive, and one or more visual output components 200-26A can include other visual output components not explicitly identified herein that detect, generate, and/or otherwise provide data that can be used (e.g., processed, stored, and/or transformed) for outputting visual output.

As illustrated in FIG. 5, output components 200-26 include one or more audio output components 200-26B. One or more audio output components 200-26B can include any component that functions to output (e.g., generate and/or create), and/or cause output of, an audio output (e.g., an output that is audibly perceptible, such as a sound, music, speech, and/or audio media content). Examples of one or more audio output components 200-26B can include: a speaker, an audio amplifier, a tone generator, and/or a component that creates audibly perceptible effects (e.g., movement such as vibrations). This list is not intended to be exhaustive, and one or more audio output components 200-26B can include other audio output components not explicitly identified herein that detect, generate, and/or otherwise provide data that can be used (e.g., processed, stored, and/or transformed) for outputting audio output.

As illustrated in FIG. 5, output components 200-26 include one or more movement output components 200-26C (also referred to herein as a “movement component”). One or more movement output components 200-26C can include any component that functions to output (e.g., generate and/or create), and/or cause output of, a movement output (e.g., an output that includes physical movement of the device and/or another device/component). Examples of one or more movement output components 200-26C can include: a movement controller, an actuator, a mechanical linkage, an electromechanical device, and/or a component that creates physical movement. This list is not intended to be exhaustive, and one or more movement output components 200-26C can include other movement output components not explicitly identified herein that detect, generate, and/or otherwise provide data that can be used (e.g., processed, stored, and/or transformed) for outputting movement output. As illustrated in FIG. 5, output components 200-26 include one or more haptic output components 200-26D. One or more haptic output components 200-26D can include any component that functions to output (e.g., generate, create, and/or display), and/or cause output of, a haptic output (e.g., an output that is physically perceptible using tactile sensation, such as a vibration, pressure, texture, and/or shape). Examples of one or more haptic output components 200-26D can include: a speaker, a component that generates vibrations, a component that generates texture changes, a component that generates pressure changes, and/or a component that creates perceivable tactile effects. This list is not intended to be exhaustive, and one or more haptic output components 200-26D can include other haptic output components not explicitly identified herein that detect, generate, and/or otherwise provide data that can be used (e.g., processed, stored, and/or transformed) for outputting haptic output.

As illustrated in FIG. 5, output components 200-26 include one or more communications components 200-26E. One or more communications components 200-26E can include any component that functions to send and/or receive communications (e.g., an antenna, a modem, a network interface component, an encoder, a decoder, and/or a communication protocol stack) internal and/or external to agent system 200-20. In some embodiments, the communications can be between different devices and/or between components of the same device. In some embodiments, the communications can include control signals and/or data (e.g., messages, instructions, files, application data, and/or media streams). In some embodiments, one or more communications components 200-26E includes one or more features of one or more communications components 200-22B (e.g., as described above). In some embodiments, one or more communications components 200-26E are the same as one or more communications components 200-22B (e.g., one or more components that handle communication inputs and outputs and thus be considered as either and/or both an input component and an output component).

Throughout this disclosure, reference can be made to movement output (e.g., referred to in various forms such as: movement, device movement, output of movement, device motion, output of motion, and/or motion output). In some embodiments, outputting (e.g., causing output of) movement refers to movement of an electronic device (e.g., a portion or component thereof relative to another portion and/or of the whole electronic device). For example, referring back to FIG. 2B, movement output can refer to device 200 actuating movement component 200-3 to move display portion 200-1 to the position illustrated in FIG. 2B (e.g., from the position in FIG. 2A). In some embodiments, movement output is not (e.g., does not include and/or does not only include) haptic output (e.g., haptic movement output). In some embodiments, movement output is not (e.g., does not include and/or does not only include) vibration output. In some embodiments, movement output is not (e.g., does not include and/or does not only include) oscillating movement (e.g., movement of an actuator that merely causes vibration by moving a component repeatedly along a path that is internal to the device). In some embodiments, movement output includes (e.g., requires and/or results in) changing a location and/or pose of at least a portion of (and/or the entirety of) a component or the electronic device. In some embodiments, movement output includes output that moves at least a portion of (and/or the entirety of) a component or the electronic device from a first location and/or first pose to a second location and/or second pose. For example, with respect to FIGS. 2A-2C, display portion 200-1 is shown in a different location (e.g., in space) and pose (e.g., relative to base portion 200-2) in each of FIGS. 2A, 2B, and 2C. In some embodiments, movement output includes output that moves at least a portion (and/or the entirety of) a component or the electronic device to a third location and/or third pose (e.g., from the first location and/or first pose and/or from the second location and/or the second pose). In some embodiments, the third location and/or the third pose is the same as the first location and/or first pose and/or as the second location and/or the second pose. For example, movement output can include device 200 in FIG. 2A beginning from the first position illustrated in FIG. 2A, moving to the second position illustrated in FIG. 2B, and moving to return to the first position illustrated in FIG. 2A. For example, movement output can include device 200 in FIG. 2A beginning from the first position illustrated in FIG. 2A, moving to the second position illustrated in FIG. 2B, and continuing movement to come to rest at the third position illustrated in FIG. 2C.

Throughout this disclosure, an electronic device can be illustrated in (and/or described as being in) different locations and/or poses at different times. For example, in FIG. 2A illustrates device 200 in the first position, FIG. 2B illustrates device 200 in the second position, and FIG. 2A illustrates device 200 in the third position. In some embodiments, the electronic device moves itself between such locations and/or poses (e.g., using movement output). For example, device 200 moves from the first position to the second position under its own power (e.g., using a power source and one or more actuators to cause movement). In particular, any example herein that illustrates and/or describes an electronic device being at different locations and/or poses (e.g., at different times) should be understood to cover a scenario in which the device moved itself between such locations and/or poses (e.g., unless otherwise clearly indicated).

Throughout this disclosure, reference can be made to “performing output,” “causing output,” and/or “outputting” (e.g., by one or more output generation devices and/or by one or more output generation components) (and/or similar such phrases). In some embodiments, outputting (e.g., or the aforementioned variants) includes (and/or is) outputting movement (e.g., movement output as described above).

Throughout this disclosure, reference can be made to “displaying,” “causing display of,” and/or “outputting visual content” (e.g., by one or more display components) (and/or similar such phrases). In some embodiments, displaying (e.g., or the aforementioned variants) includes displaying visual content in connection with outputting movement (e.g., movement output as described above).

Throughout this disclosure, reference can be made to “outputting audio,” “causing output of audio,” and/or “providing audio output” (e.g., by one or more audio generation components and/or by one or more audio output devices) (and/or similar such phrases). In some embodiments, outputting audio (e.g., or the aforementioned variants) includes outputting audio content in connection with outputting movement (e.g., movement output as described above).

Throughout this disclosure, reference can be made to movement of an avatar (e.g., or other representation of a user, an agent and/or a character that is displayed) (e.g., by one or more display components) (and/or similar such phrases). In some embodiments, moving an avatar (e.g., or the aforementioned variants) includes displaying movement of visual content in connection with outputting movement (e.g., movement output as described above). For example, displaying an avatar nodding in agreement can include movement of the electronic device in a similar manner as the avatar movement (e.g., mimicking nodding). In some embodiments, moving an avatar (e.g., or the aforementioned variants) includes outputting movement (e.g., movement output as described above) without displaying movement of visual content. For example, a device can perform movement output that mimics nodding without moving a displayed avatar (e.g., the avatar does not move relative to the display). As illustrated in FIG. 5, agent system 200-20 can optionally interface with external components such as external database 200-30, remote processing component 200-32, and/or remote administration component 200-34. In some embodiments, external database 200-30 represents one or more functions that provide data storage resources accessible to agent system 200-20. In some embodiments, access to the data of external database 200-30 is provided directly to agent system 200-20 (e.g., the agent system manages the database) and/or indirectly to agent system 200-20 (e.g., a database is managed by a different system, but data stored therein can be provided and/or stored for use by agent system 200-20). In some embodiments, external database 200-30 is dedicated to (e.g., only for use by) agent system 200-20, is not dedicated to agent system 200-20 (e.g., is a database of a web service accessible to different agent systems), and/or is a combination of both dedicated and non-dedicated database resources. In some embodiments, remote processing component 200-32 represents one or more components that function as a data processing resource that is accessible to agent system 200-20. In some embodiments, access to remote processing component 200-32 is provided directly to agent system 200-20 (e.g., the agent system manages the processing resources) and/or indirectly to agent system 200-20 (e.g., a processing resource managed by a different system, but that can provide data processing for the benefit of agent system 200-20). In some embodiments, remote processing component 200-32 is dedicated to (e.g., only for use by) agent system 200-20, is not dedicated to agent system 200-20 (e.g., is a processing resource of a web service accessible to different agent systems), and/or is a combination of both dedicated and non-dedicated processing resources. Examples of data processing include processing image data (e.g., for feature extraction and/or object detection), processing audio data (e.g., for processing natural language speech input via a large language model), and/or training a machine learning algorithm and/or model. In some embodiments, remote administration component 200-34 represents functions that include and/or are related to administrative functions. For example, such administrative functions can include providing component updates to agent system 200-30 (e.g., software and/or firmware updates), managing accounts (e.g., permissions, access control, and/or preferences associated therewith), synchronizing between different agent systems and/or components thereof (e.g., such that an agent accessible via multiple devices of a user can provide a consistent user experience between such devices), managing cooperation with other services and/or agent systems, error reporting, managing backup resources to maintain agent system reliability and/or agent availability, and/or other functions required by agent system 200-20 to perform operations, such as those described herein.

The various components of agent system 200-20 described above with respect to FIG. 5 represent functional blocks that represent functionality. This functionality can be implemented on the same and/or different hardware (e.g., physical components) and/or by the same and/or different software. For example, the functional blocks can be implemented using one or more physical components, devices (e.g., computer system 100 and/or electronic device 200), and/or software programs. In other words, each functional block does not necessarily represent a single, discrete physical component, device, and/or software program, but can be implemented using one or more of these. Further, agent system 200-20 can include multiple implementations of functionality represented by a respective functional block. For example, agent system 200-20 can include multiple different model components representing ML models that are used in different contexts, can include multiple different API components representing different APIs that are used for different services, and/or can include multiple different visual output components that are used for outputting different types of visual output.

Attention is now turned to discussion of concepts that can arise with respect to operation of an agent.

As discussed throughout, an agent can be capable of interacting with a user. In some embodiments, this capability includes the ability to process explicit requests, commands, and/or statements. In some embodiments, explicit requests, commands, and/or statements include and/or are interpreted as instructions directed to accomplishing a task (e.g., display X, complete task Y, and/or perform operation Z). In some embodiments, an agent includes the ability to process implicit requests, commands, and/or statements. In some embodiments, an implicit request, command, and/or statement does not include an explicit request, command, and/or statement. For example, “I like going to Europe,” can be interpreted as an implicit request, command, and/or statement which, in response to detecting, device 200 displays an itinerary in response to the statement. As another example, “This picture is for my grandmother,” can be interpreted as an implicit request, command, and/or statement which, in response to detecting, device 200 displays suggestions for modifying the picture). As another example, “I'm so tired,” can be interpreted as an implicit request, command, and/or statement which, in response to detecting, device 200 causes a sleep meditation application to begin a meditation session. As yet another example, “I miss my grandad” can be interpreted as an implicit request, command, and/or statement when, in response to detecting, device 200 can initiate a live communication session (e.g., telephone call, video call, and/or text messaging session) with grandad. In some embodiments, an implicit request is more likely to be processed according to one or more current environmental context, operational context, and/or user context, while an explicit request is less likely to be processed according to one or more current environmental context, operational context, and/or user context. For example, the phrase, “call my grandad,” can be an explicit request, and in response to detecting the request, device 200 will initiate a live communication session with grandad, irrespective of one or more current environmental context, operational context, and/or user context. However, the phrase, “I miss my grandad,” can be an implicit request, and in response to detecting the request, device 200 can display a list of gifts to buy for grandad if a user has been recently talking about buying gifts or could call grandad in another context that does not include the user recently discussing buying gifts. In some embodiments, a request can include one or more explicit requests and one or more implicit requests. In some embodiments, an implicit request is responded to independently from an explicit request; and in other embodiments, a response to an implicit request is dependent on an explicit request.

Reference can be made herein to a response by an agent that is output by a device. In some embodiments, a response includes an audio portion (e.g., audio output, acoustic output, sound, and/or speech) (also referred to herein as a “verbal response,” an “audio response,” and/or an “acoustic response) and/or a visual portion (e.g., display and/or movement of a representation and/or avatar). In some embodiments, a response includes a movement portion (e.g., movement of the device). In some embodiments, a response includes a haptic portion (e.g., touch and/or vibration).

Reference can be made herein to an internal dialogue, internal context, and/or an operational context, which can refer to a dynamic context or dynamic decision-making process of the device, an internal state of device 200, and/or internal data the device is partially basing its decision on. In some embodiments, an internal dialogue includes a set of one or more rules, characteristics, detections, and/or observations that the computer system uses to generate a response to one or more commands, questions, and/or statements). In some embodiments, the set of one or more rules, characteristics, detections, and/or observations are learned and/or generated via deep learning and/or one or more machine learning algorithms, and/or using one or more machine learning and/or system agents. In some embodiments, an internal dialogue is generated in real-time. In some embodiments, an internal dialogue is locally stored and/or stored via the cloud. In some embodiments, an internal dialogue can be modified, updated, and/or deleted. In some embodiments, an internal dialogue is generated based on other internal dialogues.

Reference can be made herein to personality and/or behavior (or a representation of personality/behavior) (e.g., of an agent, user, and/or character). In some embodiments, personality and/or behavior refers to a set of one or more characteristics that the device detects, has knowledge of, conforms to, applies, and/or tracks. In some embodiments, the personality or behavior is used as basis to perform operations. For example, an agent can detect a user's personality and respond in a manner based on the personality (e.g., output different responses in response to different user personalities). As another example, the agent can output a response having characteristics that correspond to one or more characteristics that correspond to the personality and/or behavior (e.g., output a response in different ways that depend on personality of the agent). In some embodiments, such characteristics represent and/or mimic personality of a user, such as how the user acts and/or speaks. In some embodiments, such characteristics approximate a user's personality.

In some embodiments, an agent is a system agent. In some embodiments, a system agent is an agent that corresponds to a process that originates from and/or is controlled by an operating system of the device (e.g., the device implementing the agent). In some embodiments, an agent is an application agent. In some embodiments, an application agent is an agent that corresponds to a process that originates from and/or is controlled by an application of (e.g., installed on and/or executed by) the device (e.g., the device implementing the agent).

Reference can be made herein to a representation (e.g., an avatar and/or avatar representation) of an agent (e.g., and/or of a user (e.g., person, object, and/or an animal) and/or a user interface object (e.g., an animated character)). In some embodiments, a representation of an agent refers to a set of output characteristics (e.g., visual and/or audio) of the agent (and/or the user and/or the user interface object). For example, a representation of an agent can include (and/or correspond to) a set of one or more visual characteristics (e.g., facial features of an animated face) and/or one or more audio characteristics (e.g., language and voice characteristics of audio output). In some embodiments, a representation (e.g., of an agent) is used to represent output by the agent. For example, a device implementing an interactive agent outputs audio in a voice of the agent and displays an animated face of the agent moving in a manner to simulate the agent speaking the audio output. In this way, a user can feel like they are having a normal conversation with the agent. In some embodiments, a representation of an agent is (or is not) inclusive of personality and/or behavior characteristics (e.g., as described above). For example, a representation of an agent can include (and/or correspond to) a set of visual characteristics (e.g., facial features of an animated face) and also a set of personality characteristics. In some embodiments, a representation of an agent includes a set of user characteristics that correspond to visual representation of a user (e.g., representations of a user's appearance, voice, and/or personality are used as an avatar that appears to move and/or speak). In some embodiments, a representation is a representation of a face (e.g., a user interface object that is output having features that simulate a face and/or facial expressions of a person (e.g., for conveying information to a viewer)).

In some embodiments, a character (e.g., of an agent and/or avatar) refers to a particular set of characteristics of a representation. For example, an avatar can take on (e.g., use, apply, interact with, and/or output according to) characteristics of a fictional and/or non-fictional character (e.g., from a movie, a show, a book, a series, and/or popular culture).

In some embodiments, a voice (e.g., of an agent and/or avatar) refers to a set of one or more characteristics corresponding to sound output that resembles (e.g., represents, mimics, and/or recreates) vocal utterance (e.g., attributable and/or simulated as being output by an agent and/or avatar). For example, device 200 can output a sentence that sounds different depending on a voice used. In some embodiments, a particular character and/or avatar can be configured to use a particular voice (e.g., have a corresponding voice). In some embodiments, the particular voice can mimic a user's voice.

In some embodiments, an appearance (e.g., of an agent and/or avatar) refers to a set of one or more characteristics corresponding to visual output that represents an avatar (and/or an agent). For example, device 200 can output an avatar that has a set of facial features forming an appearance that resembles a particular character from a movie.

In some embodiments, an expression of an avatar refers to a set of one or more characteristics corresponding to a particular visual appearance of a user, an avatar, and/or an agent. For example, device 200 can output an avatar that has a set of facial features arranged in a particular way to give the appearance of a facial expression (e.g., which can be used as a form of non-verbal communication to a user) (e.g., a frown is an expression of sadness, a smile is an expression of happiness, and/or wide open eyes is an expression of surprise). As another example, device 200 can output an avatar that has a set of body features (e.g., arms and/or legs) arranged in a particular way to give the appearance of a body expression (e.g., which can be used as a form of non-verbal communication to a user) (e.g., a hand gesture is an expression of approval, covering eyes is an expression of fear, and/or shrugging shoulders is an expression of lack of knowledge). In some embodiments, an expression includes movement (e.g., a head nod is an expression of agreement and/or disagreement) of the avatar. In some embodiments, device 200 can move, via the movement component, to indicate an expression with or without the avatar moving. In some embodiments, an agent performs one or more operations that depend on a user's expression (e.g., detects if a person is sad and responds with a kind statement or question). In some embodiments, expressions (e.g., whether and/or how they are used and/or how they are output) depends on personality. For example, a first personality can use a particular expression more than a second personality. As another example, an expression (e.g., frown, smile, and/or how wide eyes are opened) for the first personality can appear different from the expression (and/or a similar and/or equivalent expression) for a second personality (e.g., the first personality smiles in a manner that reveals teeth, but the second personality smiles without revealing teeth).

In some embodiments, an agent (e.g., an avatar of the agent and/or an agent system (e.g., hardware and/or software) implementing the agent) mimics characteristics of another user, agent, and/or character (e.g., in personality, behavior, expressions, and/or voice). In some embodiments, mimicking includes mirroring a user (e.g., copying use of a phrase and/or movement detected from a user interacting with the agent). In some embodiments, mimicking characteristics of a user includes attempting to reproduce the characteristics of the user (e.g., in the exact same manner and/or in manner that resembles the characteristics but is not an exact reproduction of the characteristics). For example, an agent mimicking voice and/or expressions does not require the agent have the exact same voice and/or expressions as the user being mimicked (e.g., but rather simply resembles the user's voice and/or expressions).

In some embodiments, a component and/or device uses (e.g., performs operations, makes decisions, and/or determines context based on) learned characteristics (e.g., characteristics of a context, user, and/or environment that the device has learned over time (e.g., via detection, prior experience, and/or feedback (e.g., from one or more users)). For example, characteristics learned over time can include a user's routine. In such example, if a particular user asks an agent for a summary of any new messages for the user at the same time every day, the agent can learn to perform operations automatically based on the learned characteristics of the routine (e.g., what data is needed, when the data is needed, and/or for which user). In some embodiments, use of learned characteristics enables an agent (and/or device) to improve understanding of (and/or responses to) a context, user, and/or environment, and/or to understand a context, user, and/or environment that otherwise was not (and/or would not be) understood (e.g., not responded to or responded to incorrectly). In some embodiments, learned characteristics are formed (e.g., by and/or for an agent) using reinforcement learning. In some embodiments, learned characteristics correspond to one or more levels of confidence, certainty, and/or reward (e.g., that are shaped by one or more reward functions). In some embodiments, learned characteristics (and/or how they are used to affect output of an agent and/or device) can change over time (e.g., levels confidence, certainty, and/or reward change over time). For example, output of a device before learning a set of learned characteristics can be different from output of the device after learning the set of learned characteristics. In some embodiments, a component and/or device uses learned knowledge. For example, similar to described above with respect to learned characteristics, learned knowledge can refer to information used to update (e.g., enhance, add to, and/or augment) a knowledge base of a device (e.g., for use by an agent implemented thereon). In some embodiments, multiple sets of learned characteristics for a user can be stored and/or used. In some embodiments, different sets of learned characteristics for different users can be stored and/or used.

Reference can be made herein to interaction with an agent (and/or a device). In some embodiments, an interaction refers to a set of one or more inputs and/or outputs of a device implementing the agent and one or more users. For example, an interaction can be an input by a user (e.g., “Please turn on the lights”) and a corresponding output (e.g., causing the lights to turn on and/or a response by the device of “Okay”). In some embodiments, interaction can include multiple inputs/outputs by one or more of the parties to the interaction (e.g., device and/or users). For example, an interaction can include a first input by a user (e.g., “Please turn on the lights”) and a corresponding first output (e.g., “Which lights?”), and also include a second input by the user (e.g., “Kitchen lights”) and a second output from the device (e.g., “Okay”). In some embodiments, which inputs and/or outputs are considered together as an interaction is based on a logical and/or contextual grouping (e.g., interactions within the previous thirty (30) seconds and/or interactions relating to turning on the lights). As one of skill will appreciate, an interaction can be considered in a manner that depends on the implementation (e.g., determining when an interaction is complete can involve determining if the user still present (e.g., speaking at all) and/or if the user still talking about the lights or has moved onto a different topic). In some embodiments, an interaction is a current interaction (e.g., ongoing, presently occurring, and/or active). In some embodiments, an interaction is a previous interaction. The examples above describe a device having a conversation with a user. In some embodiments, a conversation is between two or more users (e.g., users in an environment). For example, a device can detect a conversation between to users (e.g., the users are directing speech and responses to each other, rather than to the device).

In some embodiments an agent (and/or device) determines and/or performs an operation based on an intent corresponding to a user. For example, a device detects user input and outputs a response that depends on an intent of the user input. For example, a device detects user input that includes a pointing gesture detected together with verbal instruction to “turn on that light,” and in response, the device turns on the light that is determined to correspond to the intent of the input (e.g., the light toward which the pointing gesture directed). In some embodiments, intent is determined (e.g., by the device that detects input and/or by one or more other devices) using one or more of: one or more inputs, knowledge (e.g., learned knowledge about a user based on a history of observed behavior, personality, and interactions), learned characteristics, and/or context. In some embodiments, intent is determined from one or more types of input (e.g., verbal input, visual input via a camera, and/or contextual input).

Attention is now directed towards embodiments of user interfaces (“UI”) and associated processes that are implemented on an electronic device, such as computer system 100 and/or electronic device 200.

FIGS. 6A-6B illustrate exemplary techniques for physically adjusting a position of a computer system in accordance with some embodiments. The user interfaces in these figures are used to illustrate the processes described below, including the processes in FIG. 7.

FIGS. 6A-6B illustrate computer system 600 as a tablet. It should be recognized that computer system 600 can be other types of computer systems such as a smart phone, a smart watch, a laptop, a communal device, a smart display, a smart speaker, an accessory, a personal gaming system, a desktop computer, a fitness tracking device, and/or a head-mounted display (HMD) device. In some embodiments, computer system 600 includes and/or is in communication with one or more sensors (e.g., a camera, a LiDAR detector, a motion sensor, an infrared sensor, and/or a microphone). In some embodiments, computer system 600 includes and/or is in communication with one or more output devices (e.g., display screen, projector, touch-sensitive display, haptic output device, and/or speaker). In some embodiments, computer system 600 includes and/or is in communication with one or more movement components (e.g., an actuator, a moveable base, a rotatable component, and/or a rotatable base). In some embodiments, computer system 600 includes one or more components and/or features described above in relation to computer system 100 and/or electronic device 200.

FIGS. 6A-6B illustrate computer system 600 displaying, via a touch-sensitive display, user interface 602 with control 604. In this example, user interface 602 is a confirmation user interface and control 604 is a confirmation control. In some embodiments, user interface 602 is a home screen user interface that includes multiple controls. In some embodiments, user interface 602 is a communication user interface (e.g., phone, email, voice memo, video caller, and/or text messenger) with a control to answer a phone call. In some embodiments, user interface 602 is an entertainment user interface (e.g., media player and/or media streamer) with a control to initiate playback. In some embodiments, user interface 602 is a productivity user interface (e.g., word processor, calendar, spreadsheet, slide show, and/or publication application) with a control to display a menu of options. It should be recognized that other user interfaces and/or other controls can be used with techniques described herein.

FIGS. 6A-6B also illustrate movement indicator 608, which indicates whether a portion (e.g., the touch-sensitive display and/or another component) of computer system 600 is moving, configured to move, and/or currently movable. In some embodiments, in response to determining that computer system 600 is outputting content, computer system 600 moves, via one or more movement components, the portion of computer system 600. For example, in response to displaying an alert within user interface 602, computer system 600 can turn the portion so that user interface 602 is facing a user in an environment. For another example, in response to outputting music via one or more audio devices (e.g., speakers) connected to and/or in communication with computer system 600, computer system 600 can move the portion in sync with music that computer system 600 is outputting. In some embodiments, in response to determining that computer system 600 is outputting content, computer system 600 moves the portion to a predetermined position. For example, in response to receiving an incoming video call, computer system 600 can move the portion to a position (e.g., a location and/or orientation) within the environment that places the user's preferred position in the environment as background for the incoming video call.

In some embodiments, in response to input that computer system 600 detects via one or more sensors, computer system 600 moves the portion via one or more movement components. For example, the input can include an audio input (e.g., voice command and/or statement) from the user such that computer system 600 moves the portion to face a source of the audio input and/or to move according to an instruction in the audio input. For another example, the input can include an air gesture such that the portion is based on the air gesture (e.g., in response to detecting a particular dismissive hand swipe air gesture from the user, computer system 600 can move the portion so that user interface 602 is not facing the user). For another example, the input can include a message received from another device (e.g., remote control, controller, smart watch, smart phone, laptop, communal device, smart speaker, accessory, personal gaming system, desktop computer, fitness tracking device, and/or HMD device) in communication with computer system 600, such as an instruction to move to a particular position. For another example, the input can include a physical input (e.g., button press, touch input, and/or physically moving a portion of computer system 600). For example, in response to detecting a portion of computer system 600 being pushed to the right, computer system 600 can move the portion further to the right.

In some embodiments, in response to detecting movement of the user via one or more sensors, computer system 600 moves the portion in a way that mimics the movement of the user. For example, computer system 600 can lean the portion to the left when the user leans to the left and/or computer system 600 can lean the portion to the right when the user leans to the right. For another example, computer system 600 can raise the portion when the user stands up from a sitting position and/or computer system 600 can lower the portion when the user sits down from a standing position.

FIGS. 6A-6B also illustrate hand 606, which is the hand of a user. In some embodiments, hand 606 is used to illustrate that computer system 600 can move differently depending on proximity of an input mechanism, such as hand 606. In some embodiments, hand 606 is another type of object, such as a stylus and/or a controller.

At FIG. 6A, hand 606 moves towards computer system 600. At FIG. 6A, computer system 600 detects hand 606 moving towards computer system 600. As indicated by movement indicator 608 reading “on,” in response to and/or while detecting hand 606 moving towards computer system 600 but while hand 606 is at least a first predetermined distance away from computer system 600, computer system 600 moves via one or more movement components. In some embodiments, computer system 600 moves the portion according to other input, regardless of hand 606 while hand 606 is at least the first predetermined distance away. For example, computer system 600 can be moving the portion as part of outputting content (e.g., instead of in reaction to detecting hand 606 moving towards computer system 600) while hand 606 is moving towards computer system 600.

In some embodiments, in response to hand 606 being within the first predetermined distance away from computer system 600, computer system 600 moves the portion to align control 604 with hand 606. For example, computer system 600 can move the portion vertically and/or rotate to align a control with hand 606. In some embodiments, computer system 600 tilts the portion to be in a better and/or more comfortable position for a user to provide input using hand 606 (e.g., vertical, in some embodiments, is harder for hand 606 to precisely touch than when the portion is tilted to a particular degree). In some embodiments, computer system 600 moves the portion to bring control 604 closer to hand 606. For example, computer system 600 can move the portion forward to bring an incoming call answer control closer to hand 606. In some embodiments, computer system 600 moves the portion to align with hand 606 as well as move closer to hand 606.

In some embodiments, hand 606 continues to move towards computer system 600 while computer system 600 moves towards hand 606. After FIG. 6A, computer system 600 detects hand 606 within a second predetermined distance to computer system 600. In some embodiments, the second predetermined distance to computer system 600 is closer to computer system 600 than the first predetermined distance to computer system 600. In some embodiments, the first predetermined distance to computer system 600 is the same distance to computer system 600 as the second predetermined distance to computer system 600. In some embodiments, computer system 600 is not displaying control 604 and in response to detecting hand 606 within the first predetermined distance and/or the second predetermined distance of computer system 600, computer system 600 displays control 604.

In some embodiments, as illustrated in FIG. 6B, in response to detecting hand 606 within the second predetermined distance of computer system 600, computer system 600 increases the size of control 604. In other examples, computer system 600 maintains the size of control 604 and instead only changes position of the portion. At FIG. 6B, in response to detecting hand 606 within the second predetermined distance to computer system 600, computer system 600 ceases moving, as indicated by movement indicator 608 reading “off.”

In some embodiments, in response to detecting hand 606 within the first predetermined distance and/or the second predetermined distance to computer system 600, computer system 600 displays an indication that computer system 600 detects hand 606 (e.g., within the first predetermined distance and/or the second predetermined distance). For example, in response to detecting hand 606 within the first predetermined distance to computer system 600, computer system 600 can display a different color along an edge of user interface 602 as an indication that computer system 600 detects hand 606 within the first predetermined distance to computer system 600. In some embodiments, in response to detecting hand 606 within the first predetermined distance and/or the second predetermined distance to computer system 600, computer system 600 outputs audio via one or more audio devices (e.g., speakers) connected to and/or in communication with computer system 600. For example, in response to detecting hand 606 within the second predetermined distance to computer system 600, computer system 600 can output a bell tone to indicate that computer system 600 has detected hand 606 within the second predetermined distance to computer system 600. In some embodiments, in response to ceasing moving, computer system 600 outputs audio via one or more audio devices (e.g., speakers) connected to and/or in communication with computer system 600. For example, in response to ceasing moving, computer system 600 can output the sound of a guitar to indicate to the user that computer system 600 has ceased moving.

FIG. 7 is a flow diagram illustrating a method for physically adjusting a position of a portion of a computer system using a computer system in accordance with some embodiments. Process 700 is performed at a computer system (e.g., 100, 200, and/or 600). Some operations in process 700 are, optionally, combined, the orders of some operations are, optionally, changed, and some operations are, optionally, omitted.

As described below, process 700 provides an intuitive way for physically adjusting a position of a portion of a computer system. The method reduces the cognitive burden on a user for physically adjusting a position of a portion of a computer system, thereby creating a more efficient human-machine interface. For battery operated computing devices, enabling a user to interact with a computer system faster and more efficiently conserves power and increases the time between battery charges.

In some embodiments, process 700 is performed at a computer system (e.g., 600) that is in communication with a movement component (e.g., an actuator, a movable base, a rotatable component, and/or a rotatable base) and one or more input devices (e.g., a camera, a depth sensor, and/or a microphone). In some embodiments, the computer system is a fitness tracking device, watch, a phone, a tablet, a processor, a head-mounted display (HMD) device, and/or a personal computing device.

The computer system detects (702), via the one or more input devices, a first event (e.g., an event occurring in content being displayed by the computer system) (e.g., the occurrence of an action, such as an action performed by a user (e.g., a person, animal, and/or object)) (e.g., a verbal input (e.g., an acoustic request, an acoustic command, and/or an acoustic statement) and/or a non-verbal input (e.g., a swipe input, a hold-and-drag input, a gaze input, an air gesture, and/or a mouse click)) (e.g., hand 606 moving toward computer system 600, as discussed above with respect to FIGS. 6A-6B).

In response to (704) detecting the first event, in accordance with a determination that a first set of one or more criteria is satisfied, wherein the first set of one or more criteria includes a criterion that is satisfied when a portion (e.g., body part (e.g., a hand, finger, foot, neck, and/or shoulder)) (e.g., 606) of a user is not within a first predefined distance (e.g., 1-12 inches) from the computer system, the computer system moves (706) (e.g., causes to physically move, rotates, pushes, and/or pulls), via the movement component, a portion (e.g., a housing and/or an enclosure including a display component and/or the one or more input devices, a center of a display, a and/or hardware button) of the computer system (e.g., 600) (e.g., as described above in relation to FIG. 6A).

In response to (704) detecting the first event, in accordance with a determination that a second set of one or more criteria (e.g., different from the first set of one or more criteria) is satisfied, wherein the second set of one or more criteria includes a criterion that is satisfied when the portion of the user (e.g., 606) is within the first predefined distance from the computer system (e.g., 600), the computer system forgoes (708) moving, via the movement component, the portion of the computer system (e.g., as described above in relation to FIG. 6B). In some embodiments, in response to detecting the first event and in accordance with a determination that the second set of one or more criteria, the computer system physically moves, via the movement component or another movement component different from the movement component, a second portion of the computer system, the second portion different from the first portion. In some embodiments, in response to detecting the first event and in accordance with a determination that the second set of one or more criteria, the computer system forgoes physically moving any portion of the computer system.

While moving, via the movement component, the portion of the computer system (e.g., 600) (e.g., in response to detecting the first event and/or in response to detecting another event different from the first event), the computer system detects (710) that the second set of one or more criteria is satisfied.

In response to detecting the second set of one or more criteria is satisfied (e.g., and/or in response to detecting that the first set of one or more criteria is no longer satisfied) while moving the portion of the computer system (e.g., 600), the computer system ceases (712) (e.g., stops, causes to stop, and/or halts) moving, via the movement component, the portion of the computer system (e.g., as described above in relation to FIG. 6B). In some embodiments, after ceasing moving, via the movement component, the portion of the computer system and in accordance with a determination that the first set of one or more criteria is satisfied (e.g., and/or in accordance with a determination that the second set of one or more criteria is no longer satisfied), the computer system physically moves (e.g., continues to physically move from where the computer system ceased physically moving and/or physically moves in response to detecting a new event in accordance with a determination that the first set of one or more criteria is satisfied), via the movement component, the portion of the computer system. Moving or ceasing to move a portion of the computer system based on prescribed conditions related to the location of a computer system and a user being met enables the computer system to position itself at a distance to the user in anticipation that the user may want to interact with the computer system, thereby providing improved feedback to the user and/or performing an operation when a set of conditions has been met without requiring further user input.

In some embodiments, in accordance with a determination that the first event is a first type of event (e.g., swipe hand gesture, point hand gesture, rotation hand gesture, user moves towards the computer system, user moves away from computer system, user moves parallel to computer system, snapping of fingers, and/or voice input), moving the portion of the computer system (e.g., 600) includes repositioning, via the movement component, the portion of the computer system in a first manner (e.g., rotating (e.g., pitching, yawing, and/or rolling), translating, moving the portion of the computer system towards the user, moving the portion of the computer system away from the user, and/or moving the portion of the computer system towards the user and away from the user) (e.g., as described above in relation to FIGS. 6A and 6B). In some embodiments, in accordance with a determination that the first event is a second type of event (e.g., swipe hand gesture, point hand gesture, rotation hand gesture, user moves towards the computer system, user moves away from computer system, user moves parallel to computer system, snapping of fingers, and/or voice command and/or input) different from the first type of event, moving the portion of the computer system includes repositioning, via the movement component, the portion of the computer system in a second manner (e.g., rotating (e.g., pitching, yawing, and/or rolling), translating, moving the portion of the computer system towards the user, moving the portion of the computer system away from the user, moving the portion of the computer system towards the user and away from the user) different from the first manner (e.g., as described above in relation to FIGS. 6A and 6B). Moving or ceasing to move a portion of the computer system differently based on the type of event enables the computer system to position itself at a distance to the user in anticipation that the user may want to interact with the computer system, thereby providing improved feedback to the user and/or performing an operation when a set of conditions has been met without requiring further user input.

In some embodiments, the first event corresponds to movement of the user (e.g., 606) (e.g., as described above in relation to FIGS. 6A and 6B) (e.g., translation of the user (e.g., the user moves towards the computer system, the user moves away from the computer system, and/or the user moves parallel to the computer system), the user changes its elevation, and/or rotation of the user). In some embodiments, the user moves in two directions with respect to the position of the computer system. In some embodiments, the computer system moves based on the user (e.g., the directionality, the speed, the positioning, the acceleration, and/or the velocity of the user). Having the first event correspond to movement of the user enables the computer system to position itself in response to a user's movement, thereby performing an operation when a set of conditions has been met without requiring further user input, reducing the number of inputs needed to perform an operation, and/or providing improved feedback to the user.

In some embodiments, the first event corresponds to an action that is performed by the user (e.g., 606) (e.g., a hand gesture (e.g., snapping fingers, clapping hands, pointing a finger, a hand swipe), a voice command, and/or an eye gaze) (e.g., the user is sitting, the user is talking, the something is talking about something in particular, the user is watching, and/or the user is yawning). Having the first event correspond to an action performed by the user enables the computer system to position itself in response to a user's performance of an action, thereby performing an operation when a set of conditions has been met without requiring further user input, reducing the number of inputs needed to perform an operation, and/or providing improved feedback to the user.

In some embodiments, the user is a person. In some embodiments, the user is one or more individuals and/or people.

In some embodiments, while moving, via the movement component, the portion of the computer system (e.g., 600) and in accordance with a determination that the user (e.g., 606) (e.g., a portion of the user, a central point of the user, and/or the entirety of the user) is within a second predefined distance (e.g., 1-36 inches) from the computer system and that the user is moving towards (e.g., presently moving towards or will move towards the computer system within a predetermined amount of time (e.g., 1-120 seconds)) the computer system (e.g., while moving, via the movement component, the portion of the computer system), the computer system ceases moving, via the movement component, the portion of the computer system (e.g., as described above in relation to FIG. 6B). In some embodiments, the computer system resumes moving via the movement component when the user transitions to a distance from the computer system that is greater than the second predefined distance. In some embodiments, the computer system continues to move while the user is outside of the second predefined distance from the computer system. In some embodiments, the computer system will not begin moving while the user is within the second predefined distance from the computer system. In some embodiments, the computer system will begin to move based on a determination that the user is outside of the second predefined distance from the computer system. In some embodiments, the second predefined distance is shorter than and/or lesser than the first predefined distance. In some embodiments, while moving, via the movement component, the portion of the computer system and in accordance with a determination that the user is not within the second predefined distance from the computer system and that the user is moving towards the computer system, the computer system continues to move the portion of the computer system. Ceasing moving the portion of the computer system in accordance with a determination that the user is within a second predefined distance from the computer system and that the user is moving towards the user enables the computer system to position itself to a position in anticipation that the user may want to interact with the computer system without the portion forcibly contacting the user, thereby performing an operation when a set of conditions has been met without requiring further user input, reducing the number of inputs needed to perform an operation, and/or providing improved feedback to the user.

In some embodiments, the computer system (e.g., 600) is in communication (e.g., wired communication and/or wireless communication) with a first display component (e.g., a touch sensitive screen and/or a display). In some embodiments, in response to detecting that the second set of one or more criteria is satisfied, the computer system displays, via the first display component, an indication (e.g., 604 enlarging, as described above with respect to FIG. 6B) (e.g., a graphical indication (e.g., a selectable user interface object or a non-selectable user interface object), a representation of the user, a representation of the movement of the user, and/or a textual indication (e.g., instructions on how the user should move, an indication of an operation the computer system will perform if the user continues to move, the voice of a smart assistant and/or an animation)). In some embodiments, the indication ceases to be displayed in accordance with a determination that the portion of the computer system is no longer moving. In some embodiments, the indication continues to be displayed after the portion of the computer system stops moving. Detecting that the second set of one or more criteria is satisfied and then displaying an indication enables the computer system to generate a notification and provides feedback about that status of the movement of the computer system, thereby performing an operation when a set of conditions has been met without requiring further user input, reducing the number of inputs needed to perform an operation, and/or providing improved feedback to the user.

In some embodiments, the computer system (e.g., 600) is in communication (e.g., wired communication and/or wireless communication) with a second display component (e.g., a touch sensitive screen and/or a display). In some embodiments, before detecting the first event, the computer system displays, via the second display component, a first set of one or more user interface elements (e.g., 604) (e.g., user interface elements representative of the first event, representative of the movement of the user, and/or representative of a state of the computer system) at a first size (e.g., as described above in relation to FIG. 6A). In some embodiments, in response to detecting that the second set of one or more criteria is satisfied (e.g., while moving the portion of the computer system), the computer system increases (or, in some embodiments, decreases) the size of the first set of one or more user interface elements from the first size to a second size different from the first size (e.g., as described above in relation to FIG. 6B). In some embodiments, the computer system decreases the size of the display of the first set of one or more user interface objects after a predetermined time has elapsed (e.g., 1-360 seconds). In some embodiments, the computer system decreases the size of the display of the first set of one or more user interfaces in accordance with a determination that the portion of the computer system is no longer moving. In some embodiments, the computer system does not decrease the size of the display of the first set of one or more user interfaces after the computer system enlarges the display of the first set of one or more user interface elements based on the amount of time that has elapsed and/or the state of the computer system. Detecting that the second set of one or more criteria is satisfied and then increasing the size of the first set of one or more user interface elements enables the computer system to generate a notification and provide feedback about that status of the movement of the computer system, thereby performing an operation when a set of conditions has been met without requiring further user input, reducing the number of inputs needed to perform an operation, and/or providing improved feedback to the user.

In some embodiments, the computer system (e.g., 600) displays a second set of one or more user interface elements (e.g., 604) (e.g., user interface elements representative of the first event, representative of the movement of the user, and/or representative of a state of the computer system) while the portion of computer system is moved. In some embodiments, while moving the portion of the computer system and in accordance with a determination that the user (e.g., 606) (e.g., a portion of the user, the entirety of the user and/or a central point of the user) is within a third predefined distance (e.g., 1-36 inches) from the computer system, the computer system increases the size of the second set of one or more user interface elements (e.g., as described above in relation to FIGS. 6A and 6B). In some embodiments, in accordance with a determination that the user is not within the third predefine distance from the computer system, the computer system does not increase the size of the second set of one or more user interface elements. In some embodiments, the third predefined distance is the same or different from the first predefined distance. Displaying a second set of one or more user elements while the portion of the computer system is moved and increasing the size of the second set of one or elements in accordance with a determination that the user is within a third predefined distance from the computer system enables the computer system to generate a notification and provides a status about the movement of the computer system, thereby performing an operation when a set of conditions has been met without requiring further user input, reducing the number of inputs needed to perform an operation, and/or providing improved feedback to the user.

In some embodiments, the first event corresponds to a first type of user (e.g., 606) (e.g., an individual that the computer system is actively tracking, an individual that corresponds to the computer system (e.g., the individual that owns the computer system, the individual that corresponds to a user account that is registered with the computer system and/or an individual that last interacted with the computer system)) (e.g., the targeted individual provides a voice command, moves closer to the computer system, moves away from the computer system, and/or performs a hand gesture (e.g., points a finger, air swipe, and/or hand rotation)). In some embodiments, moving the portion of the computer system (e.g., 600) includes repositioning the portion of the computer system closer to the first type of user. In some embodiments, the computer system detects, via the one or more input devices, a second event (e.g., different or the same as the first event) that corresponds to a second type of user (e.g., an individual that the computer system is not actively tracking, an individual that does not correspond to the computer system (e.g., the individual does not own the computer system, the individual does not correspond to a user account that is registered with the computer system and/or an individual that has not most recently interacted with the computer system)) (e.g., the non-targeted individual provides a voice command, moves closer to the computer system, moves away from the computer system and/or performs a hand gesture (e.g., points a finger, air swipe, and/or hand rotation)) (before, after, and/or while moving the portion of the computer system) (e.g., targeted user, a primary user, a user with a certain amount and/or type of privileges). In some embodiments, in response to detecting that second event that corresponds to the second type of user and in accordance with a determination that the first set of one or more criteria is satisfied, the computer system forgoes moving, via the movement component, the portion of the computer system (e.g., as described above at FIGS. 6A and 6B). Not moving, the portion of the computer system enables the computer system to intelligently determine which users do not require the computer system to reposition itself, thereby performing an operation when a set of conditions has been met without requiring further user input and/or reducing the number of inputs needed to perform an operation. In some embodiments, a computer system tilts when a finger approaches the computer system.

In some embodiments, moving (e.g., causes to physically move, rotates, pushes, and/or pulls), via the movement component, a portion (e.g., a housing and/or an enclosure including a display component and/or the one or more input devices, a center of a display, a and/or hardware button) of the computer system (e.g., 600) includes tilting (and/or rotating) the portion of the computer system in response to detecting that the portion (e.g., an appendage, such as a finger, arm, foot, and/or hand) (e.g., 606) of the first user is moving toward the computer system (e.g., and/or within a predetermined distance (e.g., 0.1-1 meter) of the computer system). Tilting a portion of the computer system based on prescribed conditions related to the location of a computer system and a user being met enables the computer system to tilt to be in a better position to receive input in anticipation that the user may want to interact with the computer system, thereby providing improved feedback to the user and/or performing an operation when a set of conditions has been met without requiring further user input.

Note that details of the processes described above with respect to process 700 (e.g., FIG. 7) are also applicable in an analogous manner to the methods described below/above. For example, process 900 optionally includes one or more of the characteristics of the various methods described above with reference to process 700. For example, moving the portion as described in process 700 can cause an object to be within a path as described in process 900. For brevity, these details are not repeated below.

FIGS. 8A-8C illustrate exemplary user interfaces for a movable computer system in accordance with some embodiments. The user interfaces in these figures are used to illustrate the processes described below, including the processes in FIG. 9.

FIGS. 8A-8C illustrate computer system 600 displaying user interface 802 in a physical environment including another object (e.g., object 804). User interface 802 can be similar or the same as user interface 602 discussed above. In some embodiments, object 804 is a physical object, such as a wine glass, a toy, another device, a person, a pet, and/or a plant. It should be recognized that object 804 can be other types of objects than discussed herein.

Similar to above, FIGS. 8A-8C also illustrate movement indicator 806, which indicates whether the portion of computer system 600 is moving, configured to move, and/or currently movable. Such movement can be based on one or more criteria discussed above with respect to FIGS. 6A-6B.

At FIG. 8A, computer system 600 determines to move (e.g., based on detecting an input, as described above). As indicated by movement indicator 806 reading “on”, in response to determining to move, computer system 600 moves the portion of computer system 600. In this example, computer system 600 is rotating to a new position. It should be recognized that other movements are within the scope of this disclosure. For example, computer system 600 can be moving the portion in some other direction, such as vertically to be at eye level with a user. At a time after determining to move, computer system 600 detects object 804 within the path of movement of the portion of computer system 600.

At FIG. 8B, in response to detecting object 804 within the path of movement, computer system 600 ceases moving the portion of computer system 600, as indicated by movement indicator 806 reading “off”. In some embodiments, as illustrated in FIG. 8B, in response to detecting object 804 within the path of movement (and/or within a predefined distance of the portion), computer system 600 outputs feedback. In this example, outputting the feedback includes displaying visual feedback (e.g., displaying object representation 808 and/or obstruction indication 810, both discussed in greater detail below). In some embodiments, outputting the feedback includes outputting audio feedback (e.g., an audio statement that there is an object in the way and/or alarm sound). In some embodiments, in response to computer system 600 ceasing moving (and/or detecting object 804 (1) within the path of movement and/or (2) within the predefined distance of the portion), computer system 600 outputs haptic feedback, such as to indicate that computer system 600 has ceased moving. In some embodiments, in response to detecting object 804 within the path of movement (and/or within the predefined distance of the portion), computer system 600 outputs a combination of feedback, including audio, haptic, and/or visual feedback. For example, in response to detecting object 804, computer system 600 can (1) output audio feedback and display a caution indication (e.g., obstruction indication 810) to indicate that computer system 600 has detected object 804 within the path of movement and (2) vibrate to indicate that computer system 600 has ceased movement.

As illustrated in FIG. 8B, in response to detecting object 804 within the path of movement (and/or within the predefined distance of the portion), computer system 600 displays object representation 808 at a location within user interface 802 relative to the location of object 804 (e.g., at a position along the edge of user interface 802 that aligns with object 804). In this example, because object 804 is to the right of computer system 600 and is within the path of movement, computer system 600 displays object representation 808 on the right edge of user interface 802. In some embodiments, object 804 is in some other location (e.g., above, below, to the right, and/or to the left) of computer system 600 and is in the path of movement, causing computer system 600 to display object representation 808 at a different location within user interface 802. For example, if object 804 is above computer system 600 and in the path of movement while computer system is moving up, computer system 600 can display object representation 808 along the top edge of user interface 802. In some embodiments, object representation 808 is displayed in a predefined location within user interface 802.

In some embodiments, object representation 808 is a blurring of an edge of user interface 802. In some embodiments, object representation 808 is a color blur the same color as object 804. For example, object representation 808 for a blue water bottle can be a blur of blue along the edge of user interface 802. In some embodiments, object representation 808 is a blurred image of object 804. For example, object representation 808 for a backpack can be a blurred image of the backpack along the edge of user interface 802. In some embodiments, object representation 808 is a small image of object 804 captured by one or more cameras connected to and/or in communication with computer system 600. For example, object representation 808 for the family dog can be a small image of the family dog displayed along the edge of user interface 802 nearest the dog. In some embodiments, computer system 600 detects multiple objects within the path of movement, causing computer system 600 to display multiple object representations. In this example, computer system 600 displays object representations for objects within the path of movement of computer system 600. In some embodiments, computer system 600 displays object representations of objects detected within a predetermined distance from computer system 600 irrelevant of if the object is within the path of movement of computer system 600.

As illustrated in FIG. 8B, in response to detecting object 804 within the path of movement (and/or within the predefined distance or another predefined distance (e.g., different from the predefined distance) of the portion), computer system 600 displays obstruction indication 810 within the upper portion of user interface 802. In some embodiments, obstruction indication 810 indicates that an object represented by object representation 808 needs to be removed from the path of movement of computer system 600. In some embodiments, obstruction indication 810 includes one or more instructions to remove the object from the path of movement. In this example, in response to detecting object 804 within the path of movement, computer system 600 displays obstruction indication 810 in a predefined location (e.g., the upper portion of user interface 802) irrelevant of the location of object 804 in relation to computer system 600. In some embodiments, in response to detecting object 804 within the path of movement, computer system 600 displays obstruction indication 810 at a location within user interface 802 that corresponds to the location of object 804 in relation to computer system 600. For example, in response to detecting object 804 within the path of movement, computer system 600 can display obstruction indication 810 along the edge of user interface 802 farthest from object 804 to not obscure object representation 808, if computer system 600 displays object representation 808 along the edge of user interface 802 closest to object 804. At FIG. 8B, object 804 is moved to a position out of the path of movement of computer system 600. At FIG. 8B, computer system 600 detects object 804 is no longer within the path of movement.

As illustrated in FIG. 8C, in response to detecting that object 804 is no longer within the path of movement, computer system 600 ceases displaying object representation 808. Also illustrated in FIG. 8C, in response to detecting that object is 804 is no longer within the path of movement, computer system 600 ceases displaying obstruction indication 810. As indicated by movement indicator 806 reading “on”, in response to detecting that object 804 is no longer within the path of movement, computer system 600 continues moving the portion. In some embodiments, computer system 600 ceases to display obstruction indication 810 and/or object representation 808 before computer system 600 continues moving. In some embodiments, computer system 600 ceases to display obstruction indication 810 and/or object representation 808 after computer system 600 continues moving. For example, computer system 600 can continue moving after ceasing to display obstruction indication 810 and/or object representation 808. For another example, computer system 600 can cease displaying object representation 808 before continuing moving, continue moving, then cease displaying obstruction indication 810 after continuing moving. In some embodiments, computer system 600 continues moving at the same moment as computer system 600 ceases displaying obstruction indication 810 and/or object representation 808.

In some embodiments, computer system 600 detects a changed condition (e.g., a new input, a change in a position of the user, and/or a change in content being output by computer system 600). In some embodiments, in response to detecting a changed condition, computer system 600 alters and/or updates the path of movement of computer system 600. For example, if computer system 600 is moving along a path of movement based on the position of the user relative to computer system 600 within the environment and the user has moved to a new location relative to computer system 600, computer system 600 can update the path of movement to account for the new position of the user. In some embodiments, after ceasing moving and/or outputting feedback (e.g., as described at FIG. 8B) and in response to detecting object 804, computer system 600 updates the path of movement in response to the changed condition. In some embodiments, in response to computer system 600 updating the path of movement in response to a changed condition, computer system 600 determines that object 804 is no longer within the path of movement. In some embodiments, in response to determining that object 804 is no longer within the path of movement in response to updating the path of movement, computer system 600 moves the portion along the updated path of movement and/or ceases displaying obstruction indication 810 and/or object representation 808. In some embodiments, computer system 600 updates the path of movement in response to detecting a changed condition after computer system 600 continues moving in response to detecting that object 804 is no longer within the path of movement.

In some embodiments, computer system 600 detects a second object within the path of movement after continuing moving, causing computer system 600 to cease moving and repeat the actions and outputs described above with respect to object 804. In some embodiments, computer system 600 detects an object within the direction of movement of computer system 600 while determining that the object is outside the path of movement. Because of the determination that the object is outside the path of movement, computer system 600 does not cease movement. For example, if computer system 600 detects an object to the rear while moving backwards, and computer system 600 determines that the object is beyond the final position of the movement, computer system 600 will not cease moving before reaching the final position.

In some embodiments, in response to detecting object 804 within the path of movement, in addition to performing the action and outputs described in FIG. 8B, computer system 600 sends a request (e.g., via Wi-Fi, Bluetooth, and/or ultra-wideband transmission) to one or more nearby devices (e.g., smart phone, smart watch, laptop, communal device, smart speaker, accessory, personal gaming system, desktop computer, fitness tracking device, and/or HMD device) to output feedback (e.g., haptic feedback, audio feedback, and/or visual feedback). For example, in response to detecting object 804 within the path of movement, computer system 600 can send a request to a nearby smart phone to have the phone vibrate and display an alert informing the user that there is an object in the path of movement of computer system 600.

FIG. 9 is a flow diagram illustrating a method for a movable computer system using a computer system in accordance with some embodiments. Process 900 is performed at a computer system (e.g., 100, 200, and/or 600). Some operations in process 900 are, optionally, combined, the orders of some operations are, optionally, changed, and some operations are, optionally, omitted.

As described below, process 900 provides an intuitive way for a movable computer system. The method reduces the cognitive burden on a user for a movable computer system, thereby creating a more efficient human-machine interface. For battery operated computing devices, enabling a user to interact with a computer system faster and more efficiently conserves power and increases the time between battery charges.

In some embodiments, process 900 is performed at a computer system (e.g., 600) that is in communication with a movement component (e.g., an actuator, a movable base, a rotatable component, and/or a rotatable base), one or more input devices (e.g., a camera, a depth sensor, and/or a microphone), and a display component (e.g., a display screen and/or a touch-sensitive display). In some embodiments, the computer system is a fitness tracking device, watch, a phone, a tablet, a processor, a head-mounted display (HMD) device, and/or a personal computing device.

The computer system detects (902), via the one or more input devices, a first event (e.g., an event occurring in content being displayed by the computer system) (e.g., an action, such as an action performed by an object (e.g., a rain drop, a lightning, a thunder, a person, an animal, and/or a movable object) (e.g., as described above with respect to FIG. 8A).

In response to (904) detecting the first event, in accordance with a determination that a first set of one or more criteria is satisfied, wherein the first set of one or more criteria includes a criterion that is satisfied when a first object (e.g., 804) is not within a path (e.g., a movement path and/or an anticipated movement direction) (e.g., between the computer system and a portion (e.g., a housing and/or an enclosure including a display component and/or the one or more input devices) of a user (e.g., a person, animal, and/or object) and/or a predetermined path and/or course of movement of the computer system), the computer system moves (906) (e.g., causes to physically move, rotates, pushes, and/or pulls), via the movement component, a portion (e.g., as described above in relation to process 700) of the computer system (e.g., as described above in relation to FIG. 8C). In some embodiments, the path of the computer system is determined based on the position of a user.

In response to (904) detecting the first event, in accordance with a determination that a second set of one or more criteria (e.g., different from the first set of one or more criteria) is satisfied, wherein the second set of one or more criteria includes a criterion that is satisfied when the first object (e.g., 804) is within the path (e.g., between the computer system and the portion of the user), the computer system forgoes (908) moving, via the movement component, the portion of the computer system (e.g., as described above in relation to FIG. 8B). In some embodiments, in response to detecting the first event and in accordance with a determination that the second set of one or more criteria, the computer system physically moves, via the movement component or another movement component different from the movement component, a second portion of the computer system, the second portion different from the first portion. In some embodiments, in response to detecting the first event and in accordance with a determination that the second set of one or more criteria, the computer system forgoes physically moving any portion of the computer system.

While moving, via the movement component, the portion of the computer system (e.g., in response to detecting the first event and/or in response to detecting another event different from the first event), the computer system detects (910) that the second set of one or more criteria is satisfied.

In response to (912) detecting the second set of one or more criteria is satisfied (e.g., and/or in response to detecting that the first set of one or more criteria is no longer satisfied) while moving the portion of the computer system, the computer system ceases (914) (e.g., stops, causes to stop, and/or halts) moving, via the movement component, the portion of the computer system (e.g., as described above with respect to FIG. 8B).

In response to (912) detecting the second set of one or more criteria is satisfied while moving the portion of the computer system, the computer system displays (916), via the display component, a first representation of the first object (e.g., 808 and/or 810). In some embodiments, after ceasing physically moving, via the movement component, the portion of the computer system and in accordance with a determination that the first set of one or more criteria is satisfied (e.g., and/or in accordance with a determination that the second set of one or more criteria is no longer satisfied), the computer system physically moves (e.g., continues to physically move from where the computer system ceased physically moving and/or physically moves in response to detecting a new event in accordance with a determination that the first set of one or more criteria is satisfied), via the movement component, the portion of the computer system. Moving or not moving a portion of the computer system based on prescribed conditions related to whether or not a first object within a path of the computer system is satisfied and displaying a first representation of the first object based on the prescribed conditions related to whether or not a first object within a path of the computer system is satisfied enables the computer system to avoid collisions or obstacles while positioning itself and also provide a notification of potential obstacles, thereby providing improved visual feedback to the user and/or performing an operation when a set of conditions has been met without requiring further user input.

In some embodiments, moving, via the movement component, the portion of the computer system includes rotating (e.g., yaw rotation, pitch rotation, and/or roll rotation) the portion of the computer system (e.g., as described above in relation to FIGS. 8A-8C). In some embodiments, the portion of the computer system rotates about one axis of the movement component. In some embodiments, the portion of the computer system rotates about two or more axes of the movement component. In some embodiments, the portion of the computer system is rotated in two or more types of manners (e.g., yaw rotation and roll rotation and/or pitch rotation and yaw rotation). Rotating or not rotating a portion of the computer system based on prescribed conditions related to whether or not a first object within a path of the computer system is satisfied and displaying a first representation of the first object based on the prescribed conditions related to whether or not a first object within a path of the computer system is satisfied enables the computer system to avoid collisions or obstacles by rotating while positioning itself and also provide a notification of potential obstacles, thereby providing improved visual feedback to the user and/or performing an operation when a set of conditions has been met without requiring further user input.

In some embodiments, moving, via the movement component, the portion of the computer system includes rotating, via the movement component, the portion of the computer system about a first axis and a second axis different from the first axis. In some embodiments, ceasing moving, via the movement component, of the portion of the computer system includes: in accordance with a determination that the first object (e.g., 804) is in a first location (e.g., relative to the computer system) (e.g., in front of the computer system, to the side of the computer system, above the computer system, in the path of the computer system, outside of the path of the computer system and/or below the computer system): ceasing rotation (e.g., pitch, yaw and/or roll rotation) of the portion of the computer system about (e.g., around and/or with respect to) a first axis (e.g., a longitudinal axis, a lateral axis, and/or a vertical axis) of the movement component (e.g., as described above in relation to FIGS. 8A-8C); and continuing rotation (e.g., pitch, yaw and/or roll rotation) of the portion of the computer system about a second axis different from the first axis (e.g., a longitudinal axis, a lateral axis, and/or a vertical axis) of the movement component (e.g., as described above in relation to FIGS. 8A-8C); and in accordance with a determination that the first object is in a second location (e.g., relative to the computer system) (e.g., in front of the computer system, to the side of the computer system, above the computer system, in the path of the computer system, outside of the path of the computer system and/or below the computer system) different from the first location: ceasing rotation (e.g., pitch, yaw and/or roll rotation) of the portion of the computer system about the second axis of the movement component (e.g., as described above in relation to FIGS. 8A-8C); and continuing rotation (e.g., pitch, yaw and/or roll rotation) of the portion of the computer system about the first axis of the movement component (e.g., as described above in relation to FIGS. 8A-8C). In some embodiments, the rotation of the portion of the computer system about a respective axis of the movement component resumes based on a determination that the location of the first object changes. In some embodiments, the rotation of the portion of the computer system about a respective axis of the movement component ceases based on a determination that the location of the first object changes.

In some embodiments, the representation (e.g., 808 and/or 810) is displayed at a predefined location (e.g., where 810 is displayed in FIG. 8B) of the display component (e.g., the top, bottom, left, right, and/or center of the display component) (e.g., predefined by a user and/or a default location) (e.g., a location that is closer to the housing of the display than the bottom third, fourth, fifth, sixth, seventh, eighth, ninth, and/or tenth of the display). In some embodiments, the representation is displayed at two or more discrete and separate locations of the display component. In some embodiments, the predefined location of the display component includes two discrete (e.g., separate and/or distinct) locations of the display component. Having the representation be displayed at predefined location of the display component enables the computer system to display a notification at a specific portion of display component that is visible to users, thereby providing improved visual feedback to the user and/or performing an operation when a set of conditions has been met without requiring further user input.

In some embodiments, in accordance with a determination that the first object (e.g., 804) is positioned at a third location (e.g., in front of the computer system, to the side of the computer system, above the computer system, in the path of the computer system, outside of the path of the computer system and/or below the computer system), the representation of the first object (e.g., 808) is displayed via (and/or on, in, and/or at) a first portion (e.g., the top, bottom, left, right, and/or center of the display component) of the display component (e.g., as described above in relation to FIGS. 8A-8C). In some embodiments, in accordance with a determination that the first object is positioned at a fourth location (e.g., in front of the computer system, to the side of the computer system, above the computer system, in the path of the computer system, outside of the path of the computer system and/or below the computer system) different from the third location, the representation of the first object is displayed via (and/or on, in, and/or at) a second portion of the display component (e.g., the top, bottom, left, right, and/or center of the display component) different from the first portion of the display component (e.g., as described above in relation to FIGS. 8A-8C). Displaying the representation of the first object at a first or a second portion of the display component based on prescribed conditions being satisfied enables the computer system to intelligently display notifications about obstructions along the path of the computer system, thereby providing improved visual feedback to the user and/or performing an operation when a set of conditions has been met without requiring further user input.

In some embodiments, while moving, via the movement component, the portion of the computer system, the computer system detects that a third set of one or more criteria is satisfied (e.g., before, after or while displaying the representation of the first object), wherein the third set of one or more criteria include a criterion that is satisfied when a second object (e.g., 804) (e.g., a rain drop, a lightning, a thunder, a person, an animal, and/or a movable object) and a third object (e.g., 804) (e.g., a rain drop, a lightning, a thunder, a person, an animal, and/or a movable object) (e.g., the third object is separate and/or distinct from the third object) are detected (e.g., concurrently detected or serially detected) (e.g., via one or more cameras and/or one or more sensors that are in communication with the computer system) in the path. In some embodiments, in response to detecting that the third set of one or more criteria is satisfied while moving the portion of the computer system, the computer system concurrently displays, via the display component: a second representation (e.g., a textual representation and/or a graphical representation) of the second object; and a third representation of the third object different from the second representation of the second object. In some embodiments, the second representation and the third representation are displayed while the first representation is displayed. In some embodiments, the second representation and/or the third representation cease to be displayed in response to the second object and/or the third object are removed from the path. In some embodiments, the second object and the third object are different types of objects. In some embodiments, the second object and the third object are the same types of objects. In some embodiments, the appearances of the second representation and/or the third representation are based on the appearance and/or location of the second and/or third object. Detecting that the third set of one or more criteria is satisfied while moving the portion of the computer system and concurrently displaying a second representation of a second object and a third representation of a third object enables the computer system to display a notification about obstacles along the path of the computer system, thereby providing improved visual feedback to the user and/or reducing the number of inputs needed to perform an operation.

In some embodiments, while displaying, via the display component, the first representation of the first object (e.g., 808 and/or 810) (e.g., and while the portion of the computer system is not moving), the computer system detects (e.g., via one or more cameras and/or one or more sensors that are in communication with the computer system) that a fourth set of one or more criteria is satisfied, wherein the fourth set of one or more criteria includes a criterion that is satisfied when the first object is not within the path (e.g., the first object is moved outside of the path and/or the computer system is moved such that the first object is not within the path) (and/or the third set of one or more criteria is not satisfied and/or the first set of one or more criteria is no longer satisfied). In some embodiments, in response to detecting that fourth set of one or more criteria is satisfied, the computer system ceases the display of the first representation of the first object (e.g., as described above in relation to FIGS. 8A-8C). In some embodiments, the first representation of the first object is redisplayed based on a determination that the first object is within the path. In some embodiments, the first representation of the first object abruptly ceases to be displayed or the first representation of the first object ceases to be displayed over a period of time (e.g., 1-360 seconds) (e.g., fades outs). Ceasing the display of the first representation of the first object in response to detecting that fourth set of one or more criteria is satisfied enables the computer system to display a notification updating the position of an object that is no longer interfering the path of the computer system, thereby providing improved visual feedback to the user and/or reducing the number of inputs needed to perform an operation.

In some embodiments, in response to detecting that the fourth set of one or more criteria is satisfied, the computer system moves (e.g., automatically (e.g., without intervening user input) or in response to an input) (e.g., resuming moving), via the movement component, the portion of the computer system along the path (e.g., as described above in relation to FIGS. 8A-8C). In some embodiments, the portion of the computer system ceases moving in response to detecting that the fourth set of one or more criteria is no longer satisfied. In some embodiments, the portion of the computer system resumes moving before, after, or while the first representation of the first object ceases to be displayed. Moving the portion of the computer system along the path in response to detecting that the fourth set of one or more criteria is satisfied and moving enables the computer system to continue to intelligently position itself after obstacles along the computer system's path have been removed thereby providing improved feedback to the user and/or reducing the number of inputs needed to perform an operation.

In some embodiments, while moving the portion of the computer system in response to detecting that the fourth set of one or more criteria is satisfied, the computer system detects (e.g., via one or more cameras that are in communication with the computer system and/or one or more sensors that are in communication with the computer system) that a fifth set of one or more criteria is satisfied (e.g., different from the fourth set of one or more criteria or the same as the fourth set of one or more criteria), wherein the fifth set of one or more criteria includes a criterion that is satisfied when a fourth object (e.g., a rain drop, a computer system, an inanimate object, a lightning, a thunder, a person, an animal, and/or a movable object) different from the first object (e.g., 804) is within the path (e.g., the entirety of the respective object is within the path or a portion of the respect object is within the path) (e.g., the respective object is between the portion of the computer system and the end of the path). In some embodiments, in response to detecting that the fifth set of one or more criteria is satisfied, the computer system ceases moving (e.g., stops, causes to stop, and/or halts), via the movement component, the portion of the computer system along the path (e.g., as described above in relation to FIGS. 8A-8C). In some embodiments, the portion of the computer system comes to an abrupt stop. In some embodiments, the portion of the computer system stops over a period of time (e.g., 1-30 seconds) (e.g., before reaching the object different from the first object). Ceasing moving the portion of the computer system along the path when a fourth object is determined to be within the path of the computer system enables the computer system to prevent collisions with other obstacles detected along the path of the computer system, thereby providing improved feedback to the user and/or reducing the number of inputs needed to perform an operation.

In some embodiments, while the movement of the portion of the computer system is resumed, the computer system detects (e.g., via one or more cameras and/or one or more sensors that are in communication (e.g., wired communication and/or wireless communication)) a fifth object (e.g., 804) (e.g., a rain drop, a computer system, an inanimate object, a lightning, a thunder, a person, an animal, and/or a movable object) in the direction of the path. In some embodiments, in response to detecting the fifth object in the direction of the path and in accordance with a determination that fifth object is outside of the path (e.g., a portion of the fifth object is outside of the path or the entirety of the fifth object is outside of the path) (e.g., to the right of the path, to the left of the path, below the path, above the path, positioned at a location that is before the beginning position of the path, and/or positioned at a location that is beyond the final position of the path), the computer system continues moving the portion of the computer system (e.g., as described above in relation to FIGS. 8A-8C). In some embodiments, in accordance with a determination that the fifth object is within the path, the movement of the portion of the computer system is ceased. In some embodiments, the movement of the portion of the computer system ceases in accordance with a determination that the fifth object is moved within the path. Continuing to move the portion of the computer system in accordance with a determination that fifth object is outside of the path enables the computer system to intelligently position itself even when conditions around the computer system change, thereby providing improved feedback to the user and/or reducing the number of inputs needed to perform an operation.

In some embodiments, the first representation of the first object (e.g., 808) is displayed after (e.g., within a threshold amount of time (e.g., 1-360 seconds) after) (e.g., immediately after) the movement of the portion of the computer system ceases (e.g., as described above in relation to FIGS. 8A-8C). Having the first representation of the first object be displayed after the movement of the portion of the computer system ceases enables the computer system to provide a notification that an obstruction along the computer system's path is present, thereby providing improved visual feedback to the user and/or reducing the number of inputs needed to perform an operation.

In some embodiments, the first representation of the first object (e.g., 808) is displayed before (e.g., within a threshold amount of time (e.g., 1-360 seconds) before) (e.g., immediately before) the movement of the portion of the computer system ceases (e.g., as described above in relation to FIGS. 8A-8C). Having the first representation of the first object be displayed before the movement of the portion of the computer system ceases enables the computer system to provide a notification that an obstruction along the computer system's path is present, thereby providing improved visual feedback to the user and/or reducing the number of inputs needed to perform an operation.

In some embodiments, the computer system is in communication (e.g., wireless communication and/or wired communication) with a first set of one or more one or more output devices (e.g., a display, a speaker, and/or a set of one or more lights). In some embodiments, in response to detecting the second set of one or more criteria is satisfied (e.g., and/or in response to detecting that the first set of one or more criteria is no longer satisfied), the computer system outputs, via the first set of one or more output devices, a first indication (e.g., a visual indication, an auditory indication and/or a haptic indication) that the portion of the computer system has stopped moving (e.g., as described above in relation to FIG. 8B) (e.g., while displaying the first representation of the first object). In some embodiments, the first indication that the portion of the computer system has stopped moving includes two different modalities (e.g., a visual modality, an audio modality, and/or a haptic modality) or a single modality. In some embodiments, the first indication ceases to be output in accordance with a determination that the computer system resumes moving. In some embodiments, the first indication that the portion of the computer system has stopped is output based on the speed of the portion of the computer system. In some embodiments, the computer system ceases to output the first indication in response to detecting an input (e.g., a voice command, a tap input, a swipe input, and/or a hand gesture). In some embodiments, in response to detecting the second set of one or more criteria is satisfied, the computer does not output the first indication that the portion of the computer system has stopped moving.

In some embodiments, the computer system is in communication (e.g., wireless communication and/or wired communication) with a second set of one or more one or more output devices (e.g., a display, a speaker, and/or a set of one or more lights). In some embodiments, in response to detecting the second set of one or more criteria is satisfied (e.g., and/or in response to detecting that the first set of one or more criteria is no longer satisfied), the computer system outputs, via the second set of one or more output devices, a second indication (e.g., a visual indication, an auditory indication and/or a haptic indication) that the first object (e.g., 804) is in the path (e.g., as described above in relation to FIGS. 8A-8C). In some embodiments, the second indication that the first object is in the path includes two different modalities (e.g., a visual modality, an audio modality, and/or a haptic modality) or a single modality. In some embodiments, the second indication ceases to be output in accordance with a determination that first object is not in the path. In some embodiments, the second indication has characteristics based on the characteristics of the first object. In some embodiments, in response to detecting the second set of one or more criteria is not satisfied, the computer system does not output the second indication that the first object is in the path.

In some embodiments, in response to detecting the second set of one or more criteria is satisfied, the computer system sends an external device (e.g., an external computer system and/or electronic device) an instruction to output a third indication that the first object (e.g., 804) is in the path (e.g., as described above in relation to FIGS. 8A-8C). In some embodiments, the external computer system outputs the third indication that the first object is in the path. In some embodiments, the external device is a fitness tracking device, watch, a phone, a tablet, a processor, a head-mounted display (HMD) device, a smart device (e.g., a smart lamp, alarm, clock, light, lock, and/or window covering), a display, and/or a personal computing device. Sending an external device an instruction to output a third indication that the first object is in the path enables the computer system to notify another device of obstacles along the path of the computer system, thereby providing improved feedback to the user and/or reducing the number of inputs needed to perform an operation.

In some embodiments, while the second indication that the first object is in the path is output, the computer system detects (e.g., via a set of one or more cameras that are in communication with the computer system and/or a set of one or more sensors that are in communication with the computer system) that the first object (e.g., 804) is no longer in (e.g., has been removed from and/or has moved from) the path (e.g., the computer system removes the first object from the path and/or a user removes the first object from the path). In some embodiments, in response to detecting that the first object is removed from the path, the computer system ceases to output the second indication that the first object is in the path (e.g., as described above in relation to FIGS. 8A-8C). In some embodiments, the second indication resumes being output in accordance with a determination that the first object is back in the path. Ceasing to output the second indication that the first object is in the path in response to detecting that the first object is removed from the path enables the computer system to notify another device of obstacles no longer being along the path of the computer system, thereby providing improved feedback to the user and/or reducing the number of inputs needed to perform an operation.

In some embodiments, after (immediately after and/or within a predetermined amount of time (e.g., 1-360 seconds after)) the second indication that the first object is in the path is output (via the computer system and/or an external device), the computer system detects (e.g., via a set of one or more cameras and/or a set of one or more sensors that are in communication with the computer system) that the first object (e.g., 804) is removed from the path. In some embodiments, in response to detecting that the first object is removed from the path, the computer system outputs, via the second set of one or more output devices, an indication that a sixth object is in the path (e.g., after detecting that the sixth object is in the path) (e.g., as described above in relation to FIGS. 8A-8C). In some embodiments, the computer system cannot detect the fifth object while the first object is in the path. In some embodiments, the first object and the fifth object are the same types of objects or are different types of objects. In some embodiments, the third indication is output with characteristics (e.g., volume, brightness, intensity, color, and/or shape) based on characteristics of the fifth object (e.g., size, shape, and/or distance from computer system of the fifth object).

Note that details of the processes described above with respect to process 900 (e.g., FIG. 9) are also applicable in an analogous manner to the methods described below/above. For example, process 700 optionally includes one or more of the characteristics of the various methods described above with reference to process 900. For example, a computer system can use one or more techniques of process 900 to detect a user is not within a predefined distance from the computer system and move the portion of the computer system using one or more techniques of process 700. For brevity, these details are not repeated below.

FIGS. 10A-10G illustrate exemplary user interfaces for acknowledging a user in accordance with some embodiments. The user interfaces in these figures are used to illustrate the processes described below, including the processes in FIGS. 11-13.

The left side of FIGS. 10A-10G illustrates computer system 1000 displaying different user interfaces as a tablet. It should be recognized that computer system 1000 can be other types of computer systems such as a smart phone, a smart watch, a laptop, a communal device, a smart speaker, a smart display, an accessory, a personal gaming system, a desktop computer, a fitness tracking device, and/or a head-mounted display (HMD) device. In some embodiments, computer system 1000 includes and/or is in communication with one or more sensors (e.g., a camera, a lidar detector, a motion sensor, an infrared sensor, and/or a microphone). In some embodiments, computer system 1000 includes and/or is in communication with one or more output devices (e.g., a display screen, a projector, a touch-sensitive display, and/a speaker). In some embodiments, computer system 1000 includes and/or is in communication with one or more movement components (e.g., an actuator, a moveable base, a rotatable component, and/or a rotatable base). In some embodiments, computer system 1000 includes one or more components and/or features described above in relation to computer system 100 and/or electronic device 200.

The right side of FIGS. 10A-10G include diagram 1006. Diagram 1006 is a visual aid representing a physical space and/or environment that includes computer system 1000, the first user, the second user, and the third user. Diagram 1006 includes computer system representation 1008 for computer system 1000, first user representation 1010 for the first user, second user representation 1012 for the second user, and third user representation 1014 for the third user. The positioning of computer system representation 1008, first user representation 1010, second user representation 1012, and third user representation 1014 within diagram 1006 is representative of the real-world positioning of computer system 1000 with respect to the first user, the second user, and the third user. Diagram 1006 includes dotted lines which represent a field of detection and/or a field of view (sometimes collectively referred to as the field of detection) of computer system representation 1008. The field of detection of computer system representation 1008 corresponds to the field of detection for one or more front facing sensors of computer system 1000 in the real-world. In some embodiments, one or more other sensors of computer system 1000 include a different field of detection than the field of detection (e.g., overlapping but smaller or bigger and/or not overlapping). In this example, there are three users. In some embodiments, there are more or less than three users.

FIGS. 10A-10G illustrate a process where computer system 1000 performs one or more operations to acknowledge each user in a physical space and/or environment by facing each user in turn and appearing to bow to them. It should be recognized that bowing is just one example of an acknowledgement and that other acknowledgements are within the scope of this disclosure. In some embodiments, if a user that computer system 1000 is facing is recognized by computer system 1000 (e.g., registered with computer system 1000), computer system 1000 displays an indication that the user is recognized and/or displays content (e.g., data and/or controls that, in some embodiments, are predefined and/or preconfigured by the user) of the user. In some embodiments, if the user that computer system 1000 is facing is not recognized by computer system 1000 (e.g., not registered with computer system 1000), computer system 1000 will not display content corresponding to the user, ask the user to identify themselves, and/or add the newly identified user to the list of known users for future use.

As illustrated in FIG. 10A, computer system 1000 displays user interface 1002 including time indication 1004, which displays the current real-world time, at a central location of user interface 1002. In this example, user interface 1002 is a home screen user interface which can include one or more indications and/or controls. In some embodiments, user interface 1002 is a smart home system user interface that displays indications and/or controls for a building's systems (e.g., lighting, shades, locks, sound, and/or environmental controls). For example, user interface 1002 can be displaying the lock status of all the doors of the building as well as the average room temperature. In some embodiments, user interface 1002 is an office check-in system user interface, which will be described in more detail below. In some embodiments, user interface 1002 includes an avatar (e.g., an anthropomorphic visual representation) for a virtual assistant or other artificial intelligence application. In some embodiments, user interface 1002 does not include time indication 1004. It should be recognized that such content of user interface 1002 as described herein is used for discussion purposes and that other and/or different content can be included in user interface 1002.

At FIG. 10A, computer system 1000 is in standby mode. In some embodiments, computer system 1000 is in standby mode when in a power saving state and/or waiting to detect an event (e.g., detect a user, detect input from a user, and/or output an indication). In some embodiments, computer system 1000 goes into standby mode when computer system 1000 has not detected input by a user and/or has not output content as a result of an event for a predetermined amount of time. As illustrated in FIG. 10A, because computer system 1000 is in standby mode, computer system 1000 displays user interface 1002 with decreased emphasis (e.g., greyed out, dimmed display, muted colors, and/or transparent overlay). In some embodiments, because computer system 1000 is in standby mode, computer system 1000 ceases displaying user interface 1002.

As illustrated in diagram 1006 of FIG. 10A, no users are within the field of detection of computer system 1000 (e.g., as indicated in diagram 1006 by no user representation (e.g., first user representation 1010, second user representation 1012, and/or third user representation 1014) being located within the field of detection of computer system representation 1008). At FIG. 10A, computer system 1000 detects one or more users within the environment. In some embodiments, a user is a living thing (e.g., a person, a user, and/or an animal). In some embodiments, a user is an electronic device (e.g., smart phone, a smart watch, a laptop, a communal device, a smart speaker, an accessory, a personal gaming system, a desktop computer, a fitness tracking device, a head-mounted display (HMD) device, a drone, and/or a robot).

At FIG. 10B, in response to detecting one or more users, computer system 1000 switches out of standby mode. As illustrated in FIG. 10B, because computer system 1000 is no longer in standby mode, computer system 1000 displays user interface 1002 with increased emphasis (e.g., brightened display, brighter colors, and/or without transparent overlay). At FIG. 10B, in response to detecting one or more users, computer system 1000 rotates a portion of computer system 1000 via one or more movement components around a single axis until one or more of the users are within the field of detection. It should be recognized that, in some embodiments, computer system 1000 can rotate the portion around more than one axis. As illustrated in diagram 1006, first user representation 1010 is within the field of detection of computer system representation 1008, indicating that computer system 1000 has rotated and the first user (e.g., Jake Allen) is within the field of detection of computer system 1000. In some embodiments, computer system 1000 determines which user to rotate towards based on which user is nearest to computer system 1000. In some embodiments, computer system 1000 determines which user to rotate towards based on user status (e.g., user is a primary user (e.g., the user with the most permissions), user is known to computer system 1000, or user is unknown to computer system 1000). In some embodiments, computer system 1000 rotates clockwise/counterclockwise and faces each user in turn. In some embodiments, computer system 1000 uses a combination of factors listed above and/or other factors to determine which user to rotate towards.

At FIG. 10B, computer system 1000 detects the first user within the field of detection of computer system 1000. At FIG. 10B, in response to detecting the first user within the field of detection, computer system 1000 stops rotating. In this example, the first user (e.g., Jake Allen) is known to computer system 1000. In some embodiments, a user that is known to computer system 1000 is registered with computer system 1000 (e.g., user has an account, user's biometrics are catalogued, and/or user has a log in). At FIG. 10B, computer system 1000 recognizes the first user. In some embodiments, in response to and/or after detecting the first user within the field of detection, computer system 1000 continues to rotate a portion of computer system 1000 until the first user is at a particular position (e.g., centered and/or framed in a certain way) in the field of detection. At FIG. 10B, in response to detecting the first user within the field of detection, computer system 1000 performs a first set of movements by moving a portion of computer system 1000 via one or more movement components around one or more axes. In this example, the first set of movements includes computer system 1000 moving a portion of computer system 1000 down a predetermined distance and then moving the same portion of computer system 1000 up the same predetermined distance to the position the portion of computer system 1000 was in before moving down, giving the impression that computer system 1000 is bowing. In this example, computer system 1000 completes the first set of movements with the first user within the field of detection. In some embodiments, in response to detecting the first user within the field of detection, computer system 1000 performs a different first set of movements (e.g., dance, nod, and/or shake) by moving a portion of computer system 1000 via one or more movement components around one or more axes. In some embodiments, computer system 1000 performs the first set of movements in conjunction with a height adjustment via one or more movement components to be at an accessible level to the first user. For example, if the first user is taller than a starting and/or current position of computer system 1000, computer system 1000 can perform the first set of movements followed by elevating a portion of computer system 1000 to place user interface 1002 at eye level and/or at hand level with the first user. In some embodiments, in response to recognizing the first user and detecting the first user within the field of detection, computer system 1000 performs a predetermined first set of movements that correspond to the first user. For example, in response to recognizing the first user and detecting the first user within the field of detection, computer system 1000 can tilt down then tilt up a portion of computer system 1000 in a movement resembling a nod. In some embodiments, computer system 1000 performs the first set of movements before stopping rotation. In some embodiments, computer system 1000 performs the first set of movements after stopping rotation.

In some embodiments, in response to detecting the first user within the field of detection, computer system 1000 outputs a first audio indication (e.g., a chirp, a ring, a greeting, and/or music). In some embodiments, in response to recognizing the first user and detecting the first user within the field of detection, computer system 1000 outputs a second audio indication (e.g., a chirp, a ring, a greeting, the user's name, and/or music) that corresponds to the first user. For example, in response to recognizing the first user and detecting the first user within the field of detection, computer system 1000 can output the audio “Good afternoon, Jake.” In some embodiments, computer system 1000 does not output an audio indication in response to detecting the first user within the field of detection. In some embodiments, computer system 1000 outputs the first audio indication and/or the second audio indication before stopping rotation. In some embodiments, computer system 1000 outputs the first audio indication and/or the second audio indication after stopping rotation. In some embodiments, computer system 1000 outputs the first audio indication and/or the second audio indication before performing the first set of movements. In some embodiments, computer system 1000 outputs the first audio indication and/or the second audio indication while performing the first set of movements. In some embodiments, computer system 1000 outputs the first audio indication and/or the second audio indication after performing the first set of movements.

As illustrated in FIG. 10B, in response to recognizing the first user and detecting the first user within the field of detection, computer system 1000 displays first user indication 1016 corresponding to the first user at the top center of user interface 1002 (e.g., a default and/or predefined location for indications of users within the field of detection). In this example, first user indication 1016 includes the initials of the first user (e.g., J.A. for Jake Allen). In some embodiments, first user indication 1016 includes an avatar of the first user (e.g., an image chosen by the first user). In some embodiments, first user indication 1016 includes an image of the first user captured by computer system 1000 via one or more cameras connected to and/or in communication with computer system 1000. It should be recognized that first user indication 1016 can include more and/or different content than described herein. In some embodiments, computer system 1000 displays first user indication 1016 at a different location (e.g., not the top center) within user interface 1002 (e.g., at a location within user interface 1002 closest to the first user). In some embodiments, computer system 1000 displays first user indication 1016 after stopping rotation. In some embodiments, computer system 1000 displays first user indication 1016 before stopping rotation.

As illustrated in FIG. 10B, in response to recognizing the first user and detecting the first user within the field of detection, computer system 1000 displays first application control 1018a, which corresponds to the first user, at the lower left location within user interface 1002 (e.g., a default location for controls corresponding to users within the field of detection). In this example, first application control 1018a is a control for a fitness tracker application, displaying the first user's fitness goals and accomplishments for the day. In some embodiments, first application control 1018a is a control for some other type of application. For example, first application control 1018a can be a calendar application control displaying the first user's appointments for the day. In some embodiments, in response to recognizing the first user and detecting the first user within the field of detection, computer system 1000 does not display first application control 1018a. In some embodiments, in response to recognizing the first user, computer system 1000 displays one or more other controls and/or indications that correspond to the first user. In some embodiments, computer system 1000 displays first application control 1018a at different locations (e.g., not the lower left) within user interface 1002. In some embodiments, in response to recognizing the first user, computer system 1000 ceases displaying time indication 1004. At a time before, while, and/or after displaying first user indication 1016, computer system 1000 detects the second user.

At FIG. 10C, in response to detecting the second user (and/or after displaying first user indication 1016), computer system 1000 rotates a portion of computer system 1000 via one or more movement components until the second user is within the field of detection. As illustrated in diagram 1006, second user representation 1012 is within the field of detection of computer system representation 1008, indicating that computer system 1000 has rotated and the second user (e.g., Julie Smith) is within the field of detection of computer system 1000. As illustrated in FIG. 10C, in response to no longer detecting the first user within the field of detection, computer system 1000 ceases displaying first user indication 1016.

At FIG. 10C, computer system 1000 detects the second user within the field of detection of computer system 1000. At FIG. 10C, in response to detecting the second user within the field of detection, computer system 1000 stops rotating. In this example, the second user (e.g., Julie Smith) is known to computer system 1000 (and/or registered with computer system 1000). At FIG. 10C, computer system 1000 recognizes the second user. In some embodiments, in response to detecting the second user within the field of detection, computer system 1000 continues to rotate a portion of computer system 1000 until the second user is at a particular position (e.g., centered and/or framed in a certain way) in the field of detection. At FIG. 10C, in response to detecting the second user within the field of detection, computer system 1000 performs the second set of movements by moving a portion of computer system 1000 via one or more movement components around one or more axes. In some embodiments, the second set of movements is the same as the first set of movements. In some embodiments, the second set of movements is different from the first set of movements. In some embodiments, in response to recognizing the second user and detecting the second user within the field of detection, computer system 1000 performs a predetermined second set of movements that corresponds to the second user. For example, computer system 1000 can move a portion of computer system 1000 side to side, as preset by the second user. In some embodiments, computer system 1000 performs the second set of movements before stopping rotation. In some embodiments, computer system 1000 performs the second set of movements after stopping rotation.

At FIG. 10C, in response to detecting the second user within the field of detection, computer system 1000 outputs a third audio indication (e.g., a chirp, a ring, a greeting, and/or music). In some embodiments, the third audio indication is the same as the first audio indication. In some embodiments, the third audio indication is different from the third audio indication. In some embodiments, in response to recognizing the second user and detecting the second user within the field of detection, computer system 1000 outputs a fourth audio indication (e.g., a chirp, a ring, a greeting, the user's name, and/or music) that corresponds to the second user. For example, in response to recognizing the second user and detecting the second user within the field of detection, computer system 1000 can output a portion of the theme song from the second user's favorite TV show. In some embodiments, computer system 1000 does not output an audio indication in response to detecting the second user within the field of detection. In some embodiments, computer system 1000 outputs the third audio indication and/or the fourth audio indication before stopping rotation. In some embodiments, computer system 1000 outputs the third audio indication and/or the fourth audio indication after stopping rotation. In some embodiments, computer system 1000 outputs the third audio indication and/or the fourth audio indication before performing the second set of movements. In some embodiments, computer system 1000 outputs the third audio indication and/or the fourth audio indication while performing the second set of movements. In some embodiments, computer system 1000 outputs the third audio indication and/or the fourth audio indication after performing the second set of movements.

As illustrated in FIG. 10C, in response to recognizing the second user and detecting the second user within the field of detection, computer system 1000 displays second user indication 1020 corresponding to the second user at the top center of user interface 1002. In this example, second user indication 1020 includes the initials of the first user (e.g., J.S. for Julie Smith). In some embodiments, second user indication 1020 includes an avatar of the second user (e.g., an image chosen by the second user). In some embodiments, second user indication 1020 includes an image of the second user captured by computer system 1000 via one or more cameras connected to and/or in communication with computer system 1000. In some embodiments, computer system 1000 displays second user indication 1020 at a different location (e.g., not the top center) within user interface 1002. In some embodiments, computer system 1000 displays second user indication 1020 after stopping rotation. In some embodiments, computer system 1000 displays second user indication 1020 before stopping rotation.

In some embodiments, computer system 1000 detects more than one user within the field of detection. In some embodiments, in response to computer system 1000 detecting more than one user within the field of detection, computer system 1000 displays the user indications corresponding to each user in a row at the top center of user interface 1002. In some embodiments, in response to detecting more than one user within the field of detection, computer system 1000 displays the user indications corresponding to each of the users at locations at the top of user interface 1002 that correspond to each of the user's relative locations within the field of detection. For example, if the first user is within the field of detection towards the right side of user interface 1002 and the second user is within the field of detection towards the left side of user interface 1002, computer system 1000 can display the user indication corresponding to the first user at a location within the top right of user interface 1002 and display the user indication corresponding to the second user at a location within the top left of user interface 1002. In some embodiments, in response to computer system 1000 detecting more than one user within the field of detection, computer system 1000 displays the user indications corresponding to each of the users at locations along the sides of user interface 1002 that correspond to each of the user's relative locations within the field of detection. In some embodiments, the user indications are the same for multiple users. For example, the users can have the same initials and/or both users can be unknown with a user indication indicating such (e.g., a question mark, as described below with respect to unknown user indication 1022). In some embodiments, the user indications are different for each user. In some embodiments, computer system 1000 temporarily detects both the first user and the second user within the field of detection while computer system 1000 is rotating between the first user and the second user, causing computer system 1000 to display both first user indication 1016 and second user indication 1020 for the period of time that both users are within the field of detection.

As illustrated in FIG. 10C, in response to recognizing the second user and detecting the second user within the field of detection, computer system 1000 ceases displaying first application control 1018a and displays second application control 1018b, which corresponds to the second user, at the bottom left location within user interface 1002. In some embodiments, computer system 1000 ceases displaying first application control 1018a in response to not detecting the first user within the field of detection. In this example, second application control 1018b is a control for a fitness tracker application, displaying the second user's fitness goals and accomplishments for the day. In some embodiments, second application control 1018b is a control for some other type of application. For example, second application control 1018b can be a news application displaying the headlines from the second user's selected news sources. In some embodiments, in response to recognizing the second user and detecting the second user within the field of detection, computer system 1000 does not display second application control 1018b. In some embodiments, in response to recognizing the second user and detecting the second user within the field of detection, computer system 1000 displays one or more other application controls that correspond to the second user. In some embodiments, in response to detecting more than one user within the field of detection, computer system 1000 does not display any application controls that correspond to a single user, to preserve privacy of the single user. At a time before, while, and/or after displaying second user indication 1020, computer system 1000 detects the third user.

At FIG. 10D, in response to and/or after detecting the third user (e.g., after displaying second user indication 1020), computer system 1000 rotates a portion of computer system 1000 via one or more movement components until the third user is within the field of detection. As illustrated in diagram 1006, third user representation 1014 is within the field of detection of computer system representation 1008, indicating that computer system 1000 has rotated and the third user is within the field of detection of computer system 1000. At FIG. 10D, computer system 1000 detects the third user within the field of detection of computer system 1000. At FIG. 10D, in response to detecting the third user within the field of detection, computer system 1000 stops rotating. In some embodiments, in response to detecting the third user within the field of detection, computer system 1000 continues to rotate until the third user is at a particular position (e.g., centered and/or framed in a certain way) in the field of detection. As illustrated in FIG. 10D, in response to not detecting the second user within the field of detection, computer system 1000 ceases displaying second user indication 1020.

In this example, the third user is not known to computer system 1000. In some embodiments, a user that is not known to computer system 1000 is not registered with computer system 1000 (e.g., user does not have an account, user's biometrics are not catalogued, and/or user does not have a log in). At FIG. 10D, computer system 1000 determines that the third user is not known and/or does not recognize the third user. At FIG. 10D, in response to detecting the third user within the field of detection, computer system 1000 performs a third set of movements by moving a portion of computer system 1000 via one or more movement components around one or more axes. In some embodiments, the third set of movements is the same as the first and/or second set of movements. In some embodiments, the third set of movements is different from the first and/or second set of movements. In some embodiments, in response to the third user being unknown to computer system 1000, computer system 1000 does not perform a movement (e.g., the third set of movements). In some embodiments, in response to the third user being unknown to computer system 1000, the third set of movements are a set of movements that correspond to the user being unknown. For example, in response to the third user being unknown to computer system 1000, computer system 1000 can tilt a portion of computer system 1000 to appear inquisitive.

At FIG. 10D, in response to detecting the third user within the field of detection, computer system 1000 outputs a fifth audio indication (e.g., a chirp, a ring, a greeting, and/or music). In some embodiments, the fifth audio indication is the same as the first and/or third audio indication. In some embodiments, the fifth audio indication is different from the first and/or third audio indication. In some embodiments, in response to the third user being unknown to computer system 1000, computer system 1000 does not output the fifth audio indication. In some embodiments, in response to the third user being unknown to computer system 1000, computer system 1000 outputs a sixth audio indication (e.g., a chirp, a ring, a greeting, and/or music) (e.g., the same as or different from the first, second, third, fourth, and/or fifth audio indication. In some embodiments, the sixth audio indication is an audio indication that corresponds to the user being unknown. For example, in response to the third user being unknown to computer system 1000, computer system 1000 can output a simple chime, to indicate that computer system 1000 acknowledges that an unknown user is present.

As illustrated in FIG. 10D, in response to detecting the third user within the field of detection, computer system 1000 ceases displaying second application control 1018b. In some embodiments, computer system 1000 ceases displaying second application control 1018b in response to not detecting the second user within the field of detection. As illustrated in FIG. 10D, in response to computer system 1000 detecting the third user and the third user being unknown, computer system 1000 displays unknown user indication 1022 at the top of user interface 1002. In this example, unknown user indication 1022 includes two question marks (e.g., ??). In some embodiments, in response to computer system 1000 detecting the third user within the field of detection and the third user being unknown, computer system 1000 displays unknown user indication 1022 with one or more different symbols and/or content. As illustrated in FIG. 10D, in response to computer system 1000 detecting the third user within the field of detection and the third user being unknown, computer system 1000 displays time indication 1004 and unknown user indication 1022 within user interface 1002. In some embodiments, in response to computer system 1000 detecting the third user within the field of detection and the third user being unknown, computer system 1000 ceases displaying time indication 1004. In some embodiments, in response to computer system 1000 detecting the third user within the field of detection and the third user being unknown, computer system 1000 displays one or more other controls and/or indicators within user interface 1002.

As illustrated in FIG. 10E, at a time after displaying unknown user indication 1022, computer system 1000 ceases displaying user interface 1002 and displays greeting screen 1024, which includes first text 1026. Also illustrated in FIG. 10E, computer system 1000 continues to display unknown user indication 1022 concurrently with greeting screen 1024. In this example, first text 1026 includes a greeting (e.g., “Hello”) and a request for the third users name (e.g., “what is your name?”). In some embodiments, first text 1026 includes some other greeting and/or request for the third user's name. For example, first text 1026 can include “Greetings, I am Computer System 1000” (e.g., the assigned name of computer system 1000), as well as “Who are you?”. In some embodiments, while displaying first text 1026, computer system 1000 outputs the audio that corresponds to computer system 1000 reading first text 1026 (e.g., “Hello, what is your name?”). In some embodiments, while displaying first text 1026, computer system 1000 captures an image of the third user using one or more cameras connected to and/or in communication with computer system 1000 and/or displays the captured image at the top of greeting screen 1024 instead of unknown user indication 1022. At a time after displaying first text 1026, computer system 1000 detects first audio input 1028 from the third user that corresponds to the third user responding to first text 1026 with the name of the third user (e.g., “Anna Smith”).

In some embodiments, at a time after displaying unknown user indication 1022, before displaying greeting screen 1024, computer system 1000 detects audio input from the third user corresponding to the third user introducing themselves to computer system 1000. In some embodiments, the audio input corresponding to the third user introducing themselves to computer system 1000 does not include an explicit indication to add the third user as a new user (e.g., a known user). For example, the third user can say, “Hello, my name is Anna Smith.” In some embodiments, the audio input corresponding to the third user introducing themselves to computer system 1000 does include an explicit indication to add the third user as a new user.

In some embodiments, at a time after displaying unknown user indication 1022, computer system 1000 rotates a portion of computer system 1000 until a known user (e.g., the first user, the second user, and/or a primary user of computer system 1000) is within the field of detection and does not display greeting screen 1024. For example, after displaying unknown user indication 1022, computer system 1000 can rotate a portion of computer system 1000 until the first user is again within the field of detection. In some embodiments, at a time after displaying unknown user indication 1022, computer system 1000 detects audio input from a known user (e.g., the first user, the second user, and/or a primary user of computer system 1000) that corresponds to the known user introducing the third user to computer system 1000. In some embodiments, the audio input corresponding to a known user introducing the third user to computer system 1000 does not include an explicit indication to register the third user as a user (e.g., a known user). For example, the first user can say, “This is Anna Smith.” In some embodiments, the audio input corresponding to a known user introducing the third user to computer system 1000 does include an explicit indication to register the third user as a user (e.g., a known user). For example, the second user can say, “Computer, please add Anna Smith as a user.” In some embodiments, computer system 1000 detects audio input from a known user that corresponds to the known user introducing the third user to computer system 1000 after detecting the third user and before displaying unknown user indication 1022. For example, the second user can say, “This is Anna Smith,” while the second user is within the field of detection, before computer system 1000 has begun rotating towards the third user.

In some embodiments, if computer system 1000 detects the third user within the field of detection, in response to detecting an audio input corresponding to the third user introducing themselves to computer system 1000 and/or an audio input corresponding to a known user introducing the third user to computer system 1000, computer system 1000 will respond as described below in FIG. 10F. In some embodiments, if computer system 1000 does not detect the third user within the field of detection, in response to detecting an audio input corresponding to the third user introducing themselves to computer system 1000 and/or an audio input corresponding a known user introducing the third user to computer system 1000, computer system 1000 rotates a portion of computer system 1000 until the third user is detected within the field of detection before continuing as described below in FIG. 10F. For example, if computer system 1000 is facing the first user when the first user introduces the third user to computer system 1000, computer system 1000 can rotate a portion of computer system 1000 until the third user is within the field of detection before continuing as described below in FIG. 10F.

In some embodiments, before computer system 1000 detects the third user, computer system 1000 detects an audio input from a known user that corresponds to the known user introducing the third user to computer system 1000. In some embodiments, before computer system 1000 detects the third user, after computer system 1000 detects an audio input from a known user corresponding to the known user introducing the third user to computer system 1000, computer system 1000 detects an air gesture from the same known user in a direction towards the third user, so as to indicate where computer system 1000 should look for the third user. For example, while the first user is in the field of detection, before computer system 1000 has detected the third user, the first user can say “Computer, let me introduce you to Anna Smith,” then gesture in the direction of the third user. In some embodiments, in response to detecting an audio input from a known user corresponding to the known user introducing the third user to computer system 1000 followed by detecting an air gesture from the same known user in the direction of the third user, computer system 1000 rotates a portion of computer system 1000 in the direction indicated by the air gesture until computer system 1000 detects the third user within the field of detection then continues as described below in FIG. 10F. In some embodiments, before computer system 1000 detects the third user, after computer system 1000 detects an audio input from a known user, corresponding to the known user introducing the third user to computer system 1000, computer system 1000 does not detect an input indicating where computer system 1000 should look for the third user. In some embodiments, in response to detecting an audio input from a known user corresponding to the known user introducing the third user to computer system 1000 and computer system 1000 has not yet detected the third user, computer system 1000 rotates a portion of computer system 1000 until an unknown user is within the field of detection, then computer system 1000 will continue as described below in FIG. 10F.

As illustrated in FIG. 10F, in response to detecting first audio input 1028, computer system 1000 ceases displaying first text 1026 and displays second text 1032 which includes a request to confirm the name of the third user (e.g., “Anna Smith, is that correct?”). In some embodiments, in response to detecting first audio input 1028, computer system 1000 outputs audio that corresponds to computer system 1000 reading second text 1032. At FIG. 10F, in response to first audio input 1028, computer system 1000 captures the biometric data (e.g., pictures, sounds (e.g., voice), and/or sensor data (e.g., infrared, and/or heat signature)) of the third user via one or more sensors. In some embodiments, the biometric data is used to identify the third user (e.g., detect that the third user is who they are). In some embodiments, content corresponding to first text 1026 is not output and instead user interface 1002 in FIG. 10G is displayed after user interface 1024 in FIG. 10E without displaying user interface 1024 in FIG. 10F. As illustrated in FIG. 10F, in response to detecting first audio input 1028, computer system 1000 ceases displaying unknown user indication 1022 and displays third user indication 1030. In this example, third user indication 1030 includes the initials for the third user (e.g., A.S. for Anna Smith). In some embodiments, third user indication 1030 includes an image of the third user captured by one or more cameras connected to and/or in communication with computer system 1000. At FIG. 10F, computer system 1000 detects second audio input 1034 from the third user corresponding to a positive response (e.g., Yes) to the question in second text 1032. In some embodiments, unknown user indication 1022 is not updated to be third user indication 1030 until after the position response.

At FIG. 10G, in response to detecting second audio input 1034 corresponding to a positive response, computer system 1000 registers the third user (e.g., Anna Smith) as a known user. As illustrated in FIG. 10G, in response to detecting second audio input 1034, computer system 1000 ceases displaying greeting screen 1024 and displays user interface 1002 including time indication 1004. In some embodiments, a determination is made that the third user is not registered with another computer system (e.g., a personal device of Anna Smith that is in communication with computer system 1000), causing computer system 1000 to continue to display third user indication 1030. In some embodiments, a determination is made that the third user is registered with another computer system (e.g., a personal device of Anna Smith that is in communication with computer system 1000), causing computer system 1000 to display a fourth user indication that corresponds to the user indication used by the third user on the other computer system. In some embodiments, computer system 1000 detects second audio input 1032 from the third user corresponding to a negative response (e.g., “No”) to the question in second text 1032. In some embodiments, in response to detecting an audio input from the third user corresponding to a negative response, computer system 1000 repeats a same and/or similar process to the processes described above starting at FIG. 10E.

The example illustrated in FIGS. 10A-10F above is a generalized example with user interface 1002 being a home screen user interface. In some embodiments, user interface 1002 is an office check-in system user interface. For example, computer system 1000 can rotate to face patients at a doctor's office or professionals at a conference. Each person that is known to computer system 1000 (e.g., an existing patient and/or a registered conference attendant) can be individually and automatically greeted and checked in by computer system 1000. Each person that is unknown to computer system 1000 can be asked to identify themselves by computer system 1000. After receiving the person's identification, computer system 1000 can check the information against a connected database. If computer system 1000 finds the person in the database, computer system 1000 can help the person complete the system registration making the person known to computer system 1000.

FIG. 11 is a flow diagram illustrating a method for moving a portion of a computer system in accordance with some embodiments. Process 1100 is performed at a computer system (e.g., 100, 200, and/or 1000). Some operations in process 1100 are, optionally, combined, the orders of some operations are, optionally, changed, and some operations are, optionally, omitted.

As described below, process 1100 provides an intuitive way for moving a portion of a computer system. The method reduces the cognitive burden on a user for moving a portion of a computer system, thereby creating a more efficient human-machine interface. For battery operated computing devices, enabling a user to move a portion of a computer system faster and more efficiently conserves power and increases the time between battery charges.

In some embodiments, process 1100 is performed at a computer system (e.g., 1000) that is in communication with a movement component (e.g., an actuator, a movable base, a rotatable component, and/or a rotatable base), one or more input devices (e.g., a camera, a depth sensor, and/or a microphone), and a display component (e.g., a display screen and/or a touch-sensitive display). In some embodiments, the computer system is a fitness tracking device, watch, a phone, a tablet, a processor, a head-mounted display (HMD) device, and/or a personal computing device.

The computer system detects (1102), via the one or more input devices, a first user (e.g., 1010, 1012, and/or 1014) (e.g., person, animal, user, and/or object) in an environment (e.g., 1006) (e.g., a physical environment).

In response to (1104) detecting the first user (e.g., 1010, 1012, and/or 1014) in the environment (e.g., 1006), the computer system moves (1106) (e.g., causes to physically move, rotates, pushes, and/or pulls), via the movement component, a portion (e.g., a housing and/or an enclosure including a display component and/or the one or more input devices) (e.g., a front portion) of the computer system (e.g., 1000) to be directed to the first user (e.g., 1010, 1012, and/or 1014) (e.g., as described above at FIGS. 10A-10D) (e.g., at least partially face the object and/or at least partially face a portion of the object) (e.g., from a first orientation to a second orientation different from the first orientation).

In response to (1104) detecting the first user in the environment, the computer system displays (1108) a first predefined indication (e.g., 1016, 1020, 1022, and/or 1030) (e.g., a predefined identification and/or a predefined representation) for (e.g., of, associated with, and/or corresponding to) the first user (e.g., 1010, 1012, and/or 1014). In some embodiments, the first predefined indication is configured and/or set for the object before detecting the object. In some embodiments, the first predefined indication is not an image and/or a video of the object. In some embodiments, the first predefined indication includes one or more characters. In some embodiments, the first predefined indication is displayed in a predefined location. In some embodiments, the first predefined indication is displayed in a location relative to a location of the object. Moving the portion of the computer system to be directed to the first user and displaying the first predefined indication for the first user in response to detecting the first user in the environment allows the computer system to indicate to users in an environment what the computer system detects, thereby providing improved visual feedback to the user and/or performing an operation when a set of conditions has been met without requiring further user input.

In some embodiments, the first predefined indication (e.g., 1016, 1020, 1022, and/or 1030) is displayed after (e.g., 0-360 seconds after) moving, via the movement component, the portion of the computer system (e.g., 1000) to the first user (e.g., 1010, 1012, and/or 1014) (e.g., (1) after the portion of the computer system is directed to the first user, (2) in response to detecting the first user in the environment and in accordance with a determination that the portion of the computer system is directed to the first user, and/or (3) after ceasing moving the portion of the computer system). In some embodiments, the first predefined indication is displayed before (e.g., 0.1-360 seconds before) the computer system moves, via the movement component, the portion of the computer system to be directed to the first user. In some embodiments, after displaying the first predefined indication and in accordance with a determination that the computer system is not directed to the first user (e.g., after moving the portion of the computer system to be directed to the first user), the computer system ceases displaying the first predefined indication. In some embodiments, after the computer system moves, via the movement component, the portion of the computer system to be directed to the first user and in accordance with a determination that the computer system is not directed to the first user, the computer system maintains display of the first predefined indication. Displaying the first predefined indication after moving the portion of the computer system to the first user allows the computer system to display content when it is able to be viewed and not, in some embodiments, when it is harder to view due to movement, thereby providing improved visual feedback to the user and/or performing an operation when a set of conditions has been met without requiring further user input.

In some embodiments, the first predefined indication (e.g., 1016, 1020, and/or 1030) is displayed while moving, via the movement component, the portion of the computer system (e.g., 1000) to be directed to the first user (e.g., 1010, 1012, and/or 1014) (e.g., and in accordance with a determination that the first user is within a field of view and/or detection of an input device of the one or more input devices). In some embodiments, the first predefined indication is displayed based on a speed of the movement of the portion of the computer system. In some embodiments, the first predefined indication is displayed during a first portion of moving, via the movement component, the portion of the computer system to be directed to the first user in accordance with a determination that the moving is at a first speed. In some embodiments, the first predefined indication is displayed during a second portion, different from the first portion, of moving (e.g., without being displayed during the first portion of moving), via the movement component, the portion of the computer system to be directed to the first user in accordance with a determination that the moving is at a second speed different from the first speed. Displaying the first predefined indication while moving the portion of the computer system to the first user allows the computer system to display an indication of what is in a field of view and/or detection of the computer system when it happens instead of when the computer system comes to a stop, thereby providing improved visual feedback to the user and/or performing an operation when a set of conditions has been met without requiring further user input.

In some embodiments, while displaying the first predefined indication (e.g., 1016, 1020, 1022, and/or 1030) for the first user (e.g., 1010, 1012, and/or 1014), the computer system detects, via the one or more input devices, a second user (e.g., 1010, 1012, and/or 1014) (e.g., person, animal, user, and/or object) (e.g., the second user is detected while the first user is detected and/or the computer system was not previously directed to the second user) in the environment (e.g., 1006) (e.g., the portion of the computer system is not directed at the second user when the second user is detected), wherein the second user is different (e.g., distinct and/or separate) from the first user. In some embodiments, in response to detecting the second user (e.g., 1010, 1012, and/or 1014) in the environment (e.g., 1006), the computer system moves, via the movement component, the portion of the computer system (e.g., 1000) to be directed to the second user (e.g., 1010, 1012, and/or 1014) (e.g., and not the first user) (e.g., and the first user). In some embodiments, in response to detecting the second user in the environment, the computer system displays a second predefined indication (e.g., 1016, 1020, 1022, and/or 1030) for the second user (e.g., 1010, 1012, and/or 1014). In some embodiments, the portion of the computer system is directed to the first user when the computer system detects, via the one or more input devices, the second user in the environment. In some embodiments, the portion of the computer system is not directed to the first user when the computer system detects, via the one or more input devices, the second user in the environment. In some embodiments, the second user and the first user are the same types of users (e.g., both the first user and the second user are humans, animals, and/or inanimate objects). In some embodiments, the second user and the first user are different types of users (e.g., the first user is a human and the second user is an animal or the first user is an animate object and the second user is a human). Moving the portion of the computer system to be directed to the second user and displaying the second predefined indication for the user in response to detecting the second user in the environment allows the computer system to more efficiently and/or effectively indicate to users that they are detected by the computer system, thereby providing improved visual feedback to the user and/or performing an operation when a set of conditions has been met without requiring further user input.

In some embodiments, while moving, via the movement component, the portion of the computer system (e.g., 1000) to be directed to the second user (e.g., 1010, 1012, and/or 1014) (and/or in accordance with a determination that the portion of the computer system is not directed to the first user (and/or that the first user is not in a field of view and/or detection of an input device of the one or more input devices)), the computer system ceases displaying the first predefined indication (e.g., 1016, 1020, 1022, and/or 1030) of the first user (e.g., 1010, 1012, and/or 1014). In some embodiments, the first predefined indication of the first user ceases to be displayed after the portion of the computer system stops moving (e.g., once the portion of the computer system is directed to the second user). Ceasing displaying the first predefined indication of the user while moving the portion of the computer system to be directed to the second user allows the computer system to indicate to users in the environment when the computer system has moved on from one user and/or what the computer system detects in a field of view and/or detection of the computer system, thereby providing improved visual feedback to the user and/or performing an operation when a set of conditions has been met without requiring further user input.

In some embodiments, after detecting the second user (e.g., 1010, 1012, and/or 1014) in the environment (e.g., 1006) and while displaying the second predefined indication (e.g., 1016, 1020, 1022, and/or 1030) for the second user, the computer system maintains (and/or continues) display of the first predefined indication (e.g., 1016, 1020, 1022, and/or 1030) for the first user (e.g., 1010, 1012, and/or 1014). In some embodiments, the second predefined indication is the same size, color, and/or shape as the first predefined indication. In some embodiments, the second predefined indication has a different size, color, and/or shape than the first predefined indication. In some embodiments, the first predefined indication ceases to be displayed as a part of the second predefined indication being displayed. In some embodiments, the second predefined indication has an appearance that is based on the appearance of the second user. In some embodiments, the first predefined indication for the first user is displayed on a larger portion of the display component than the second predefined indication for the second user. In some embodiments, the second predefined indication for the second user is displayed on a larger portion of the display component than the first predefined indication for the first user. Maintaining display of the first predefined indication for the first user while displaying the second predefined indication for the second user allows the computer system to indicate to users in the environment which users are being detected and/or which users are within a field of view and/or detection of the computer system, thereby providing improved visual feedback to the user and/or performing an operation when a set of conditions has been met without requiring further user input.

In some embodiments, the first predefined indication (e.g., 1016, 1020, 1022, and/or 1030) and the second predefined indication (e.g., 1016, 1020, 1022, and/or 1030) are the same (e.g., the first predefined indication and the second predefined indication have the same appearance, shape, color, size, have the same visual characteristics but are displayed in different areas of the display component, and/or are displayed on the same area of the display component). In some embodiments, the first user and/or the second user are not registered with the computer system. In some embodiments, the first predefined indication indicates that the first user is not registered with the computer system. In some embodiments, the second predefined indication indicates that the second user is not registered with the computer system. The first predefined indication and the second predefined indication being the same allows the computer system to indicate when it is detecting users that are determined to be the same type of user, thereby providing improved visual feedback to the user and/or performing an operation when a set of conditions has been met without requiring further user input.

In some embodiments, the first predefined indication (e.g., 1016, 1020, 1022, and/or 1030) and the second predefined indication (e.g., 1016, 1020, 1022, and/or 1030) are different (e.g., different size, different color, different shape and/or displayed on different areas of the display component). The first predefined indication and the second predefined indication being different allows the computer system to indicate when it is detecting different users in the environment, thereby providing improved visual feedback to the user and/or performing an operation when a set of conditions has been met without requiring further user input.

Note that details of the processes described above with respect to process 1100 (e.g., FIG. 11) are also applicable in an analogous manner to the methods described below/above. For example, process 1200 optionally includes one or more of the characteristics of the various methods described above with reference to process 1100. For example, the first predefined indication of process 1100 can be displayed in response to detecting the first user in process 1200. For brevity, these details are not repeated below.

FIG. 12 is a flow diagram illustrating a method for performing a movement using a computer system in accordance with some embodiments. Process 1200 is performed at a computer system (e.g., 100, 200, and/or 1000). Some operations in process 1200 are, optionally, combined, the orders of some operations are, optionally, changed, and some operations are, optionally, omitted.

As described below, process 1200 provides an intuitive way for performing a movement. The method reduces the cognitive burden on a user for interacting with a computer system, thereby creating a more efficient human-machine interface. For battery operated computing devices, enabling a user to interact with a computer system faster and more efficiently conserves power and increases the time between battery charges.

In some embodiments, process 1200 is performed at a computer system (e.g., 1000) that is in communication with a first movement component (e.g., an actuator, a movable base, a rotatable component, and/or a rotatable base), a second movement component (e.g., an actuator, a movable base, a rotatable component, and/or a rotatable base) (e.g., the first movement component or another movement component different from the first movement component), and one or more input devices (e.g., a camera, a depth sensor, and/or a microphone). In some embodiments, the computer system is a watch, a phone, a tablet, a processor, a head-mounted display (HMD) device, a communal device, a media device, a speaker, a television, and/or a personal computing device.

The computer system detects (1202), via the one or more input devices, a first user (e.g., 1010, 1012, and/or 1014) in an environment (e.g., 1006) (e.g., a physical environment). In some embodiments, the first user is detected via a microphone, a camera, a depth sensor, and/or a communication (e.g., indicating presence of the first user) received from a computer system corresponding to the first user.

In response to (1204) detecting the first user (e.g., 1010, 1012, and/or 1014) in the environment (e.g., 1006), the computer system moves (1206) (e.g., physically changes and/or moves), via the first movement component, a portion (e.g., a housing and/or an enclosure including a display component and/or the one or more input devices) (e.g., a front portion) of the computer system (e.g., 1000) to be directed to (e.g., facing and/or in an orientation with respect to) the first user (e.g., 1010, 1012, and/or 1014) (e.g., as described above at FIGS. 10A-10D).

In response to (1204) detecting the first user in the environment, in conjunction with (e.g., before, during, and/or after) moving the portion of the computer system (e.g., 1000) to be directed to the first user (e.g., 1010, 1012, and/or 1014), the computer system performs (1208), via the second movement component, a first physical movement (e.g., a predefined physical movement) (e.g., bowing and/or other physical movement that is either predefined for any user or for a particular user) (e.g., while facing and/or orientated toward the first user) that causes a position of the portion of the computer system to be moved away from being directed to the first user (e.g., as described above with respect to FIGS. 10A-10D). In some embodiments, the first physical movement is separate from moving the portion of the computer system to be directed to the first user. In conjunction with moving the portion of the computer system to be directed to the first user, performing the first physical movement that causes a position of the portion of the computer system to be moved away from being directed to the first user allows the computer system to visually indicate using movement to the first user that the computer system detects the first user, thereby providing improved visual feedback to the user and/or performing an operation when a set of conditions has been met without requiring further user input.

In some embodiments, the second movement component is the first movement component (e.g., a single movement component). In some embodiments, the second movement component is different from the first movement component.

In some embodiments, the computer system detects, via the one or more input devices, a second user (e.g., 1010, 1012, and/or 1014) in the environment (e.g., 1006). In some embodiments, the second user is different from the first user (e.g., 1010, 1012, and/or 1014). In some embodiments, the second user is detected when the first user is detected. In some embodiments, the second user is detected after the first user is detected. In some embodiments, the second user is detected after moving the portion of the computer system to be directed to the first user and/or after performing the first physical movement. In some embodiments, after moving the portion of the computer system (e.g., 1000) to be directed to the first user (e.g., 1010, 1012, and/or 1014), the computer system moves (e.g., physically changes and/or moves), via the first movement component, the portion of the computer system (e.g., 1000) to be directed to (e.g., facing and/or in an orientation with respect to) the second user (e.g., 1010, 1012, and/or 1014). In some embodiments, after moving the portion of the computer system to be directed to the first user, in conjunction with (e.g., before, during, and/or after) moving the portion of the computer system (e.g., 1000) to be directed to the second user (e.g., 1010, 1012, and/or 1014), the computer system performs, via the second movement component, a second predefined physical movement (e.g., bowing and/or other physical movement that is either predefined for any user or for a particular user) (e.g., while facing and/or orientated toward the second user) that causes a position of the portion of the computer system to be moved away from being directed to the second user (e.g., as described above at FIGS. 10A-10D). In some embodiments, the second physical movement is separate from moving the portion of the computer system to be directed to the second user. In conjunction with moving the portion of the computer system to be directed to the second user, performing the second physical movement that causes a position of the portion of the computer system to be moved away from being directed to the second user allows the computer system to visually indicate using movement to different users that the computer system detects the different users, thereby providing improved visual feedback to the user and/or performing an operation when a set of conditions has been met without requiring further user input.

In some embodiments, the second physical movement is the same as the first physical movement (e.g., as described above at FIGS. 10A-10D) (e.g., same type of movement, same amount of rotation, and/or same type of translation). In some embodiments, the second physical movement is a different type of movement than the first physical movement. In some embodiments, the second physical movement is a different movement than the first physical movement. In some embodiments, the second physical movement is different from the first physical movement. The second physical movement being the same as the first physical movement allows the computer system to represent certain states (e.g., detecting a user) in the same way so that users can understand what to look for, thereby providing improved visual feedback to the user and/or performing an operation when a set of conditions has been met without requiring further user input.

In some embodiments, the first physical movement occurs while moving the portion of the computer system (e.g., 1000) to be directed to the first user (e.g., 1010, 1012, and/or 1014). In some embodiments, the second physical movement occurs while moving the portion of the computer system to be directed to the second user (e.g., 1010, 1012, and/or 1014). In some embodiments, the first physical movement is finished before the computer system is directed to the first user. In some embodiments, the second physical movement is finished before the computer system is directed to the second user. The first physical movement occurring while moving the portion of the computer system to be directed to the first user allows the computer system to be directed to a user and to indicate detection of the user in one continuous movement, thereby providing improved visual feedback to the user and/or performing an operation when a set of conditions has been met without requiring further user input.

In some embodiments, the computer system (e.g., 1000) is in communication with a display component. In some embodiments, while (and/or in response to detecting that) the portion of the computer system (e.g., 1000) is directed to the first user (e.g., 1010, 1012, and/or 1014) (and/or in accordance with a determination that the portion of the computer system is directed to and/or moving to be directed to the first user), the computer system displays, via the display component, a first user interface (e.g., 1002, including 1004, 1016, and/or 1018a) (e.g., 1002, including 1004, 1018b, and/or 1020) that corresponds to the first user (e.g., the first user interface includes content that corresponds to the first user and/or the first user interface is customized to, for, and/or by the first user) (e.g., and not the second user). In some embodiments, the first user interface takes up a majority of the display component. In some embodiments, the first user interface takes up a portion (e.g., less than a majority of the display component) of the display component. In some embodiments, while (and/or in response to detecting that) the portion of the computer system (e.g., 1000) is directed to the second user (e.g., 1010, 1012, and/or 1014) (and/or in accordance with a determination that the portion of the computer system is directed to and/or moving to be directed to the second user), the computer system displays, via the display component, a second user interface (e.g., 1004, and/or 1024) that corresponds to the second user (e.g., the second user interface includes content that corresponds to the second user and/or the second user interface is customized to, for, and/or by the second user) (e.g., and not the first user). In some embodiments, the first user interface and/or the second user interface are based on the first user and the second user. In some embodiments, the computer system concurrently displays the first user interface and the second user interface. In some embodiments, the computer system ceases display of the first user interface to display the second user interface or vice versa. In some embodiments, the second user interface takes up a majority of the display component. In some embodiments, the second user interface takes up a portion (e.g., less than a majority of the display component) of the display component. In some embodiments, the second user interface is the same as the first user interface. In some embodiments, the second user interface is the first user interface. In some embodiments, the second user interface is different from the first user interface. In some embodiments, the second user interface includes a user interface element that the first user interface does not include. In some embodiments, the first user interface includes a user interface element that the second user interface does not include. Displaying a user interface while the portion of the computer system is directed to different users allows the computer system to visually indicate using user interfaces that the computer system detects a user, thereby providing improved visual feedback to the user and/or performing an operation when a set of conditions has been met without requiring further user input.

In some embodiments, the computer system (e.g., 1000) is in communication with one or more output devices (e.g., smart speakers, home theater system, soundbars, headphones, earphones, earbuds, speakers, television speakers, augmented reality headset speakers, audio jacks, optical audio output, Bluetooth audio outputs, and/or HDMI audio outputs). In some embodiments, in conjunction with (e.g., while, before, and/or after) (and/or in response to a determination that) the portion of the computer system (e.g., 1000) is directed to the first user (e.g., 1010, 1012, and/or 1014) (e.g., and not the second user), the computer system outputs, via the one or more output devices, first audio output that corresponds to the first user (e.g., as described above at FIGS. 10A-10F) (e.g., and not the second user) (e.g., the first audio output has a set of one or more audio characteristics (e.g., tone, treble, and/or bass) that corresponds to the first user (e.g., an appearance of the first user and/or a distance of the first user from the computer system)). In some embodiments, in conjunction with (e.g., while, before, and/or after) (and/or in response to a determination that) the portion of the computer system (e.g., 1000) being directed to the second user (e.g., 1010, 1012, and/or 1014) (e.g., and not the first user), the computer system outputs, via the one or more output devices, second audio output (e.g., that is different from the first audio output or is the same as the first audio output) that corresponds to the second user (e.g., as described above at FIGS. 10A-10F) (e.g., and not the first user) (e.g., the second audio output has a set of one or more audio characteristics (e.g., tone, treble, and/or bass) that corresponds to the second user (e.g., an appearance of the second user and/or a distance of the second user from the computer system)). In some embodiments, the first audio output and the second audio output are the same. In some embodiments, the first audio output and the second audio output are different. In some embodiments, the first audio output and/or the second audio output are based on the first user and the second user. In conjunction with the portion of the computer system being directed to the second user, outputting audio output that corresponds to a user allows the computer system to acoustically indicate that the computer system detects a user, thereby providing improved feedback to the user and/or performing an operation when a set of conditions has been met without requiring further user input.

In some embodiments, the first physical movement is performed after moving the portion of the computer system (e.g., 1000) to be directed to the first user (e.g., 1010, 1012, and/or 1014). In some embodiments, the second physical movement is performed after moving the portion of the computer system to be directed to the second user (e.g., 1010, 1012, and/or 1014). In some embodiments, the first physical movement is performed before the portion of the computer system is directed to the first user. In some embodiments, the second physical movement is performed before the portion of the computer system is directed to the second user. In some embodiments, the first physical movement is performed before moving the portion of the computer system to be directed to the first user. In some embodiments, the second physical movement is performed before moving the portion of the computer system to be directed to the second user. A physical movement being performed after moving the portion of the computer system to be directed to a user allows the computer system to indicate to the user that the computer system detects the user while directed to the user and/or without distracting the user with other movements (e.g., moving to be directed to the user), thereby providing improved visual feedback to the user and/or performing an operation when a set of conditions has been met without requiring further user input.

In some embodiments, the computer system detects, via the one or more input devices, a third user (e.g., 1010, 1012, and/or 1014) in the environment (e.g., 1006). In some embodiments, the third user is different from the first user (e.g., 1010, 1012, and/or 1014) and the second user (e.g., 1010, 1012, and/or 1014). In some embodiments, the third user is detected when the first user and/or the second user is detected. In some embodiments, the third user is detected after the first user and/or the second user is detected. In some embodiments, the third user is detected after moving the portion of the computer system to be directed to the first user and/or the second user. In some embodiments, the third user is detected after performing the first physical movement and/or the second physical movement. In some embodiments, after moving the portion of the computer system (e.g., 1000) to be directed to the second user (e.g., 1010, 1012, and/or 1014), the computer system moves (e.g., physically changes and/or moves), via the first movement component, the portion of the computer system (e.g., 1000) to be directed to (e.g., facing and/or in an orientation with respect to) the third user (e.g., 1010, 1012, and/or 1014). In some embodiments, after moving the portion of the computer system to be directed to the second user, in conjunction with (e.g., before, during, and/or after) moving the portion of the computer system (e.g., 1000) to be directed to the third user (e.g., 1010, 1012, and/or 1014), the computer system performs, via the second movement component, a third predefined physical movement (e.g., bowing and/or other physical movement that is either predefined for any user or for a particular user) (e.g., while facing and/or orientated toward the third user) that causes a position of the portion of the computer system to be moved away from being directed to the third user (e.g., 1010, 1012, and/or 1014) (e.g., as described above at FIGS. 10A-10D). In some embodiments, the third physical movement is separate from moving the portion of the computer system to be directed to the third user. In conjunction with moving the portion of the computer system to be directed to the third user, performing the third physical movement that causes a position of the portion of the computer system to be moved away from being directed to the third user allows the computer system to visually indicate using movement to several different users that the computer system detects the different users, thereby providing improved visual feedback to the user and/or performing an operation when a set of conditions has been met without requiring further user input.

In some embodiments, after moving the portion of the computer system (e.g., 1000) to be directed to the second user (e.g., 1010, 1012, and/or 1014) (and/or after performing the second physical movement) (and/or before moving the portion of the computer system to be directed to the third user) (and/or after moving the portion of the computer system to be directed to the third user), the computer system moves (e.g., physically changes and/or moves), via the first movement component, the portion of the computer system to be directed to the first user (e.g., 1010, 1012, and/or 1014) (e.g., without performing the first physical movement in conjunction with moving the portion of the computer system to be directed to the first user). In some embodiments, after moving the portion of the computer system to be directed to the third user, the computer system moves (e.g., physically changes and/or moves), via the first movement component, the portion of the computer system to be directed to the second user (e.g., without performing the second physical movement in conjunction with moving the portion of the computer system to be directed to the second user) and/or the first user (e.g., without performing the first physical movement in conjunction with moving the portion of the computer system to be directed to the first user). After moving the portion of the computer system to be directed to the second user, moving the portion of the computer system to be directed to the first user allows the computer system to go back to a user after acknowledging detection of another user in the environment, thereby providing improved visual feedback to the user and/or performing an operation when a set of conditions has been met without requiring further user input.

In some embodiments, the first physical movement ends while the portion of the computer system (e.g., 1000) is directed to the first user (e.g., 1010, 1012, and/or 1014). In some embodiments, the first physical movement ends before the portion of the computer system is directed to the first user. In some embodiments, the second physical movement ends while the portion of the computer system is directed to the second user. In some embodiments, the second physical movement ends before the portion of the computer system is directed to the second user. The first physical movement ending while the portion of the computer system is directed to the first user allows the computer system to be directed to a user and to indicate detection of the user in one continuous movement, thereby providing improved visual feedback to the user and/or performing an operation when a set of conditions has been met without requiring further user input.

In some embodiments, in response to detecting the first user (e.g., 1010, 1012, and/or 1014) in the environment (e.g., 1006), the computer system transitions from a first state (e.g., an active state, a sleep state, a low power state, and/or an inactive state) (e.g., as illustrated in FIG. 10A) to a second state (e.g., an active state, a sleep state, a low power state, and/or an inactive state) (e.g., as illustrated in FIG. 10B) different from the first state. In some embodiments, the computer system transitions from the second state to the first state in response to no longer detecting a user (e.g., the first user, the second user, and/or the third user). Transitioning between states in response to detecting the first user in the environment allows the computer system to cater its state to a current context and/or a likelihood that the computer system will be interacted with, thereby providing improved feedback to the first user, reducing the number of inputs needed to perform an operation, and/or performing an operation when a set of conditions has been met without requiring further user input.

In some embodiments, moving the portion of the computer system (e.g., 1000) to be directed to the first user (e.g., 1010, 1012, and/or 1014) includes rotating (e.g., a pitch rotation, a yaw rotation, and/or a roll rotation) the portion of the computer system about a first axis (and, in some embodiments, one or more other axes) and not a second axis different from the first axis (e.g., an axis of the computer system and/or the portion of the computer system and/or an axis of the first movement component and/or the second movement component). In some embodiments, performing the first physical movement includes rotating (e.g., a pitch rotation, yaw rotation, and/or a roll rotation) the portion of the computer system (e.g., 1000) about the second axis (and, in some embodiments, one or more other axes) and not the first axis (e.g., as described above at FIGS. 10A-10D). In some embodiments, performing the second physical movement and/or the third physical movement includes rotating the computer system about the second axis and not the first axis. Rotating about different axes depending on whether performing physical movements or moving to be directed to a user allows the computer system to more distinctively move so that users can interpret its movements easier, thereby providing improved feedback to the first user, reducing the number of inputs needed to perform an operation, and/or performing an operation when a set of conditions has been met without requiring further user input.

Note that details of the processes described above with respect to process 1200 (e.g., FIG. 12) are also applicable in an analogous manner to the methods described below/above. For example, process 1300 optionally includes one or more of the characteristics of the various methods described above with reference to process 1200. For example, moving the portion of the computer system in process 1300 can be performed in conjunction with performing the first physical movement of process 1200. For brevity, these details are not repeated below.

FIG. 13 is a flow diagram illustrating a method for introducing a new user using a computer system in accordance with some embodiments. Process 1300 is performed at a computer system (e.g., 100, 200, and/or 1000). Some operations in process 1300 are, optionally, combined, the orders of some operations are, optionally, changed, and some operations are, optionally, omitted.

As described below, process 1300 provides an intuitive way for introducing a new user. The method reduces the cognitive burden on a user for introducing a new user, thereby creating a more efficient human-machine interface. For battery operated computing devices, enabling a user to introduce a new user faster and more efficiently conserves power and increases the time between battery charges.

In some embodiments, process 1300 is performed at a computer system (e.g., 1000) that is in communication with a movement component (e.g., an actuator, a movable base, a rotatable component, and/or a rotatable base) and a sensor (e.g., a biometric sensor, one or more cameras, a wide-angle camera, an ultra-wide angle camera, a telephone camera, a depth sensor, a finger print scanner, a thermometer, and/or a heart-rate sensor).

While a portion (e.g., a housing and/or an enclosure including a display component and/or the one or more input devices) (e.g., a front portion) of the computer system (e.g., 1000) is in a first position in an environment (e.g., 1006), the computer system detects (1302) an input (e.g., a verbal input (e.g., a verbal input, an audible request, an audible command, and/or an audible statement) and/or a non-verbal input (e.g., a swipe input, a hold-and-drag input, a gaze input, an air gesture, and/or a mouse click)) (e.g., as described above with respect to FIG. 10E) corresponding to a request to register a user (e.g., 1010, 1012, and/or 1014) (e.g., person, animal, user, and/or object) with the computer system.

In response to (1304) detecting the input corresponding to the request to register a user (e.g., 1010, 1012, and/or 1014) with the computer system (e.g., 1000), in accordance with a determination that a new user (e.g., 1010, 1012, and/or 1014) is in a second position, different from the first position, in the environment (e.g., 1006), the computer system moves (1306) (e.g., rotates, tilts, and/or laterally moves), via the movement component, the portion of the computer system (e.g., 1000) to be directed to the second position (e.g., so that the new user is within a portion of a field of view and/or detection of the sensor (e.g., after movement of the portion of the computer system has stopped and/or after movement of the portion of the computer system has stopped in a particular direction and/or a particular type (e.g., lateral movement, yaw movement, pitch movement, and/or roll movement (e.g., has stopped in a particular direction (e.g., clockwise and/or counterclockwise))))) (e.g., as described above with respect to FIG. 10E).

In response to (1304) detecting the input corresponding to the request to register the user with the computer system, in accordance with a determination that the new user (e.g., 1010, 1012, and/or 1014) is in a third position, different from the first position and the second position, in the environment (e.g., 1006), the computer system moves (1308) (e.g., rotates, tilts, and/or laterally moves), via the movement component, the portion of the computer system (e.g., 1000) to be directed to the third position (e.g., as described above at FIGS. 10A-10D) (e.g., without being directed to the second position) (e.g., so that the new user is within a portion of a field of view and/or detection of the sensor (e.g., after movement of the portion of the computer system has stopped and/or after movement of the portion of the computer system has stopped in a particular direction and/or a particular type (e.g., lateral movement, yaw movement, pitch movement, and/or roll movement (e.g., has stopped in a particular direction (e.g., clockwise and/or counterclockwise))))).

In response to (1304) detecting the input corresponding to the request to register the user with the computer system, in conjunction with (before, while, and/or after) moving the portion of the computer system (e.g., 1000), the computer system captures (1310), via the sensor, data corresponding to the new user (e.g., 1010, 1012, and/or 1014) (e.g., as described above with respect to FIGS. 10E-10F). In some embodiments, in response to detecting the input corresponding to the request to register the new user with the computer system and in accordance with a determination that the new user is in the first position in the environment, the computer system is not moved. In some embodiments, while the computer system is in the first position in the environment, the second position, the third position, and/or the new user is not within a field of detection of the sensor. Moving the portion of the computer system to different positions depending on a position of a new user in response to detecting the input corresponding to the request to register a user with the computer system allows the computer system to indicate to users in the environment who the computer system is attempting to register and/or to re-position the portion to better detect data corresponding to the new user, thereby providing improved feedback to users, reducing the number of inputs needed to perform an operation, and/or performing an operation when a set of conditions has been met without requiring further user input.

In some embodiments, the computer system (e.g., 1000) is in communication with one or more input devices (e.g., including the sensor). In some embodiments, before detecting the input (e.g., 1-360 seconds before), the computer system detects, via the one or more input devices, the new user (e.g., 1010, 1012, and/or 1014) as being unregistered with the computer system (e.g., 1000) (e.g., presently unregistered with the computer system and/or previously unregistered with the computer system) (e.g., the new user is unknown to the computer system, the new user is not associated with the computer system, the new user does not own the computer system, the new user does not correspond to a user account that is registered with the computer system, and/or the new user was not previously registered with the computer system). In some embodiments, the new user is detected as being unregistered with the computer system in response to the computer system receiving the verbal input. In some embodiments, the new user is detected in the environment before detecting the new user as being unregistered with the computer system. Before detecting the input, detecting the new user as being unregistered with the computer system allows the computer system to more quickly and/or efficiently determine where to move by already identifying the new user as being unregistered before receiving a request to register a user, thereby providing improved feedback to users, reducing the number of inputs needed to perform an operation, and/or performing an operation when a set of conditions has been met without requiring further user input.

In some embodiments, the input corresponds to (and/or is from) a first user (e.g., 1010, 1012, and/or 1014) different from the new user. In some embodiments, the first user is identified as being registered with the computer system (e.g., 1000) (e.g., the first user is known to the computer system and/or the computer system has previously identified the first user) (e.g., the first user is the source of the input (e.g., the first user speaks the input and/or the first user causes the computer system or another computer system different from the computer system to provide the input to the computer system)). The input corresponding to a registered user allows the computer system to enable registered users to add other users to the computer system, thereby providing improved feedback to users and/or performing an operation when a set of conditions has been met without requiring further user input.

In some embodiments, the input is from the new user (e.g., 1010, 1012, and/or 1014) (e.g., the new user is the source of the input (e.g., the new user speaks the input and/or the new user causes the computer system or another computer system different from the computer system to provide the input to the computer system)). The input being from the new user allows the computer system to react to unknown users interacting with the computer system and, in some embodiments, begin to build a profile and/or account for the unknown users, thereby providing improved feedback to users and/or performing an operation when a set of conditions has been met without requiring further user input.

In some embodiments, the input does not include an instruction (e.g., an audible instruction and/or a textual instruction) (e.g., a request and/or a demand) to register a user (e.g., 1010, 1012, and/or 1014) with the computer system (e.g., 1000) (e.g., to save an identity of a user with the computer system, register a user account with the computer system, and/or save biometric identity of a user with the computer system). In some embodiments, the input includes an instruction to register a user with the computer system. In some embodiments, the input includes a name that is not known by the computer system. In some embodiments, the name corresponds to the new user. The input not including an instruction to register a user with the computer system allows the computer system to more naturally register users with the computer system without necessarily requiring explicit instructions to do so, allowing, in some embodiments, the computer system begin to build a profile and/or account for unregistered users, thereby providing improved feedback to users and/or performing an operation when a set of conditions has been met without requiring further user input.

In some embodiments, the computer system (e.g., 1000) is in communication with one or more output devices. In some embodiments, in response to detecting the input corresponding to the request to register a user (e.g., 1010, 1012, and/or 1014) with the computer system (e.g., 1000) and in conjunction with capturing the data corresponding to the new user (e.g., 1010, 1012, and/or 1014), the computer system outputs, via the one or more output devices, a request for a name of the new user (e.g., 1026) (e.g., an auditory request and/or a textual request) (e.g., a legal name, a nickname, and/or a name that corresponds to a user account of the new user) (e.g., requesting a name of the new user through a textual and/or auditory modality). In response to detecting the input corresponding to the request to register a user with the computer system and in conjunction with capturing the data corresponding to the new user, outputting, via the one or more output devices, a request for a name of the new user allows the computer system to register an identifier provided by the new user with the new user, thereby providing improved feedback to users and/or performing an operation when a set of conditions has been met without requiring further user input.

In some embodiments, the data corresponding to the new user (e.g., 1010, 1012, and/or 1014) includes an image of the new user (e.g., a still photo and/or a video). In some embodiments, the image includes data corresponding to a face, upper torso, and/or lower torso of the new user. In some embodiments, the image includes data corresponding to the new user and a respective user different from the new user. In some embodiments, the data corresponding to the new user includes biometric data (e.g., data corresponding to retina recognition, iris recognition, voice recognition, facial recognition, and/or finger geometry of the new user) (e.g., of the new user or of a user that does not provide the input). The data corresponding to the new user including an image of the new user allows the computer system to use the image of the new user to recognize the new user going forward in a visual manner, thereby providing improved feedback to users and/or performing an operation when a set of conditions has been met without requiring further user input.

In some embodiments, the computer system (e.g., 1000) is in communication with a display component. In some embodiments, after (and/or in response to) detecting the data including the image of the new user (e.g., 1010, 1012, and/or 1014), the computer system displays, via the display component, a graphical representation (e.g., 1016, 1020, 1022, and/or 1030) (e.g., avatar and/or an animation of the new user) of the new user (e.g., as described above at FIG. 10F). In some embodiments, an appearance of the graphical representation is based on an appearance of the new user in the image. In some embodiments, an appearance of the graphical representation is not based on an appearance of the new user. In some embodiments, the computer system animates the graphical representation to mimic real time movements of the new user. In some embodiments, the computer system ceases to display the graphical representation in accordance with a determination that the new user is not within a field of detection of an input device of one or more inputs devices in communication with the computer system. In some embodiments, the computer system maintains display of the graphical representation in accordance with a determination that the new user is not within a field of detection of an input device of one or more inputs devices in communication with the computer system. In some embodiments, the graphical representation is unassigned to the new user in accordance with a determination that the new user unregisters with the computer system. Displaying the graphical representation of the new user after detecting the data including the image of the new user allows the computer system to provide to a user what and/or how the computer system sees and/or detects the user, thereby providing improved feedback to users and/or performing an operation when a set of conditions has been met without requiring further user input.

In some embodiments, in accordance with a determination that the new user (e.g., 1010, 1012, and/or 1014) is registered with another computer system (e.g., 1000) different from the computer system (e.g., a user account of the new user is registered with the other computer system, the other computer system stores biometric data that corresponds to the new user, and/or the new user owns the other computer system), the graphical representation (e.g., 1016, 1020, 1022, and/or 1030) was previously assigned (e.g., by the other computer system) to the new user. In some embodiments, in accordance with a determination that the new user (e.g., 1010, 1012, and/or 1014) is not registered with another computer system (e.g., 1000) different from the computer system (e.g., and/or the other computer system described in the previous limitation), the graphical representation (e.g., 1016, 1020, 1022, and/or 1030) was not previously assigned to the new user. The graphical representation being previously assigned to the new user (e.g., with another computer system) allows the computer system to use representations already approved and/or created by the user instead of generating its own, thereby providing improved feedback to users and/or performing an operation when a set of conditions has been met without requiring further user input.

In some embodiments, in accordance with a determination that the new user (e.g., 1010, 1012, and/or 1014) is not registered with another computer system (e.g., 1000) (and/or the computer system), the graphical representation is a placeholder representation (e.g., 1030) (e.g., initials of the new user, a name of the new user, and/or a default graphical representation (e.g., a default graphical representation chosen by the computer system or chosen by a user of the computer system)). In some embodiments, the placeholder representation is replaced with a graphical representation that is created and/or selected by the new user. In some embodiments, the placeholder representation is predefined and/or not defined by the new user. The graphical representation being a placeholder representation when the new user is not registered with another computer system allows the computer system to indicate to new users an amount of information that the computer system knows about the new user and, in some embodiments, to display some representation for the new user so that the new user can know that the computer system detects the new user, thereby providing improved feedback to users and/or performing an operation when a set of conditions has been met without requiring further user input.

In some embodiments, the data corresponding to the new user (e.g., 1010, 1012, and/or 1014) includes biometric data (e.g., data from an infrared sensor, a heat index sensor, proximity sensor, speed sensor, ultrasound sensor, and/or an accelerometer sensor) corresponding to the new user. The data corresponding to the new user including biometric data corresponding to the new user allows the computer system to use the biometric data to recognize the new user going forward, thereby providing improved feedback to users and/or performing an operation when a set of conditions has been met without requiring further user input.

In some embodiments, the data corresponding to the new user (e.g., 1010, 1012, and/or 1014) includes voice data (e.g., content of words spoken, source of voice, tone of voice, volume of voice, amount of bass in voice, inflection in voice, source of voice, and/or speed of output of words) corresponding to the new user. The data corresponding to the new user including voice data corresponding to the new user allows the computer system to use the voice data to recognize the new user going forward, thereby providing improved feedback to users and/or performing an operation when a set of conditions has been met without requiring further user input.

In some embodiments, the movement of the portion of the computer system to be directed to the second position ends while the portion of the computer system is directed to the user. In some embodiments, ending the movement of the portion of the computer system to be directed to the user enables the computer system to direct one or more sensors to identify the user, thereby providing improved feedback to users and/or performing an operation when a set of conditions has been met without requiring further user input.

In some embodiments, in conjunction with moving the portion of the computer system to be directed to the second position, the computer system performs, via the movement component, a physical movement that causes a position of the portion of the computer system to be moved away from being directed to the second position (e.g., as described above with respect to process 1100).

Note that details of the processes described above with respect to process 1300 (e.g., FIG. 13) are also applicable in an analogous manner to the methods described below/above. For example, process 1100 optionally includes one or more of the characteristics of the various methods described above with reference to process 1300. For example, the data of process 1300 can be captured in conjunction with moving the portion of the computer system to be directed to the first user of process 1100. For brevity, these details are not repeated below.

FIGS. 14A-14D illustrate exemplary user interfaces for communicating with respect to dialects and registering users in accordance with some embodiments. The user interfaces in these figures are used to illustrate the processes described below, including the processes in FIGS. 15-17.

The left side of FIGS. 14A-14D illustrates computer system 1400 displaying different user interfaces as a tablet. It should be recognized that computer system 1400 can be other types of computer systems such as a smart phone, a smart watch, a laptop, a communal device, a smart speaker, a smart display, an accessory, a personal gaming system, a desktop computer, a fitness tracking device, and/or a head-mounted display (HMD) device. In some examples, computer system 1400 includes and/or is in communication with one or more sensors (e.g., a camera, a lidar detector, a motion sensor, an infrared sensor, and/or a microphone). In some examples, computer system 1400 includes and/or is in communication with one or more output devices (e.g., a display screen, a projector, a touch-sensitive display, and/a speaker). In some examples, computer system 1400 includes and/or is in communication with one or more movement components (e.g., an actuator, a moveable base, a rotatable component, and/or a rotatable base). In some examples, computer system 1400 includes one or more components and/or features described above in relation to computer system 100 and/or electronic device 200.

The right side of FIGS. 14A-14D include diagram 1408. Diagram 1408 is a visual aid that is a representation of a physical space and/or environment that includes computer system 1400, a first user, and a second user different from the first user. Diagram 1408 includes computer system representation 1410, first user representation 1412, and second user representation 1414. The positioning of computer system representation 1410, first user representation 1412, and second user representation 1414 within diagram 1408 is representative of the real-world positioning of computer system 1400 with respect to the first user and the second user. Diagram 1408 includes dotted lines which represent a field of detection and/or a field of view (sometimes collectively referred to as a field of detection herein) of computer system 1400. The field of detection of computer system 1400 corresponds to a field of view and/or a field of detection of one or more front facing sensors (e.g., cameras) of computer system 1400. It should be recognized that the field of detection can be for a set of one or more sensors while computer system 1400 has another set of one or more sensors with a larger and/or different field of detection. In this example, there are two users. In some examples, there are more or less than two users.

FIGS. 14A-14D illustrate a process where computer system 1400 detects information about users within an environment and uses the information to operate in the environment. In some examples, the information is used to register an unknown user with computer system 1400 (e.g., instead of having the information input into computer system 1400 by the unknown user and/or another user (e.g., a registered user). In some examples, the process includes computer system 1400 changing content output by computer system 1400 based on languages and/or dialects detected in the environment (e.g., language and/or dialect spoken by a user). In some examples, content output by computer system 1400 includes audio content via one or more speakers connected to and/or in communication with computer system 1400, visual content via a display component connected to and/or in communication with computer system 1400, a set of one or more movements of a user-interface object (e.g., an avatar, as described herein) via the display component, and/or a set of one or more movements of a portion (e.g., a display component and/or one or more other components) of computer system 1400 via one or more movement components.

As illustrated in FIG. 14A, computer system 1400 displays user interface 1402. In this example, user interface 1402 is a home screen user interface which can include one or more indications and/or controls. In some examples, user interface 1402 is a smart home system user interface that displays indications and/or controls for a building's systems (e.g., lighting, shades, locks, sound, and/or environmental controls). For example, user interface 1402 can display a lock status of all doors of the building as well as an average room temperature. In some examples, user interface 1402 includes a virtual assistant avatar (e.g., an anthropomorphic visual representation) for a virtual assistant and/or other artificial intelligence application. It should be recognized that user interface 1402 is merely an example and that other user interfaces can be displayed by computer system 1400.

As illustrated in FIG. 14A, computer system 1400 displays user interface element 1404 at a central location within user interface 1402. In this example, user interface element 1404 is a time indicator displaying a current real-world time. In some examples, user interface element 1404 is some other type of user interface element (e.g., control and/or indicator). In some examples, user interface element is displayed at some other location within user interface 1402.

As illustrated in FIG. 14A, the first user is within the field of detection of computer system 1400 (e.g., as indicated by first user representation 1412 being within the dotted lines in diagram 1408). At FIG. 14A, computer system 1400 detects the first user within the field of detection. In this example, the first user is an unknown user (e.g., not known by computer system 1400). In some examples, an unknown user is a user that is not registered with computer system 1400 (e.g., user does not have an account with, user's biometrics are not catalogued by, and/or user does not have a login for computer system 1400).

At FIG. 14A, in response to detecting the first user, a determination is made that the first user is not registered with computer system 1400. As illustrated in FIG. 14A, in response to detecting the first user and in accordance with the determination is made that the first user is not registered with computer system 1400, computer system 1400 displays unknown user indication 1406 at a top central location within user interface 1402 (e.g., a default and/or predefined location for indications of users within the field of detection of computer system 1400). In this example, unknown user indication 1406 includes two question marks (e.g., ??). It should be recognized that other indications of an unknown user can be used with techniques described herein. For example, unknown user indication 1406 can include an image of the first user captured by one or more cameras connected to or in communication with computer system 1400. For another example, unknown user indication 1406 can include some other image and/or symbol, such as an outline of a nondescript human head. In some examples, computer system 1400 displays unknown user indication 1406 at a different location (e.g., not the top center) within user interface 1402.

In some examples, in response to detecting the first user (e.g., an unknown user), computer system 1400 initiates a user registration process for the first user. In some examples, a user registration process is a process of gathering detectable information (e.g., images captured by computer system 1400 and/or identifying information detected via audio input (e.g., voice, name, title, relationship, and/or birthday)) corresponding to the unknown user to register the unknown user with computer system 1400.

In some examples, in response to initiating the user registration process for the first user, computer system 1400 displays an indication with unknown user indication 1406 to indicate that computer system 1400 has initiated the user registration process. For example, in response to initiating the user registration process for the first user, computer system 1400 can pulse the border around unknown user indication 1406.

At FIG. 14A, computer system 1400 detects the second user. In some examples, in response to detecting the second user and/or determining to turn to the second user, computer system 1400 rotates the portion of computer system 1400 until the second user is within the field of detection.

As illustrated in FIG. 14B, the second user is within the field of detection of computer system 1400 and the first user is not within the field of detection of computer system 1400 (e.g., as indicated by second user representation 1414 and not first user representation 1412 being within the dotted lines in diagram 1408). At FIG. 14B, computer system 1400 ceases to detect the first user within the field of detection of computer system 1400. As illustrated in FIG. 14B, in response to computer system 1400 ceasing to detect the first user within the field of detection of computer system 1400, computer system 1400 ceases displaying unknown user indication 1406.

At FIG. 14B, computer system 1400 detects the second user within the field of detection of computer system 1400. In this example, the second user (e.g., Julie Allen) is a known user (e.g., known by computer system 1400). In some examples, a known user is a user that registered with computer system 1400 (e.g., user has an account with, user's biometrics are catalogued by, and/or user has a login for computer system 1400). At FIG. 14B, in response to detecting the second user, a determination is made that the second user is registered with computer system 1400. As illustrated in FIG. 14B, in response to detecting the second user and in accordance with a determination that the second user is registered with computer system 1400, computer system 1400 displays known user indication 1416, which corresponds to the second user. As illustrated in FIG. 14B, computer system displays known user indication 1416 at a top central location within user interface 1402 (e.g., the same location as unknown user indication 1406) (e.g., a default and/or predefined location for indications of users within the field of detection of computer system 1400). In some examples, computer system 1400 displays known user indication 1416 at a different location (e.g., not the top center) within user interface 1402. In some examples, computer system 1400 displays known user indication 1416 after stopping rotation. In some examples, computer system 1400 displays known user indication 1416 before stopping rotation.

In this example, known user indication 1416 includes the initials of the second user (e.g., JA for Julie Allen). It should be recognized that known user indication 1416 can include other content corresponding to the second user. For example, known user indication 1416 can include an image of the second user captured by computer system 1400 via one or more cameras connected to and/or in communication with computer system 1400. For another example, known user indication 1416 can include a user avatar that corresponds to the second user (e.g., an image preselected by the second user).

In some examples, in response to detecting the second user and in accordance with the determination that the second user is registered with computer system 1400, computer system 1400 displays one or more controls and/or indications that correspond to the second user within user interface 1402. For example, computer system 1400 can display a calendar and/or social media feed of the second user. In some examples, such controls and/or indications are automatically determined based on a current context (e.g., the second user has an upcoming meeting and so information about the upcoming meeting is displayed) and/or preconfigured by the second user.

At FIG. 14B, computer system 1400 detects first audio input 1418 from the second user. In this example, first audio input 1418 is in a first dialect (e.g., an English dialect) and corresponds to the second user telling the first user to pick a song while mentioning a name of the first user.

At FIG. 14B, in response to detecting first audio input 1418, computer system 1400 determines that first audio input 1418 is in a first dialect. At FIG. 14B, computer system 1400 detects the name “Kyle” within first audio input 1418. At FIG. 14B, in response to detecting the name “Kyle” and determining that the name of the second user is not Kyle while another user is in the environment, a determination is made that the name of the first user (e.g., the unknown user) is “Kyle.” At FIG. 14B, in response to the determination that the name of the first user is “Kyle,” a determination is made that the second user is talking to the first user and that first audio input 1418 corresponds to the second user telling the first user to pick a song. After FIG. 14B, in response to the determination that the second user is telling the first user to pick a song, computer system 1400 rotates the portion of computer system 1400 until the first user is within the field of detection of computer system 1400.

As illustrated in FIG. 14C, the first user is within the field of detection of computer system 1400 and the second user is not within the field of detection of computer system 1400 (e.g., as indicated by first user representation 1412 and not second user representation 1414 being within the dotted lines in diagram 1408). At FIG. 14C, computer system 1400 ceases to detect the second user within the field of detection of computer system 1400. As illustrated in FIG. 14C, in response to ceasing to detect the second user within the field of detection of computer system 1400, computer system 1400 ceases displaying known user indication 1416.

At FIG. 14C, computer system 1400 detects the first user within the field of detection of computer system 1400. As illustrated in FIG. 14C, in response to detecting the first user within the field of detection of computer system 1400 and in accordance with a determination that the name of the first user is “Kyle,” computer system 1400 displays new user indication 1424 at the top center of user interface 1402 (e.g., the same location as unknown user indication 1406). In some examples, the first user is within the field of detection of computer system 1400 while computer system 1400 is displaying unknown user indication 1406 when the determination is made that “Kyle” is the name of the first user.

In some examples, in response to the determination that “Kyle” is the name of the first user while computer system 1400 detects the first user within the field of detection of computer system 1400, computer system 1400 ceases displaying and/or does not display unknown user indication 1406 but instead displays new user indication 1424. In this example, new user indication 1424 includes the initials of the first user, and, because computer system 1400 only detected one name corresponding to the first user, only one initial is displayed (e.g., K for Kyle). In some examples, computer system 1400 detects more than one name (e.g., the full name (e.g., the first, middle, and/or last name)) corresponding to the first user, causing computer system 1400 to display more than one initial in new user indication 1424. In some examples, new user indication 1424 includes an image of the first user captured by computer system 1400 by one or more cameras connected to and/or in communication with computer system 1400. In some examples, computer system 1400 displays new user indication 1424 after stopping rotation. In some examples, computer system 1400 displays new user indication 1424 before stopping rotation. In some examples, after detecting the name of the first user, computer system 1400 continues the user registration process (e.g., continues adding detected information to the profile of the first user). In some examples, in response to continuing the user registration process, computer system 1400 continues to display the indication that computer system 1400 has initiated the user registration process.

In some examples, computer system 1400 links the name determined to be the name of the first user to a name (e.g., a contact entry) in a contact list of the second user and/or computer system 1400. In some examples, in response to linking the detected name to a name in the contact list, computer system 1400 identifies the first user as the contact entry. In some examples, computer system 1400 identifying the first user as the contact entry allows computer system 1400 to register the first user as the contact entry (e.g., changing the first user from an unknown user to a known user). In some examples, computer system 1400 identifies the first user through images captured by computer system 1400 via one or more cameras connected to and/or in communication with computer system 1400 and/or though information and/or images captured in previous encounters between computer system 1400 and the first user. In some examples, computer system 1400 uses multiple pieces of detected information to identify the first user, to register the first user with computer system 1400, and/or build a profile for the first user. In some examples, in response to detecting the first user within the environment, computer system 1400 greets and/or otherwise acknowledges the first user, asks the first user their name, and/or uses a response of the first user to identify the first user.

In some examples, computer system 1400 links the first user to a profile in another computer system. For example, in response to identifying the first user through biometric data (e.g., images captured via one or more cameras) and/or though detecting the first users name in audio input, computer system 1400 can associate an existing profile of the first user in another computer system and use that profile information to register the first user with computer system 1400. In some examples, in response to associating the first user to a profile in another computer system, computer system 1400 displays new user indication 1424 with content (e.g., text and/or an image) assigned within the profile of the first user in the other computer system.

In some examples, while no unknown user is in the environment, computer system 1400 detects an unknown name within an audio input. In some examples, in response to detecting an unknown name within an audio input while no unknown users are detected within the environment, computer system 1400 ignores the unknown name (e.g., does not register the unknown name with a user in the environment). For example, if computer system 1400 detects the name “Jacob” within a conversation between the first user and the second user, and computer system 1400 knows that the name of the first user is “Kyle” and the name of the second user is Julie, computer system 1400 can ignore the name “Jacob.”

In some examples, in response to computer system 1400 identifying the first user, the first user is registered as a guest (e.g., registered for a limited amount of time and/or with limited permissions). For example, when computer system 1400 identifies and registers the first user, computer system 1400 can accept commands from the first user only for entertainment applications and/or only for the time period of a month starting from the date of registration. In some examples, the level of registration (e.g., the amount of time registered and/or the amount of permissions) that the first user is registered at is based on the level of registration of the user that provided the identifying input. For example, if the second user (e.g., the user who spoke the first user's name) is a primary user of computer system 1400 (e.g., a user with a particular amount of permissions), computer system 1400 can register the first user with a higher level of registration (e.g., registered for more time and/or registered with more permissions) than if the second user was a standard user (e.g., a user with less amount of permissions than a primary user). In some examples, the level of registration depends on information detected within the input that included the identifying information, such as how the first user is introduced (e.g., titles given (e.g., friend, sister, brother, mother, father, boss, neighbor, employee, and/or coworker), how formal the conversation is (e.g., informal, semi-formal, and/or very formal), and/or the presence of words and/or phrases that indicate the type of relationship (e.g., I love you, let's be friends, you are my best friend, nice to meet you, and/or I hope I see you soon). For example, if computer system detects the phrase “Nice to meet you, Kevin” being spoken to the first user, computer system 1400 can identify the first user as “Kevin” and not register the first user or register the first user with less permissions until it is determined that “Kevin” will be around computer system 1400 more often. For another example, in some languages, users use different word choices depending on the level of formality of a situation, and computer system 1400 can choose what level to register the first user at based on the formality level of the detected words.

As illustrated in FIG. 14C, in response to detecting first audio input 1418 and/or in accordance with a determination that first audio input 1418 corresponds to the second user telling the first user to pick a song, computer system 1400 ceases displaying user interface 1402 and displays user interface 1420. In this example, user interface 1420 includes a prompt (e.g., a user interface element output by computer system 1400 (1) to represent a request for additional information so that computer system 1400 can perform a task related to first audio input 1418 and/or (2) designed to elicit action from a user and/or with an open-ended request for more information from the user). In some examples, user interface 1420 includes a list of songs for the first user to choose from. In this example, user interface 1420 includes first text 1422, which corresponds to computer system 1400 asking the first user what kind of music they would like to listen to (e.g., “would you like to listen to country or pop music?”). In some examples, computer system 1400 outputs audio content asking the first user what kind music they would like to listen to (e.g., computer system 1400 reads the text displayed within first text 1422).

As illustrated in FIG. 14C, in response to the determination that first audio input 1418 was in a first dialect (e.g., an English dialect), computer system 1400 outputs the first content in the first dialect. In this example, computer system 1400 outputting the first content in the first dialect includes computer system 1400 displaying first text 1422 in the first dialect. In some examples, computer system 1400 outputting the first content in the first dialect includes computer system 1400 outputting the first audio content in the first dialect. In some examples, in response to detecting that first audio input 1418 was spoken by the second user, computer system 1400 outputs the first content in a dialect that corresponds to the second user. For example, if the second user normally speaks in an English dialect, computer system 1400 can output the first context in that English dialect, and if the second user normally speaks in a Chinese dialect, computer system 1400 can output the first context in that Chinese dialect. In some examples, computer system displaying first text 1422 in the first dialect includes moving (e.g., scrolling) first text 1422 in a manner that corresponds with the first dialect. For example, if the first dialect is a Hebrew dialect, computer system 1400 can scroll first text 1422 from right to left, and if the first dialect is a Spanish dialect, computer system 1400 can scroll first text 1422 from left to right, and if the first dialect is a Mongolian dialect, computer system 1400 can scroll first text 1422 from top to bottom.

In some examples, computer system 1400 displays a virtual assistant avatar instead of and/or in addition to first text 1422 within user interface 1420. In some examples, in response to outputting the first content, computer system 1400 moves the virtual assistant avatar in a set of one or more movements coordinated with the first content (e.g., first text 1422 and/or the first audio content) output by computer system 1400 to give the appearance that the virtual assistant avatar is saying the content within the first content (e.g., that the virtual assistant avatar is asking the first user what kind of music they would like to listen to). In some examples, in response to outputting the first content in the first dialect, computer system 1400 moves the virtual assistant avatar in a manner corresponding to the first dialect and the interpretation of the content within the first content. For example, in response to outputting the first content in the first dialect and the first content being a question, computer system 1400 can move the virtual assistant avatar within user interface 1420 to be tilted with a slight smile as to appear inquisitive. For another example, in response to outputting the first content in the first dialect and the first content being a positive response, computer system 1400 can move the virtual assistant avatar up and down within communication user interface 1420 to give the appearance that the virtual assistance avatar is nodding. In some examples, in response to outputting the first content in the first dialect, computer system 1400 moves the virtual assistant avatar in a set of one or more movements coordinated with the first content as well as in a manner corresponding to the first dialect. For example, in response to outputting the first content in the first dialect and the first content corresponding to a positive response, computer system 1400 can move the virtual assistant avatar to appear to be speaking and nodding simultaneously.

In some examples, in response to outputting the first content, computer system 1400 moves a portion of computer system 1400 in a manner that is coordinated with the first content output (e.g., first text 1422 and/or first audio content) by computer system 1400. In some examples, moving a portion of computer system 1400 includes tilting, rotating, and/or moving a portion of computer system 1400 laterally. For example, in response to outputting the first content, computer system 1400 can move a portion of computer system 1400 in a manner that gives the appearance that computer system 1400 is talking and actively paying attention to the user (e.g., moving in a manner that resembles a conversational head nodding). In some examples, in response to outputting the first content in the first dialect, computer system 1400 moves a portion of computer system 1400 in a manner corresponding to the first dialect and the interpretation of the content within the first content. For example, in response to outputting the first content in the first dialect and the first content corresponding to computer system 1400 not knowing the answer, computer system 1400 can move a portion of computer system 1400 in up and down movements that resembles a shrug. For another example, in response to outputting the first content in a second dialect and the first content corresponds to computer system 1400 not knowing the answer, computer system 1400 can move a portion of computer system 1400 that resembles tilting a head from side to side.

In some examples, in response to outputting the first content, computer system 1400 moves the virtual assistant avatar and a portion of computer system 1400 in synchronous movements (e.g., same speed, same rhythm, and/or same direction (and/or directions)). For example, in response to outputting the first content in the first dialect and the first content being a greeting, computer system 1400 can move the virtual assistant avatar in sync with the first content output to give the appearance that the virtual assistant avatar is speaking while computer system 1400 moves the virtual assistant avatar up within user interface 1420 and computer system 1400 moves a portion of computer system 1400 in a backwards tilt that resembles an up-nod greeting (e.g., tilting the chin up in greeting). For another example, in response to outputting the first content in a third dialect and the first content being a greeting, computer system 1400 can move the virtual assistant avatar in sync with the first content output to give the appearance that the virtual assistant avatar is speaking while computer system 1400 moves the virtual assistant avatar to appear to be looking down and moving a portion of computer system 1400 down to give the appearance of a bow.

At FIG. 14C, computer system 1400 detects second audio input 1426 from the first user. In this example, second audio input 1426 is in a fourth dialect (e.g., a French dialect) and corresponds to the first user saying they want to listen to rap. At FIG. 14C, in response to detecting second audio input 1426, computer system 1400 determines that second audio input 1426 is in the fourth dialect. In some examples, in response to the determination that second audio input 1426 is in the fourth dialect, computer system 1400 ceases displaying the text within first text 1422 in the first dialect (e.g., the English dialect) and displays the text within first text 1422 in the fourth dialect (e.g., the French dialect). In some examples, in response to the determination that second audio input 1426 is in the fourth dialect, computer system 1400 ceases displaying the text within first text 1422 in the first dialect and displays the text within first text 1422 in the fourth dialect along with extra content to help facilitate the understanding of the information contained within the text. For example, if the fourth dialect does not have a direct translation for “country music,” computer system 1400 can provide extra content to help define “country music” for the first user. In some examples, in response to the determination that second audio input 1426 is in the fourth dialect, computer system 1400 does not cease displaying the text within first text 1422 in the first dialect to display the text within first text 1422 in the fourth dialect, and instead outputs the next content (e.g., the second content) in the fourth dialect, as described below.

As illustrated in FIG. 14D, in response to detecting second audio input 1426, computer system 1400 ceases outputting the first content and outputs second content. In this example, the second content is a prompt (e.g., a user interface element output by computer system 1400 to represent computer system 1400's readiness to perform the next command, designed to elicit action from a user, and/or with an open-ended request for more information from the user). In some examples, the second content is a list of songs for the first user to choose from. In this example, the second content includes displaying second text 1428, which corresponds to computer system 1400 asking the first user which rap song they want to listen to. In some examples, computer system 1400 outputting the second content includes computer system 1400 outputting a second audio content corresponding to computer system 1400 asking the first user which rap song they want to listen to (e.g., computer system 1400 reading the text within second text 1426). As illustrated in FIG. 14D, in response to the determination that second audio input 1426 is in the fourth dialect (e.g., a French dialect), computer system 1400 outputs the second content in the fourth dialect. In this example, computer system 1400 outputting the second content in the fourth dialect includes computer system 1400 displaying second text 1428 in the fourth dialect. In some examples, computer system 1400 outputting the second content in the fourth dialect includes computer system 1400 outputting the second audio content in the fourth dialect.

In some examples, computer system 1400 displays a virtual assistant avatar instead of and/or in addition to second text 1428 within user interface 1420. In some examples, in response to outputting the second content, computer system 1400 moves the virtual assistant avatar in a set of one or more movements coordinated with the second content output (e.g., second text 1428 and/or second audio content) by computer system 1400 to give the appearance that the virtual assistant avatar is saying the content within the second content (e.g., that the virtual assistant avatar is asking the first user what the first user wants to listen to). In some examples, in response to outputting the second content in the fourth dialect, computer system 1400 moves the virtual assistant avatar in a manner corresponding to the fourth dialect and the interpretation of the content within the second content. In some examples, content with similar interpretations in different dialects correspond to different sets of one or more movements. For example, in response to outputting the second content in the fourth dialect and the second content being a question, computer system 1400 can move the virtual assistant avatar to have raised eyebrows and a smile (e.g., a different set of one or more movements than for a question in the first dialect) to appear interested. In some examples, content with similar interpretations in different dialects correspond to the same set of one or more movements. For example, in response to outputting the second content in the fourth dialect and the second content being a positive response, computer system 1400 can move the virtual assistant avatar up and down within communication user interface 1420 to give the appearance that the virtual assistant avatar is nodding (e.g., the same set of one or more movements as for a positive response in the first dialect). In some examples, in response to outputting the second content in the fourth dialect, computer system 1400 moves the virtual assistant avatar in a set of one or more movements coordinated with the second content as well as in a manner corresponding to the fourth dialect. For example, in response to outputting the second content in the fourth dialect and the second content being a question, computer system 1400 can move the virtual assistant avatar to appear to be speaking and smiling simultaneously.

In some examples, in response to outputting the second content, computer system 1400 moves a portion of computer system 1400 in a manner that is coordinated with the second content (e.g., second text 1428 and/or second audio content) output by computer system 1400. For example, in response to outputting the second content, computer system 1400 can move a portion of computer system 1400 closer to the first user in a manner that gives the appearance that computer system 1400 wants the first user to notice computer system 1400. In some examples, in response to outputting the second content in the fourth dialect, computer system 1400 moves a portion of computer system 1400 in a manner corresponding to the fourth dialect and the interpretation of the content within the second content. For example, in response to outputting the second content in the fourth dialect and the second content corresponding to a negative response, computer system 1400 can move a portion of computer system 1400 in a set of movements that resembles a shaking head. For another example, in response to outputting the second content in a second dialect and the second content corresponding to a negative response, computer system 1400 does not move a portion of computer system 1400, because a negative response in the second dialect corresponds to not moving. In some examples, content with different interpretations in different dialects corresponds to the same set of one or more movements. For example, in response to outputting content in a third dialect that corresponds to a negative response, computer system 1400 can move the virtual assistant avatar up and down within communication user interface 1420 to give the appearance that the virtual assistant avatar is nodding (e.g., the same set of one or more movements as for a positive response in the first dialect) which corresponds to a negative response in the third dialect.

In some examples, in response to outputting the second content, computer system 1400 moves the virtual assistant avatar and a portion of computer system 1400 in synchronous movements (e.g., same speed, same rhythm, and/or same direction (and/or directions)). For example, in response to outputting the second content in the fourth dialect and the second content being an exclamation of joy, computer system 1400 can move the virtual assistant avatar in sync with the first content output to give the appearance that the virtual assistant avatar is speaking while computer system 1400 moves the virtual assistant avatar up and down within communication user interface 1420 and computer system 1400 moves a portion of computer system 1400 up and down giving the impression of jumping for joy. For another example, in response to outputting the second content in a third dialect and the second content being and exclamation of joy, computer system 1400 can move the virtual assistant avatar in sync with the second content output to give the appearance that the virtual assistant avatar is speaking while computer system 1400 moves the virtual assistant avatar to appear to have the eyes closed and computer system 1400 rotates a portion of computer system 1400 a full rotation to give the appearance of spinning with joy.

In some examples, the audio input that computer system 1400 detects does not include explicit indications of the set of one or more movements computer system 1400 is to perform. In some examples, the audio input that computer system 1400 detects does include explicit indications of the set of one or more movements computer system 1400 is to perform. For example, in response to detecting the phrase “I just got a promotion, dance with me!,” computer system 1400 can output congratulatory content (e.g., audio and/or video content) while moving a portion of computer system 1400 in manner resembling dancing. In this example, neither first audio input 1418 nor second audio input 1426 include an explicit indication of the language being spoken (e.g., audio input does not include an explicit request to output a specific dialect; audio input does not have a set of words that explicitly refer to the dialect). In some examples, the audio input does include an explicit indication of the language. For example, in response to detecting the phrase “Can we speak in Italian? I want to practice before my trip,” computer system 1400 can output content in an Italian dialect.

In some examples, second audio input 1426 is in the second dialect. In some examples, computer system 1400 determines that second audio input 1426 is in the second dialect. In some examples, in response to the detecting second audio input 1426 and the determination that second audio 1426 is in the second dialect, computer system 1400 displays second text 1428 and/or outputs a second audio content in the second dialect. In some examples, the second dialect is different than the first dialect and/or the fourth dialect. For example, the first dialect can be an English dialect heard commonly on the western coast of Canada, and the second dialect can be an Arabic dialect heard commonly in the city of Doha in Qatar. In some examples, the second dialect is similar to the first dialect and/or the fourth dialect. For example, the first dialect can be an English dialect commonly heard in the parts of New York State in the United States, and the second dialect can be an English dialect commonly heard in Manchester in England. In some examples, computer system 1400 determines that second audio input 1426 is in the first dialect. In some examples, in response to detecting second audio input 1426 and the determination that second audio 1426 is in a first dialect, computer system 1400 displays second text 1428 and/or outputs a second audio content in the first dialect (e.g., computer system 1400 does not change the language between first text 1422 in FIG. 14C and second text 1428 in FIG. 14D).

In some examples, computer system 1400 detects several audio inputs in several dialects. In some examples, computer system 1400 detects the fifth dialect more than other dialects (e.g., first dialect, second dialect, third dialect, and/or fourth dialect). In some examples, in response to detecting the fifth dialect more than other dialects, computer system 1400 outputs content (e.g., displays text, outputs audio, moves an avatar, and/or moves a portion of computer system 1400) in and/or corresponding to the fifth dialect. For example, if computer system 1400 is in an environment where a German dialect, a Dutch dialect, and a Swiss dialect are all detected, and computer system 1400 detects the Dutch dialect the most, computer system 1400 can output content in the Dutch dialect.

In some examples, in response to outputting a user non-specific notification (e.g., news alert, emergency broadcast, and/or certain application notifications), computer system 1400 can output the notification in the dialect most recently detected by computer system 1400. For example, if a Portuguese dialect is the dialect computer system 1400 most recently detected, in response to outputting an emergency alert, computer system 1400 can output the emergency alert in the Portuguese dialect even if the original notification is in a different dialect. In some examples, in response to outputting a user specific notification (e.g., text message, calendar notification, email notifications, and/or social media notifications), computer system 1400 can output the notification in the dialect that corresponds to that user. For example, in response to detecting a text message for the second user (e.g., Julie Allen), computer system 1400 can display the text message in the English dialect that corresponds to the second user even if the original text message is in a different dialect.

In some examples, at a time after displaying second text 1428, computer system 1400 outputs a third content (e.g., displays text, outputs audio, moves an avatar, and/or moves a portion of computer system 1400) in the same fourth dialect as second text 1428. In some examples, while outputting the second content, computer system 1400 detects a third audio input and determines the third audio input is in a sixth dialect. In some examples, in response to detecting a third audio input in a sixth dialect, computer system 1400 outputs a third content (e.g., displays text, outputs audio, moves an avatar, and/or moves a portion of computer system 1400) in the sixth dialect. In some examples, in response to outputting a third content in the sixth dialect, computer system 1400 moves a virtual assistant avatar via the display and a portion of computer system 1400 via one or more movement components in a manner corresponding to the content of the third content being output in the sixth dialect.

FIG. 15 is a flow diagram illustrating a method for automatically outputting in a specific dialect using a computer system in accordance with some embodiments. Process 1500 is performed at a computer system (e.g., 100, 200, and/or 1400). Some operations in process 1500 are, optionally, combined, the orders of some operations are, optionally, changed, and some operations are, optionally, omitted.

As described below, process 1500 provides an intuitive way for automatically outputting in a different dialect. The method reduces the cognitive burden on a user for interacting with a computer system, thereby creating a more efficient human-machine interface. For battery operated computing devices, enabling a user to interact with a computer system faster and more efficiently conserves power and increases the time between battery charges.

In some embodiments, process 1500 is performed at a computer system (e.g., 1400) that is in communication with one or more output devices (e.g., a speaker, a display screen, a projector, and/or a touch-sensitive display) and one or more input devices (e.g., a camera, a depth sensor, and/or a microphone). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is in communication with a movement component (e.g., an actuator (e.g., a pneumatic actuator, hydraulic actuator and/or an electric actuator), a movable base, a rotatable component, and/or a rotatable base).

In conjunction with (e.g., while, before (e.g., immediately before), and/or after (e.g., immediately after)) outputting, via the one or more output devices (e.g., as described above in FIGS. 14A-14D), a first portion of content (e.g., 1404, 1422, and/or 1428) (e.g., media content, video media, photo media, audio media, and/or written media) in a first dialect (e.g., as described above in FIGS. 14A-14D) (e.g., vernacular, accent, slang, regional speech, and/or a first language), the computer system detects (1502), via the one or more input devices (e.g., as described above in FIGS. 14A-14D), verbal input (e.g., 1418, and/or 1426) (e.g., one or more sounds, phrases, and/or words).

In response to detecting the verbal input (e.g., 1418, and/or 1426) and in accordance with a determination that the verbal input includes a second dialect (e.g., as described above in FIGS. 14A-14D) (e.g., vernacular, accent, slang, regional speech, and/or a second language) different from the first dialect (e.g., as described above in FIGS. 14A-14D), the computer system outputs (1504), via the one or more output devices, a second portion of content (e.g., 1422 and/or 1428) (e.g., media content, video media, photo media, audio media, and/or written media) in the second dialect, wherein the second portion of content is different from the first portion of content (e.g., 1404, 1422, and/or 1428). In some embodiments, the second portion of content is the same as the first portion of content. In some embodiments, outputting the second portion of content in the second dialect includes automatically (e.g., without additional input than the verbal input) outputting the second portion of content in the second dialect. Outputting the second portion of content in the second dialect in response to detecting the verbal input and in accordance with the determination that the verbal input includes the second dialect enables the computer system to output the second portion of content based on the dialect of the verbal input, thereby reducing the number of inputs needed to perform an operation, performing an operation when a set of conditions has been met without requiring further user input, and/or providing improved feedback to the user.

In some embodiments, the one or more output devices includes a first display component (e.g., a display screen, a projector, and/or a touch-sensitive display). In some embodiments, outputting, via the one or more output devices, the second portion of content (e.g., 1404, 1422, and/or 1428) in the second dialect (e.g., as described above in FIGS. 14A-14D) includes displaying, via the first display component, a representation (e.g., 1404, 1422, and/or 1428) of the second portion of content in the second dialect. In some embodiments, outputting the first portion of content in the first dialect includes displaying, via the first display component, a representation of the first portion of content in the first dialect. Displaying a representation of the second portion of content in the second dialect enables the computer system to visually represent content in the corresponding dialect, thereby reducing the number of inputs needed to perform an operation, performing an operation when a set of conditions has been met without requiring further user input, and/or providing improved visual feedback to the user.

In some embodiments, the one or more output devices includes an audio generation component (e.g., one or more speakers and/or components capable of generating (e.g., audible) audio output). In some embodiments, outputting, via the one or more output devices, the second portion of content (e.g., 1404, 1422, and/or 1428) in the second dialect includes outputting, via the audio generation component (e.g., as described above in FIGS. 14A-14D), the second portion of content in the second dialect. In some embodiments, outputting the first portion of content in the first dialect includes outputting, via the audio generation component, the first portion of content in the first dialect. Outputting, via the audio generation component, the second portion of content in the second dialect enables the computer system to verbally represent content in the corresponding dialect, thereby reducing the number of inputs needed to perform an operation, performing an operation when a set of conditions has been met without requiring further user input, and/or providing improved feedback to the user.

In some embodiments, before detecting the verbal output, the computer system detects an input (e.g., 1418, and/or 1426) (e.g., a verbal input, a written input, and/or a text input) corresponding to a prompt (e.g., as described above in FIGS. 14A-14D) (e.g., a system prompt, a written prompt, a verbal prompt, and/or a prompt to an artificial intelligence platform) of the computer system. In some embodiments, in response to detecting the input (e.g., 1418 and/or 1426) corresponding to the prompt of the computer system, in accordance with a determination that the prompt is a first prompt, the computer system selects (e.g., choosing, generating, constructing, receiving, detecting, and/or obtaining) a first set of content (e.g., 1404, 1422, and/or 1428) as the content (e.g., to be output and/or as the content). In some embodiments, in response to detecting the input corresponding to the prompt of the computer system, in accordance with a determination that the prompt is a second prompt different from the first prompt, the computer system selects a second set of content, different from the first set of content, as the content (e.g., to be output and/or as the content). In some embodiments, the computer system outputs at least a portion (e.g., the first set of content, the second set of content, the first portion of content, the second portion of content, and/or a subset of the content that the first set of content, the second set of content, the first portion of content, and/or the second portion of content) of the content. Selecting different sets of content to output depending on which prompt the input is directed to enables the computer system to customize what is output based on input detected, thereby reducing the number of inputs needed to perform the operation, performing an operation when a set of conditions has been met without requiring further user input, and/or providing improved feedback to the user.

In some embodiments, the one or more output devices includes a second display component (e.g., the same as and/or different from the first display component) (e.g., a display screen, a projector, and/or a touch-sensitive display). In some embodiments, outputting the first portion of content (e.g., 1404, 1422, and/or 1428) includes displaying, via the second display component, the first portion of content (e.g., a hand, a mouth, a portion of a representation of a human body, an avatar, and/or portion thereof) moving in a first manner (e.g., as described above in FIGS. 14A-14D) (e.g., a hand moving (e.g., to form a gesture and/or communicate a concept), and/or a mouth moving (e.g., to form a facial expression and/or cultural expression)). In some embodiments, displaying the first portion of content includes displaying a representation of a virtual assistant (e.g., an avatar) moving in the first manner (e.g., within a virtual assistant window and/or displaying a virtual assistant moving the content in the first manner). In some embodiments, outputting the second portion of content (e.g., 1404, 1422, and/or 1428) includes displaying, via the display component, the second portion of content moving in a second manner (e.g., as described above in FIGS. 14A-14D) different from the first manner (e.g., a hand moving (e.g., to form a gesture and/or communicate a concept), a mouth moving (e.g., to form a facial expression and/or cultural expression)). In some embodiments, the second portion of content includes displaying a representation of a virtual assistant moving the first portion of content in the second manner (e.g., within a virtual assistant window and/or displaying a virtual assistant moving the content in the first manner). In some embodiments, the second manner is the same as the first manner. In some embodiments, the second manner is the same as the first manner. In some embodiments, the first portion of content includes first text (e.g., typed text and/or handwriting). In some embodiments, the second portion of content includes second text (e.g., typed text and/or handwriting) (e.g., different from the first text). In some embodiments, displaying the first portion of content moving in the first manner includes displaying the first text in a first direction (e.g., left to right, right to left, and/or top to bottom). In some embodiments, displaying the second portion of content moving in the second manner includes displaying the second text in a second direction (e.g., left to right, right to left, and/or top to bottom) different from the first direction. In some embodiments, the first text is different from the second text. In some embodiments, the first dialect is a first language. In some embodiments, the second dialect is a second language different from the first language. In some embodiments, the first direction is determined based on a directional convention of the first language (e.g., the first language is written right to left, left to right, and/or in another direction). In some embodiments, the second direction is determined based on a directional convention of the second language (e.g., the second language is written right to left, left to right, and/or in another direction). Outputting the first portion of content in the first dialect including displaying the first portion of content moving in a first manner and outputting the second portion of content in the second dialect including displaying the second portion of content moving in a second manner enables the computer system to customize movement based on dialect, thereby reducing the number of inputs needed to perform the operation, performing an operation when a set of conditions has been met without requiring further user input, and/or providing improved visual feedback to the user.

In some embodiments, the verbal input (e.g., 1418, and/or 1426) does not include an explicit indication of (e.g., a name, discrete identification of, and/or a set of words that explicitly refer to) the second dialect (e.g., as described above in FIGS. 14A-14D). In some embodiments, not including the explicit indication includes not including an explicit request (e.g., a command and/or instruction) to output in the second dialect. Outputting the second portion of content in the second dialect in response to detecting the verbal input that does not include the explicit indication of the second dialect enables the computer system to output the portion of content in an appropriate dialect without being explicitly requested to do so, thereby providing additional control options without cluttering the user interface with additional displayed controls, performing an operation when a set of conditions has been met without requiring further user input, reducing the number of inputs needed to perform the operation, and/or providing improved feedback to the user.

In some embodiments, outputting, via the one or more output devices, the second portion of content (e.g., 1404, 1422, and/or 1428) in the second dialect includes outputting, via the one or more output devices, the first portion of content (e.g., 1404, 1422, and/or 1428) in the second dialect (e.g., the second portion of content is the same as and/or includes the first portion of content but is output in the second dialect). In some embodiments, the computer system changes (e.g., translates and/or receives a translation for) the first portion of content to the second portion of content. Outputting the second portion of content in the second dialect including outputting the first portion of content in the second dialect enables the computer system to output the first portion of content in an appropriate dialect included in (and in response to) verbal input, thereby reducing the number of inputs needed to perform the operation, providing additional control options without cluttering the user interface with additional displayed controls, performing an operation when a set of conditions has been met without requiring further user input, and/or providing improved feedback to the user.

In some embodiments, outputting the second portion of content (e.g., 1404, 1422, and/or 1428) includes outputting, via the one or more output devices, a third portion of content (e.g., 1404, 1422, and/or 1428) that is different from (e.g., not included in and/or was not previously output when outputting) the first portion of content. In some embodiments, the third portion of content is a new portion of content not included in the first portion of content. In some embodiments, the third portion of content is a different portion of content different from the first portion of content. Outputting the second portion of content in the second dialect including outputting the third portion of content that is different from the first portion of content enables the computer system to output different content based on a dialect included in verbal input, thereby reducing the number of inputs needed to perform the operation, providing additional control options without cluttering the user interface with additional displayed controls, performing an operation when a set of conditions has been met without requiring further user input, and/or providing improved feedback to the user.

In some embodiments, in response to detecting the verbal input (e.g., 1418, and/or 1426) and in accordance with a determination that the verbal input includes a third dialect different from the first dialect (e.g., as described above in FIGS. 14A-14D) and the second dialect, the computer system outputs, via the one or more output devices, a fourth portion of content (e.g., 1404, 1422, and/or 1428) in the third dialect. In some embodiments, the fourth portion of content is different from the first portion of content and/or the second portion of content. In some embodiments, the fourth portion of content is the same as the first portion of content and/or the second portion of content. Outputting the fourth portion of content in the third dialect in response to detecting the verbal input and in accordance with a determination that the verbal input includes a third dialect different from the first dialect and the second dialect enables the computer system to output a portion of content based on a dialect included in a verbal input, thereby reducing the number of inputs needed to perform the operation, providing additional control options without cluttering the user interface with additional displayed controls, performing an operation when a set of conditions has been met without requiring further user input, and/or providing improved feedback to the user.

In some embodiments, in response to detecting the verbal input (e.g., 1418, and/or 1426) and in accordance with a determination that the verbal input includes the first dialect, the computer system outputs, via the one or more output devices, the second portion of content (e.g., 1404, 1422, and/or 1428) in the first dialect (e.g., the first dialect is the same as the second dialect). Outputting the second portion of content in the first dialect in response to detecting the verbal input and in accordance with a determination that the verbal input includes the first dialect enables the computer system to output the portion of content based on the dialect of a response, thereby reducing the number of inputs needed to perform the operation, providing additional control options without cluttering the user interface with additional displayed controls, performing an operation when a set of conditions has been met without requiring further user input, and/or providing improved feedback to the user.

In some embodiments, in response to detecting the verbal input, in accordance with a determination that the verbal input (e.g., 1418, and/or 1426) includes a greater amount (e.g., a greater quantity of words and/or sounds) of a fourth dialect (e.g., as described above in FIGS. 14A-14D) than the second dialect (e.g., the verbal input includes a first portion of content in the fourth dialect and a second portion of content in the second content, where the first portion is more than the second portion), the computer system outputs, via the one or more output devices, the second portion of content (e.g., 1404, 1422, and/or 1428) in the fourth dialect, wherein the fourth dialect is different from the second dialect. In some embodiments, in response to detecting the verbal input, in accordance with a determination that the verbal input (e.g., 1418, and/or 1426) includes a greater amount of the second dialect than the fourth dialect, the computer system outputs, via the one or more output devices, the second portion of content (e.g., 1404, 1422, and/or 1428) in the second dialect. In some embodiments, the fourth dialect is different from the first dialect. In some embodiments, the fourth dialect is the same as the first dialect. In some embodiments, the verbal input includes the second dialect and the fourth dialect (e.g., and the dialect with the greatest amount is selected for outputting the second portion). In some embodiments, the verbal input includes the second dialect, the fourth dialect, and one or more additional dialects (e.g., and the dialect with the greatest amount is selected for outputting the second portion). In some embodiments, an amount of a dialect (e.g., for determining which is greater) can be determined based on one or more of: the duration of the verbal input that includes the dialect, a number and/or type of words in the dialect, a volume of the verbal input in the dialect, and/or other quantified measure of dialect usage in the verbal input. Outputting the second portion of content in the fourth dialect in accordance with the determination that the verbal input includes more content in a fourth dialect than content in the second dialect, and/or outputting the second portion of content in the second dialect in accordance with the determination that the verbal input includes more content in the second dialect than content in the fourth dialect enables the computer system to output content that is more predominant in the verbal input and enables multilingual inputs, thereby reducing the number of inputs needed to perform the operation, providing additional control options without cluttering the user interface with additional displayed controls, performing an operation when a set of conditions has been met without requiring further user input, and/or providing improved feedback to the user.

In some embodiments, after (e.g., subsequent to, immediately following, and/or sequentially in time with) outputting the second portion of content (e.g., 1404, 1422, and/or 1428) in the second dialect, the computer system outputs, via the one or more output devices, a fifth portion of content (e.g., 1404, 1422, and/or 1428) different from the second portion of content in the second dialect. In some embodiments, the fifth portion of content is a remainder of the content that includes the first portion of content and/or the second portion of content. Outputting the fifth portion of content different from the second portion of content in the second dialect after outputting the second portion of content in the second dialect enables the computer system to provide additional content thereby performing an operation when a set of conditions has been met without requiring further user input, and/or providing improved feedback to the user. Outputting content in first dialect moves content in first manner; outputting content in second dialect moves content in different manner.

In some embodiments, the computer system (e.g., 1400) is in communication with a movement component. In some embodiments, outputting the first portion of content (e.g., 1404, 1422, and/or 1428) includes moving, via the movement component, at least a portion (e.g., as described below in relation to process 1600) of the computer system (e.g., 1400) in a first pattern (e.g., as described above in FIGS. 14A-14D) (e.g., a manner of movement as described below in relation to process 1600). In some embodiments, outputting the second portion of content (e.g., 1404, 1422, and/or 1428) includes moving, via the movement component (e.g., as described above in FIGS. 14A-14D), in at least the portion of the computer system (e.g., 1400) second pattern (e.g., as described above in FIGS. 14A-14D) (e.g., a manner of movement as described below in relation to process 1600) different from the first pattern.

Note that details of the processes described above with respect to process 1500 (e.g., FIG. 15) are also applicable in an analogous manner to the methods described below/above. For example, process 1600 optionally includes one or more of the characteristics of the various methods described above with reference to process 1500. For example, the computer system can use one or more techniques of process 1500 to configure the computer system to perform a physical movement corresponding to a respective dialect in accordance with a determination that a voice input includes the respective dialect using one or more techniques of process 1600. For brevity, these details are not repeated below.

FIG. 16 is a flow diagram illustrating a method for moving a computer system corresponding to a respective dialect using a computer system in accordance with some embodiments. Process 1600 is performed at a computer system (e.g., 100, 200, 1400). Some operations in process 1600 are, optionally, combined, the orders of some operations are, optionally, changed, and some operations are, optionally, omitted.

As described below, process 1600 provides an intuitive way for moving a computer system corresponding to a respective dialect. The method reduces the cognitive burden on a user for interacting with a computer system, thereby creating a more efficient human-machine interface. For battery operated computing devices, enabling a user to interact with a computer system faster and more efficiently conserves power and increases the time between battery charges.

In some embodiments, process 1600 is performed at a computer system (e.g., 1400) that is in communication with a movement component (e.g., an actuator, a movable base, a rotatable component, and/or a rotatable base) and one or more input devices (e.g., as described above in FIGS. 14A-14D) (e.g., a camera, a depth sensor, and/or a microphone). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is in communication with a display component (e.g., as described above in FIGS. 14A-14D) (e.g., a display screen, a projector, and/or a touch-sensitive display).

The computer system detects (1602), via the one or more input devices, first voice input (e.g., 1418, and/or 1426) (e.g., a phrase, a sentence, a word, and/or a series of utterances).

In response to (1604) detecting the first voice input (e.g., 1418, and/or 1426), in accordance with a determination that the first voice input (e.g., 1418, and/or 1426) includes (and/or corresponds to) a first dialect (e.g., as described above in FIGS. 14A-14D), the computer system configures (1606) the computer system (e.g., 1400) to perform a first set of one or more physical movements (e.g., as described above in FIGS. 14A-14D) corresponding to the first dialect (e.g., one or more patterns of movements, lateral movement, tilting movement, and/or rotating movement) (e.g., movements made at a particular set of one or more speeds, with a particular set of one or more accelerations, and/or with a particular set of one or more directions).

In response to (1604) detecting the first voice input, in accordance with a determination that the first voice input (e.g., 1418, and/or 1426) includes (and/or corresponds to) a second dialect (e.g., as described above in FIGS. 14A-14D) different from the first dialect, the computer system configures (1608) the computer system (e.g., 1400) to perform a second set of one or more physical movements (e.g., as described above in FIGS. 14A-14D) (e.g., different from the first set of one or more physical movements) corresponding to the second dialect (e.g., without the computer system being configured to perform the second set of one or more physical movements).

After the computer system (e.g., 1400) is configured to perform the first set of one or more physical movements corresponding to the first dialect or the second set of one or more physical movements corresponding to the second dialect, the computer system provides (1610) output (e.g., 1422 and/or 1428) corresponding to (and/or in response to detecting, via the one or more input devices) a first phrase that has a respective interpretation (e.g., as described above in FIGS. 14A-14D), including (1612) in accordance with a determination that the computer system (e.g., 1400) is configured to perform the first set of one or more physical movements corresponding to the first dialect, moving (e.g., rotates, tilts, and/or moves laterally), via the movement component, a portion (e.g., a physical portion, a display component, a display, a center and/or particular portion of a display, and/or a hardware button) of the computer system in a first manner (e.g., as described above in FIGS. 14A-14D) (e.g., by a first amount, with a first pattern of movements, and/or in a first direction) and in accordance with (1614) a determination that the computer system (e.g., 1400) is configured to perform the second set of one or more physical movements corresponding to the second dialect, forgoing moving, via the movement component, the portion of the computer system in the first manner. In some embodiments, the computer system provides output via one or more output devices (e.g., a speaker, one or more haptic generation components, and/or a display component). In some embodiments, the output is provided in response to detecting the first voice input. Moving or not moving the portion of the computer system in the first manner when prescribed conditions are met allows the computer system to move according to a dialect to provide improved feedback to the user, thereby providing improved visual feedback to the user and performing an operation when a set of conditions has been met without requiring further user input.

In some embodiments, the first voice input (e.g., 1418, and/or 1426) does not include an explicit indication (e.g., name of dialect, country where dialect is spoken, name of person who speaks dialect, and/or a symbol of dialect) of (e.g., corresponding to and/or indicating) the first dialect (e.g., as described above in FIGS. 14A-14D). In some embodiments, the first voice input does not include an explicit indication (e.g., name of dialect, country where dialect is spoken, name of person who speaks dialect, and/or a symbol of dialect) of (e.g., corresponding to and/or indicating) the second dialect (e.g., as described above in FIGS. 14A-14D). Moving or not moving the portion of the computer system in the first manner when prescribed conditions are met allows the computer system to move according to a dialect to provide improved feedback to the user without the computer system being explicitly instructed to move according to the dialect, thereby providing improved visual feedback to the user, performing an operation when a set of conditions has been met without requiring further user input, and reducing the number of inputs needed to perform an operation.

In some embodiments, the first voice input (e.g., 1418, and/or 1426) does not include an explicit indication (e.g., instructions to move in a certain manner (e.g., shake, rotate, move right, left, up, and/or down)) (e.g., move like a fish and/or move like a turtle) of the first set of one or more movements (e.g., as described above in FIGS. 14A-14D) (and/or the first manner of movement). In some embodiments, the first voice input does not include an explicit indication (e.g., instructions to move in a certain manner (e.g., shake, rotate, move right, left, up, and/or down)) (e.g., move like a fish and/or move like a turtle) of the second set of one or more movements (e.g., as described above in FIGS. 14A-14D) (and/or the second manner of movement). Moving or not moving the portion of the computer system in the first manner when prescribed conditions are met allows the computer system to move according to a dialect to provide improved feedback to the user without the computer system being explicitly instructed to move a certain way, thereby providing improved visual feedback to the user, performing an operation when a set of conditions has been met without requiring further user input, and reducing the number of inputs needed to perform an operation.

In some embodiments, the computer system (e.g., 1400) is in communication with one or more speakers. In some embodiments, providing output corresponding to the first phrase that has the respective interpretation includes, in accordance with a determination that the computer system (e.g., 1400) is configured to perform the first set of one or more physical movements corresponding to the first dialect, outputting, via the one or more speakers, first audio (e.g., as described above in FIGS. 14A-14D) corresponding to the first phrase while moving, via the movement component, the portion of the computer system in the first manner; and in accordance with a determination that the computer system (e.g., 1400) is configured to perform the second set of one or more physical movements corresponding to the second dialect, second audio corresponding to the first phrase without moving, via the movement component, the portion of the computer system in the first manner (e.g., without outputting the first audio). In some embodiments, the first audio is the same as the second audio. In some embodiments, the first audio is different from the second audio. In some embodiments, the first audio is in the first dialect and the second audio is in the second dialect. In some embodiments, as a part of providing output corresponding to the first phrase that has the respective interpretation includes, in accordance with a determination that the computer system is configured to perform the first set of one or more physical movements corresponding to the first dialect, the computer system does not output, via the one or more speakers, the second audio. Outputting, via the one or more speakers, first audio corresponding to the first phrase while moving the portion of the computer system in the first manner allows the computer system to output audio (e.g., with a particular dialect) while moving (e.g., based on the particular dialect), thereby providing improved visual feedback to the user and performing an operation when a set of conditions has been met without requiring further user input.

In some embodiments, the computer system (e.g., 1400) is in communication with a display component. In some embodiments, providing output corresponding to the first phrase (e.g., one or more words and/or segments of the phrases) that has the respective interpretation (e.g., meaning and/or translation) includes, in accordance with a determination that the computer system (e.g., 1400) is configured to perform the first set of one or more physical movements corresponding to the first dialect, displaying, via the display component, a first indication of (e.g., name, symbol, representation, image, and/or video corresponding to) the first phrase while moving, via the movement component, the portion of the computer system in the first manner; and in accordance with a determination that the computer system (e.g., 1400) is configured to perform the second set of one or more physical movements corresponding to the second dialect, displaying, via the display component, a second indication of (e.g., name, symbol, representation, image, and/or video corresponding to) the first phrase without moving, via the movement component, the portion of the computer system in the first manner. In some embodiments, the first indication of the first phrase is the same as the second indication of the first phrase. In some embodiments, the first indication of the first phrase is different from the second indication of the first phrase. In some embodiments, the first indication of the first phrase is representative of the first dialect. In some embodiments, the second indication of the first phrase is representative of the second dialect. Displaying the first indication of the first phrases while moving the portion of the computer system in the first manner allows the computer system to display an indication (e.g., in a particular dialect) while moving (e.g., based on the particular dialect), thereby providing improved visual feedback to the user and performing an operation when a set of conditions has been met without requiring further user input.

In some embodiments, providing output (e.g., audio, visual, image, video, and/or haptic output) corresponding to the first phrase that has the respective interpretation includes, in accordance with a determination that the computer system (e.g., 1400) is configured to perform the second set of one or more physical movements corresponding to the second dialect, moving, via the movement component, the portion of the computer system in a second manner different from (e.g., with a second amount different from the amount of movement when moving in and/or with a second pattern of movement different from the pattern of movement when moving in, and/or with a second direction and/or set of one or more directions different from the direction and/or the set of one or more directions when moving in) the first manner (e.g., without moving in the first manner). Moving, via the movement component, the portion of the computer system in a second manner different from the first manner when prescribed conditions are met allows the computer system to move according to a dialect to provide improved feedback to the user, thereby providing improved visual feedback to the user and performing an operation when a set of conditions has been met without requiring further user input.

In some embodiments, in response to detecting the first voice input (e.g., 1418, and/or 1426) and in accordance with a determination that the first voice input includes (and/or corresponds to) a third dialect different from the first dialect and the second dialect, the computer system configures the computer system (e.g., 1400) to perform a third set of one or more physical movements (e.g., different from the first set of one or more physical movements) corresponding to the third dialect (e.g., without the computer system being configured to perform the second set of one or more physical movements). In some embodiments, after the computer system (e.g., 1400) is configured to perform the third set of one or more physical movements corresponding to the third dialect, the computer system provides output corresponding to the first phrase that has the respective interpretation, including: in accordance with a determination that the computer system (e.g., 1400) is configured to perform the third set of one or more physical movements corresponding to the third dialect, moves, via the movement component, the portion of the computer system in a third manner different from (e.g., with a third amount different from the amount of movement when moving the portion of the computer system in, with a third pattern of movement different from the pattern of movement when moving in, and/or with a third direction and/or set of one or more directions different from the direction and/or the set of one or more directions when moving in) the first manner.

In some embodiments, in accordance with a determination that the computer system (e.g., 1400) is configured to perform the first set of one or more physical movements corresponding to the first dialect and that the respective interpretation is a first interpretation, the computer system moves the portion of the computer system in a first set of one or more directions (e.g., right, left, up, down, clockwise, counterclockwise, and/or any combination thereof) while moving in the first manner. In some embodiments, in accordance with a determination that the computer system (e.g., 1400) is configured to perform the first set of one or more physical movements corresponding to the first dialect and that the respective interpretation is a second interpretation, different from the first interpretation, the computer system moves the portion of the computer system in a second set of one or more directions (e.g., right, left, up, down, clockwise, counterclockwise, and/or any combination thereof) (and, in some embodiments, does not move in the first pattern), different from the first set of one or more directions, while moving in the first manner. Moving the portion of the computer system in a particular set of one or more directions based on whether an interpretation of the input has a certain interpretation allows the computer system to move differently based on the interpretation of a phrase, thereby providing improved visual feedback to the user and performing an operation when a set of conditions has been met without requiring further user input.

In some embodiments, after providing output corresponding to the first phrase that has the respective interpretation, the computer system provides output corresponding to a second phrase, different from the first phrase, that has the respective interpretation, including: in accordance with a determination that the computer system (e.g., 1400) is configured to perform the first set of one or more physical movements corresponding to the first dialect, moves, via the movement component, the portion of the computer system in the first manner; and in accordance with a determination that the computer system (e.g., 1400) is configured to perform the second set of one or more physical movements corresponding to the second dialect, moves, via the movement component, the portion of the computer system in a fourth manner, different from (e.g., with a fourth amount different from the amount of movement when moving in, with a fourth pattern of movement different from the pattern of movement when moving in, and/or with a fourth direction and/or set of one or more directions different from the direction and/or the set of one or more directions when moving in) the first manner, without moving, via the movement component, the portion of the computer system in the first manner. Moving the portion of the computer system in different manners when the interpretation of a phrase is the same allows the computer system to move differently based on the interpretation of a phrase, thereby providing improved visual feedback to the user and performing an operation when a set of conditions has been met without requiring further user input.

In some embodiments, after providing output corresponding to the first phrase that has the respective interpretation, the computer system provides output corresponding to a third phrase different from the first phrase, that has the respective interpretation, including, in accordance with a determination that the computer system (e.g., 1400) is configured to perform the first set of one or more physical movements corresponding to the first dialect, moves, via the movement component, the portion of the computer system in the first manner; and in accordance with a determination that the computer system (e.g., 1400) is configured to perform the second set of one or more physical movements corresponding to the second dialect, forgoes moving, via the movement component, the portion of the computer system in the first manner.

In some embodiments, after the computer system (e.g., 1400) is configured to perform the first set of one or more physical movements corresponding to the first dialect or the second set of one or more physical movements corresponding to the second dialect, the computer system provides output corresponding to the first phrase that has the respective interpretation, including, in accordance with a determination that the computer system (e.g., 1400) is configured to perform the second set of one or more physical movements corresponding to the second dialect, forgoing moving, via the movement component, the portion of the computer system (and, in some embodiments, in any manner) (e.g., while providing output corresponding to the first phrase that has the respective interpretation). Not moving the portion of the computer system when prescribed conditions are met allows the computer system to move according to a dialect to provide improved feedback to the user, thereby providing improved visual feedback to the user and performing an operation when a set of conditions has been met without requiring further user input.

In some embodiments, in response to detecting the first voice input (e.g., 1418, and/or 1426) and in accordance with a determination that the first voice input includes (and/or corresponds to) a fourth dialect different from the first dialect and the second dialect, the computer system configures the computer system (e.g., 1400) to perform a fourth set of one or more physical movements (e.g., different from the first set of one or more physical movements) corresponding to the fourth dialect (e.g., without the computer system being configured to perform the second set of one or more physical movements). In some embodiments, after the computer system (e.g., 1400) is configured to perform the fourth set of one or more physical movements corresponding to the fourth dialect, the computer system provides output corresponding to the first phrase that has the respective interpretation, including, in accordance with a determination that the computer system (e.g., 1400) is configured to perform the fourth set of one or more physical movements corresponding to the fourth dialect, moves, via the movement component, the portion of the computer system in the first manner.

In some embodiments, after providing output corresponding to the first phrase that has the respective interpretation, the computer system provides output corresponding to a fourth phrase, different from the first phrase, that has a third interpretation that is different from the respective interpretation, including, in accordance with a determination that the computer system (e.g., 1400) is configured to perform the first set of one or more physical movements corresponding to the first dialect, moves, via the movement component, the portion of the computer system in a fifth manner different from (e.g., with a fifth amount different from the amount of movement when moving the portion of the computer system in the fifth manner, with a fifth pattern of movement different from the pattern of movement when moving the portion of the computer system in the fifth manner, and/or with a fifth direction and/or set of one or more directions different from the direction and/or the set of one or more directions when moving in the fifth manner) the first manner; and in accordance with a determination that the computer system (e.g., 1400) is configured to perform the second set of one or more physical movements corresponding to the second dialect, forgoes moving, via the movement component, the portion of the computer system in the fifth manner.

In some embodiments, after providing output corresponding to the first phrase that has the respective interpretation, the computer system provides output corresponding to a fifth phrase, different from the first phrase, that has a fourth interpretation that is different from the respective interpretation, including: in accordance with a determination that the computer system is configured to perform the first set of one or more physical movements corresponding to the first dialect, forgoes moving, via the movement component, the portion of the computer system (e.g., 1400) in a sixth manner different from (e.g., with a sixth amount different from the amount of movement when moving the portion of the computer system in, with a sixth pattern of movement different from the pattern of movement when moving the portion of the computer system in, and/or with a sixth direction and/or set of one or more directions different from the direction and/or the set of one or more directions when moving in) the first manner; and in accordance with a determination that the computer system (e.g., 1400) is configured to perform the second set of one or more physical movements corresponding to the second dialect, moves, via the movement component, the portion of the computer system in the sixth manner.

In some embodiments, after providing output corresponding to the first phrase that has the respective interpretation, the computer system provides output corresponding to a sixth phrase, different from the first phrase, that has a fifth interpretation that is different from the respective interpretation, including, in accordance with a determination that the computer system (e.g., 1400) is configured to perform the first set of one or more physical movements corresponding to the first dialect, moves, via the movement component, the portion of the computer system in a seventh manner different from (e.g., with a seventh amount different from the amount of movement when moving the portion of the computer system in, with a seventh pattern of movement different from the pattern of movement when moving the portion of the computer system in, and/or with a seventh direction and/or set of one or more directions different from the direction and/or the set of one or more directions when moving in) the first manner; and in accordance with a determination that the computer system (e.g., 1400) is configured to perform the second set of one or more physical movements corresponding to the second dialect, moves, via the movement component, the portion of the computer system in an eighth manner different from (e.g., with an eighth amount different from the amount of movement when moving the portion of the computer system in, with a eighth pattern of movement different from the pattern of movement when moving the portion of the computer system in, and/or with a eighth direction and/or set of one or more directions different from the direction and/or the set of one or more directions when moving in) the seventh manner and the first manner.

In some embodiments, after providing output corresponding to the first phrase that has the respective interpretation, the computer system detects second voice input (e.g., 1418, and/or 1426) (e.g., a verbal input, an audible request, an audible command, and/or an audible statement) different from the first voice input (e.g., 1418 and/or 1426). In some embodiments, in response to detecting the second voice input (e.g., 1418 and/or 1426), the computer system configures the computer system (e.g., 1400) to perform a fifth set of one or more movements. In some embodiments, after the computer system (e.g., 1400) is configured to perform the fifth set of one or more movements, the computer system provides output corresponding to a seventh phrase that has a fourth interpretation including moving the portion of the computer system in a ninth manner (e.g., with an ninth amount different from the amount of movement when moving the portion of the computer system in, with a ninth pattern of movement different from the pattern of movement when moving the portion of the computer system in, and/or with a ninth direction and/or set of one or more directions different from the direction and/or the set of one or more directions when moving in) different from the first manner.

In some embodiments, while providing output corresponding to (and/or in response to detecting, via the one or more input devices) the first phrase that has a respective interpretation (and, in some embodiments, while moving in the first manner), the computer system detects a condition (e.g., a different voice input and/or another condition to change dialect movements). In some embodiments, in response to detecting the condition, the computer system configures the computer system (e.g., 1400) to perform a sixth set of one or more movements that is different from the first set of one or more movements and the second set of one or more movements. Configuring the computer system to perform a sixth set of one or more movements in response to detecting the condition allows the computer system to intelligently change how the computer system will move when providing output, thereby providing improved visual feedback to the user and performing an operation when a set of conditions has been met without requiring further user input.

In some embodiments, moving the portion of the computer system (e.g., 1400) in the first manner includes tilting, via the movement component, the portion of the computer system from a first tilt position to a second tilt position. Tilting or not tilting the portion of the computer system in the first manner when prescribed conditions are met allows the computer system to move according to a dialect to provide improved feedback to the user, thereby providing improved visual feedback to the user and performing an operation when a set of conditions has been met without requiring further user input.

In some embodiments, moving the portion of the computer system (e.g., 1400) in the first manner includes translating (e.g., moving laterally, moving horizontally, and/or moving vertically), via the movement component, the portion of the computer system from a first lateral position to a second lateral position (e.g., different from the first lateral position). Laterally moving or not laterally moving the portion of the computer system in the first manner when prescribed conditions are met allows the computer system to move according to a dialect to provide improved feedback to the user, thereby providing improved visual feedback to the user and performing an operation when a set of conditions has been met without requiring further user input.

In some embodiments, moving the portion of the computer system (e.g., 1400) in the first manner includes rotating, via the movement component, the portion of the computer system from a first rotational position to a second rotational position (e.g., different from the first rotational position). Rotating or not rotating the portion of the computer system in the first manner when prescribed conditions are met allows the computer system to move according to a dialect to provide improved feedback to the user, thereby providing improved visual feedback to the user and performing an operation when a set of conditions has been met without requiring further user input.

Note that details of the processes described above with respect to process 1600 (e.g., FIG. 16) are also applicable in an analogous manner to the methods described below/above. For example, process 1500 optionally includes one or more of the characteristics of the various methods described above with reference to process 1600. For example, the computer system can use one or more techniques of process 1600 to output a portion of content in a respective dialect in response to detecting verbal input in a different dialect using one or more techniques of process 1500. For brevity, these details are not repeated below.

FIG. 17 is a flow diagram illustrating a method for initiating a process to add unknown users using a computer system in accordance with some embodiments. Process 1700 is performed at a computer system (e.g., 100, 200, and/or 1400). Some operations in process 1700 are, optionally, combined, the orders of some operations are, optionally, changed, and some operations are, optionally, omitted.

As described below, process 1700 provides an intuitive way for initiating a process to add unknown users. The method reduces the cognitive burden on a user for initiating a process to add unknown users, thereby creating a more efficient human-machine interface. For battery operated computing devices, enabling a user to initiate a process to add unknown users faster and more efficiently conserves power and increases the time between battery charges.

In some embodiments, process 1700 is performed at a computer system (e.g., 1400). In some embodiments, the computer system is in communication with a movement component (e.g., an actuator, a motor, an electronic arm, a lift, and/or a lever). In some embodiments, the computer system is in communication with one or more output devices (e.g., a speaker, a haptic output device, a display screen, a projector, and/or a touch-sensitive display) including a display component (e.g., as described above in FIGS. 14A-14D) (e.g., a display screen, a projector, and/or a touch-sensitive display) and one or more cameras (e.g., a telephoto, wide angle, and/or ultra-wide angle camera). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is in communication with one or more input devices (e.g., a touch-sensitive display, a rotatable input mechanism, a camera (e.g., a telephoto, wide angle, and/or ultra-wide-angle camera), and/or a sensor (e.g., a gyroscope and/or a heart rate sensor)). In some embodiments, the computer system is in communication with a movement component (e.g., an actuator, a motor, an electronic arm, a lift, and/or a lever).

The computer system detects (1702), from a first user (e.g., 1412 and/or 1414) (e.g., person, animal, and/or user) (e.g., in an environment (e.g., including the computer system)), an input (e.g., 1418, and/or 1426) (e.g., a verbal input (e.g., a verbal input, an audible request, an audible command, and/or an audible statement) and/or a non-verbal input (e.g., a swipe input, a hold-and-drag input, a gaze input, an air gesture, and/or a mouse click)) that includes an indication of a second user (e.g., 1412 and/or 1414), different from the first user.

In response to (1704) detecting the input (e.g., 1418) that includes the indication of the second user (e.g., 1412 and/or 1414), in accordance with a determination that an unknown user (e.g., 1412) is detected in the environment (e.g., 1408) (e.g., while, after, and/or before detecting the input that includes the indication of the second user), the computer system initiates (1706) a process to add the unknown user (e.g., 1412 and/or 1414) as the second user (e.g., 1412 and/or 1414) (and/or adding the unknown user as the second user).

In response to (1704) detecting the input that includes the indication of the second user, in accordance with a determination that the unknown user (e.g., 1412 and/or 1414) is not detected in the environment (e.g., 1408), the computer system forgoes (1708) initiating the process to add the unknown user as the second user (e.g., 1412 and/or 1414) (and/or forgoing adding the unknown user as the second user). Choosing whether or not to initiate a process to add the unknown user as the second user when prescribed conditions are met allows the computer system to start the process to add the unknown user when the user is detected in the environment, thereby performing an operation when a set of conditions has been met without requiring further user input and increasing security.

In some embodiments, the computer system (e.g., 1400) is in communication with a display component. In some embodiments, before detecting the input (e.g., 1418) that includes the indication of the second user, the computer system displays, via the display component (e.g., as described in FIGS. 14A-14D), an indication (e.g., text, an image, a video, and/or a representation, such as a user interface object) (e.g., 1406) that the unknown user (e.g., 1412) is detected in the environment (e.g., 1408) (e.g., in accordance with a determination that an unknown user is detected in the environment). Displaying the indication that the unknown user is detected in the environment allows the computer system to provide feedback to the user that a user has not been registered with the computer system and reduces the number of inputs needed for the user to determine whether the unknown user has been registered or not, thereby providing improved visual feedback to the user, reducing the number of inputs needed to perform an operation, and increasing security.

In some embodiments, in response to detecting the input (e.g., 1418) that includes the indication of the second user (e.g., 1412) (e.g., and in accordance with a determination that the unknown user is detected in the environment), the computer system ceases to display the indication that the unknown user (e.g., 1412) is detected in the environment (e.g., 1408) (e.g., as illustrated in FIG. 14C). In some embodiments, in response to detecting the input that includes the indication of the second user and in accordance with a determination that the unknown user is detected in the environment, the computer system does not display the indication. Ceasing to display the indication that the unknown user is detected in the environment in response to detecting the input that includes the indication of the second user allows the computer system to intelligently stop displaying the indication that the unknown user is detected in the environment when it is no longer detected and preserves display real estate, thereby providing improved visual feedback to the user and reducing the number of inputs needed to perform an operation.

In some embodiments, in response to detecting the input (e.g., 1418) that includes the indication of the second user (e.g., 1412) (e.g., and/or in accordance with a determination that the unknown user is detected in the environment) (e.g., and/or in accordance with a determination that the process to add was successful), the computer system ceases to display the indication that the unknown user is detected in the environment (e.g., 1408). In some embodiments, in response to detecting the input that includes the indication of the second user, the computer system displays, via the display component (e.g., as described in FIGS. 14A-14D), an indication (e.g., text, an image, a video, an avatar, and/or a representation, such as a user interface object) (e.g., 1424) corresponding to the second user (e.g., 1412) (e.g., that was not previously displayed) (e.g., that is different from the indication that the unknown user is detected in the environment). In some embodiments, the computer system replaces display of the indication that the unknown user is detected in the environment with the indication corresponding to the second user. Ceasing to display the indication that the unknown user is detected in the environment and displaying the indication corresponding to the second user in response to detecting the input that includes the indication of the second user allows the computer system to intelligently provide feedback that the second user has been added and that the unknown user is no longer an unknown user, thereby providing improved visual feedback to the user and reducing the number of inputs needed to perform an operation.

In some embodiments, the indication corresponding to the second user includes an avatar (e.g., as described in FIGS. 14A-14D) (e.g., having the name of and/or one or more appearance characteristics (e.g., mouth, hands, noise, eyes, feet, torso, skin color, hair, eye color, and/or freckles) corresponding to and/or one or more appearance characteristics previously set (e.g., by the second user and/or another user or device) to correspond to the second user) (e.g., including an identification and/or an identifier of the second user) (e.g., of the second user). Ceasing to display the indication that the unknown user is detected in the environment and displaying an avatar in response to detecting the input that includes the indication of the second user allows the computer system to intelligently provide feedback that the second user (e.g., via the avatar) has been added and that the unknown user is no longer an unknown user, thereby providing improved visual feedback to the user and reducing the number of inputs needed to perform an operation.

In some embodiments, the avatar is identified based on the input (e.g., 1418) that includes the indication of the second user (e.g., 1412). In some embodiments, the avatar is identified by matching a known voice profile to the input (e.g., when the input is voice input).

In some embodiments, the computer system (e.g., 1400) is in communication with one or more cameras (e.g., as described above in FIGS. 14A-14D). In some embodiments, the avatar is identified based on one or more images captured by the one or more cameras. In some embodiments, the avatar is identified by matching a known image for a user to the one or more images.

In some embodiments, the avatar (e.g., as described above in FIGS. 14A-14D) is identified based on known data corresponding to the second user (e.g., 1412 and/or 1414) (e.g., a profile associated with the second user that the computer system understands after the second user has been identified) (e.g., automatically associating the unknown user with a known identifier). In some embodiments, the computer system displays one or more portions of the data corresponding to the second user, such as the second user's name. In some embodiments, the computer system outputs audio that includes the one or more portions of the data corresponding to the second user.

In some embodiments, initiating a process to add the unknown user (e.g., 1412 and/or 1414) as the second user (e.g., 1412 and/or 1414) includes displaying an indication (e.g., text, an image, a video, an avatar, and/or a representation, such as a user interface object) that the process to add the unknown user as the second user has been initiated (e.g., as described with respect to FIGS. 14B-14C). Displaying an indication that the process to add the unknown user as the second user has been initiated as a part of initiating a process to add the unknown user as the second user allows the computer system to provide feedback to the user without requiring additional input, thereby providing improved visual feedback to the user, reducing the number of inputs needed to perform an operation, and increasing security.

In some embodiments, initiating the process to add the unknown user (e.g., 1412) as the second user (e.g., 1412) includes registering (e.g., recording, storing, keeping, taking, and/or memorializing) the second user as a guest. In some embodiments, a guest is able to use less functionality of the computer system than a non-guest. In some embodiments, a guest is not recognized by the computer system after a predefined period of time (e.g., after no longer detecting the guest and/or 1-7 days). In some embodiments, a guest has a set of one or more privileges that is different from a set of one or more privileges that a non-guest has. Registering the second user as a guest as a part of initiating a process to add the unknown user as the second user allows the computer system to intelligently register the second user as the guest, thereby providing improved visual feedback to the user, reducing the number of inputs needed to perform an operation, and increasing security.

In some embodiments, initiating the process to add the unknown user as the second user includes, in accordance with a determination that the input (e.g., 1418) that includes the indication of the second user (e.g., 1412) corresponds to a first set of one or more privileges (e.g., as described above in FIGS. 14A-14D), providing the second user with a second set of one or more privileges (e.g., same as or different from the first set of one or more privileges) and in accordance with a determination that the input that includes the indication of the second user corresponds to a third set of one or more privileges, different from the first set of one or more privileges, providing the second user with a fourth set of one or more privileges (e.g., same as or different from the third set of one or more privileges) different from the second set of one or more privileges. In some embodiments, as a part of initiating the process to add the unknown user as the second user includes, in accordance with a determination that the input that includes the indication of the second user corresponds to a first set of one or more privileges, the computer system does not provide the second user with the fourth set of one or more privileges. In some embodiments, as a part of initiating the process to add the unknown user as the second user, in accordance with a determination that the input that includes the indication of the second user corresponds to the third set of one or more privileges, different from the first set of one or more privileges, the computer system does not provide the second user with the second set of one or more privileges. In some embodiments, as a part of initiating the process to add the unknown user as the second user, in accordance with a determination that the input that includes the indication of the second user corresponds to the third set of one or more privileges, different from the first set of one or more privileges, the computer system provides the second user with the second set of one or more privileges. In some embodiments, the second set of one or more privileges are a part of and/or included in the fourth set of one or more privileges. In some embodiments, the fourth set of one or more privileges are not a part of and/or included in the second set of one or more privileges. Providing the second user with a different set of conditions when prescribed conditions are met as a part of initiating a process to add the unknown user as the second user allows the computer system to register the second user with a certain set of privileges based on an input, thereby providing improved visual feedback to the user, reducing the number of inputs needed to perform an operation, and increasing security.

In some embodiments, initiating the process to add the unknown user as the second user includes, in accordance with a determination that the first user has a fifth set of one or more privileges, providing the second user with a sixth set of one or more privileges (e.g., the same as or different from the fifth set of one or more privileges) and in accordance with a determination that the first user has a set of one or more privileges that is less than the fifth set of one or more privileges, providing the second user with a set of one or more privileges that is less than the sixth set of one or more privileges (e.g., the same as or different from the set of one or more privileges that is less than the fifth set of one or more privileges). In some embodiments, as a part of initiating the process to add the unknown user as the second user, in accordance with a determination that a primary user provided input, the computer system provides the second user with a first respective set of one or more privileges. In some embodiments, as a part of initiating the process to add the unknown user as the second user includes, in accordance with a determination that a secondary user (e.g., a guest user and/or a user who is not a primary user) provided input, the computer system provides the second user with an second respective set of one or more privileges that is less than the first respective set of one or more privileges. Providing the second user with a different set of conditions when prescribed conditions are met as a part of initiating a process to add the unknown user as the second user allows the computer system to register the second user with a certain set of privileges based on who provided the input, thereby providing improved visual feedback to the user, reducing the number of inputs needed to perform an operation, and increasing security.

In some embodiments, initiating the process to add the unknown user as the second user includes, in accordance with a determination that the input that includes the indication of the second user has a first type of content, providing the second user with a seventh set of one or more privileges (e.g., same as or different from the first set of one or more privileges), and in accordance with a determination that the input that includes the indication of the second user has a second type of content, different from the first type of content, providing the second user with an eighth set of one or more privileges different from the seventh set of one or more privileges. In some embodiments, the second user is provided with a set of one or more privileges based on what was said. In some embodiments, a verbal input that includes “meet my friend” leads to the second user being provided with a set of one or more friend privileges. In some embodiments, a verbal input that includes “meet my guest” leads to the second user being provided with a set of one or more guest privileges. In some embodiments, a verbal input that includes “meet my family member” leads to the second user being provided with a set one or more different privileges than a verbal input that includes “meet my partner” and/or a verbal input that includes “meet my child.” Providing the second user with a different set of conditions when prescribed conditions are met as a part of initiating a process to add the unknown user as the second user allows the computer system to register the second user with a certain set of privileges based on the content of the input, thereby providing improved visual feedback to the user, reducing the number of inputs needed to perform an operation, and increasing security.

Note that details of the processes described above with respect to process 1700 (e.g., FIG. 17) are also applicable in an analogous manner to the methods described below/above. For example, process 1600 optionally includes one or more of the characteristics of the various methods described above with reference to process 1700. For example, the computer system can use one or more techniques of process 1700 to configure the computer system to perform a physical movement corresponding to a respective dialect in accordance with a determination that a voice input includes the respective dialect using one or more techniques of process 1600. For brevity, these details are not repeated below.

The description above has been described with reference to specific examples for the purpose of explanation. Such specific examples can be in the form of textual description above and/or in the accompanying drawings. However, such embodiments should not be interpreted as being exhaustive and/or limiting to the disclosure (e.g., limiting to the explicit manners described herein). Many modifications and variations are possible in view of the above teachings by one of ordinary skill in the art without departing from the scope of the present disclosure.

Aspects of the technology described above can include gathering and/or using data from various sources. Such data can include demographic data, telephone numbers, email addresses, location and/or location-related data, home addresses, work addresses, and/or any other identifying information. In some scenarios, such data can include personal information that is usable to uniquely identify a specific person. Such data can be used to improve interactions that a device has with its environment (e.g., interactions with users). The use of such data can require one or more entities handling such data. These entities can be involved in collecting, processing, disclosing, transferring, storing, or other functions that support the technologies described herein. The present disclosure expects that (e.g., does not preclude) that all use of such data complies with well-established privacy policies and/or privacy practices by such entities. As a general matter, such policies and practices should meet or exceed generally recognized industry standards and comply with all applicable data privacy and security-related governmental requirements. In particular, for example, entities should receive informed consent from users to collect and/or use such data, and such collection and/or use should only be for legitimate and reasonable uses. Further, such data should not be shared, disclosed, sold, and/or provided for uses other than legitimate and/or reasonable uses. Various scenarios can arise in which such data is not available, such as when a user selects not to share such data. For example, the user can withhold consent for collection and/or use of such data (e.g., “opt out” of sharing such data and/or not explicitly “opt in” during a registration process). The user can also employ the use of any of various hardware and/or software components that prevent collection and/or use of such data. While the use of such data can benefit a user by improving the operation of the device, the present disclosure contemplates that embodiments of the present technology can be used without such data. For example, operations of the device can use other data (e.g., instead of and/or in place of such data). Other techniques include making inferences based on other data or a minimal amount of such data. The use of such data can be utilized for the benefit of users of the device. For example, such data can be used to improve interactions that the device engages in with the user. Other benefits from the use for such data are also possible and within the scope of the present disclosure.

What is claimed is:

1. A method, comprising:
at a computer system that is in communication with a movement component and one or more input devices:
detecting, via the one or more input devices, a first event;
in response to detecting the first event:
in accordance with a determination that a first set of one or more criteria is satisfied, wherein the first set of one or more criteria includes a criterion that is satisfied when a portion of a user is not within a first predefined distance from the computer system, moving, via the movement component, a portion of the computer system; and
in accordance with a determination that a second set of one or more criteria is satisfied, wherein the second set of one or more criteria includes a criterion that is satisfied when the portion of the user is within the first predefined distance from the computer system, forgoing moving, via the movement component, the portion of the computer system;
while moving, via the movement component, the portion of the computer system, detecting that the second set of one or more criteria is satisfied; and
in response to detecting the second set of one or more criteria is satisfied while moving the portion of the computer system, ceasing moving, via the movement component, the portion of the computer system.

2. The method of claim 1, wherein:
in accordance with a determination that the first event is a first type of event, moving the portion of the computer system includes repositioning, via the movement component, the portion of the computer system in a first manner; and
in accordance with a determination that the first event is a second type of event different from the first type of event, moving the portion of the computer system includes repositioning, via the movement component, the portion of the computer system in a second manner different from the first manner.

3. The method of claim 1, wherein the first event corresponds to movement of the user.

4. The method of claim 1, wherein the first event corresponds to an action that is performed by the user.

5. The method of claim 1, wherein the user is a person.

6. The method of claim 1, further comprising:
while moving, via the movement component, the portion of the computer system and in accordance with a determination that the user is within a second predefined distance from the computer system and that the user is moving towards the computer system, ceasing moving, via the movement component, the portion of the computer system.

7. The method of claim 1, wherein the computer system is in communication with a first display component, the method further comprising:
in response to detecting that the second set of one or more criteria is satisfied, displaying, via the first display component, an indication a textual indication.

8. The method of claim 1, wherein the computer system is in communication with a second display component, the method further comprising:
before detecting the first event, displaying, via the second display component, a first set of one or more user interface elements at a first size; and
in response to detecting that the second set of one or more criteria is satisfied, increasing the size of the first set of one or more user interface elements from the first size to a second size different from the first size.

9. The method of claim 1, wherein the computer system displays a second set of one or more user interface elements while the portion of computer system is moved, the method further comprising:
while moving the portion of the computer system and in accordance with a determination that the user is within a third predefined distance from the computer system, increasing the size of the second set of one or more user interface elements.

10. The method of claim 1, wherein the first event corresponds to a first type of user, and wherein moving the portion of the computer system includes repositioning the portion of the computer system closer to the first type of user, the method further comprising:
detecting, via the one or more input devices, a second event that corresponds to a second type of user; and
in response to detecting that second event that corresponds to the second type of user and in accordance with a determination that the first set of one or more criteria is satisfied, forgoing moving, via the movement component, the portion of the computer system.

11. The method of claim 1, wherein moving, via the movement component, a portion of the computer system includes tilting the portion of the computer system in response to detecting that the portion of the user is moving toward the computer system.

12. A non-transitory computer-readable storage medium storing one or more programs configured to be executed by one or more processors of a computer system that is in communication with a movement component and one or more input devices, the one or more programs including instructions for:
detecting, via the one or more input devices, a first event;
in response to detecting the first event:
in accordance with a determination that a first set of one or more criteria is satisfied, wherein the first set of one or more criteria includes a criterion that is satisfied when a portion of a user is not within a first predefined distance from the computer system, moving, via the movement component, a portion of the computer system; and
in accordance with a determination that a second set of one or more criteria is satisfied, wherein the second set of one or more criteria includes a criterion that is satisfied when the portion of the user is within the first predefined distance from the computer system, forgoing moving, via the movement component, the portion of the computer system;
while moving, via the movement component, the portion of the computer system, detecting that the second set of one or more criteria is satisfied; and
in response to detecting the second set of one or more criteria is satisfied while moving the portion of the computer system, ceasing moving, via the movement component, the portion of the computer system.

13. A computer system that is in communication with a movement component and one or more input devices, comprising:
one or more processors; and
memory storing one or more programs configured to be executed by the one or more processors, the one or more programs including instructions for:
detecting, via the one or more input devices, a first event;
in response to detecting the first event:
in accordance with a determination that a first set of one or more criteria is satisfied, wherein the first set of one or more criteria includes a criterion that is satisfied when a portion of a user is not within a first predefined distance from the computer system, moving, via the movement component, a portion of the computer system; and
in accordance with a determination that a second set of one or more criteria is satisfied, wherein the second set of one or more criteria includes a criterion that is satisfied when the portion of the user is within the first predefined distance from the computer system, forgoing moving, via the movement component, the portion of the computer system;
while moving, via the movement component, the portion of the computer system, detecting that the second set of one or more criteria is satisfied; and
in response to detecting the second set of one or more criteria is satisfied while moving the portion of the computer system, ceasing moving, via the movement component, the portion of the computer system.
